(19) United States
(12) Patent Application Publication
(10) Pub. No.: US 2005/0168460 A1
(43) Pub. Date: Aug. 4, 2005

(54) Three-dimensional digital library system

(76) Inventors: Anshuman Razdan, Phoenix, AZ (US); Jeremy Rowe, Mesa, AZ (US); Daniel Collins, Tempe, AZ (US); Gerald Farin, Paradise Valley, AZ (US); Peter McCartney, Chandler, AZ (US); Gregory M. Nielson, Mesa, AZ (US); Arleyn Simon, Tempe, AZ (US); Mark Richard Henderson, Chandler, AZ (US); Mathew Tocheri, Tempe, AZ (US); David Capco, Tempe, AZ (US); Jiuxiang Hu, Tempe, AZ (US); Mary Marke, Tempe, AZ (US)

Correspondence Address: TIFFANY & BOSCO;CAMELBACK ESPLANADE II, THIRD FLOOR, 2525 EAST CAMELBACK ROAD, PHOENIX, AZ, 85016, US

(21) Appl. No.: 10/510,326

(22) PCT Filed: Apr. 4, 2003
(86) PCT No.: PCT/US03/10665

Related U.S. Application Data
(60) Provisional application No. 60/370,507, filed on Apr. 4, 2002.

(51) Int. Cl. G06T 15/00

(52) U.S. Cl. 345/419

(57) ABSTRACT

A computer system (100) and method for the storage, archiving, query and retrieval of information relating to 3D objects is provided. The système includes data acquisition (130) means for requiring point coordinate data about a three-dimensional object, a database component (105), a processor (103) and a user interface (110). The processor (103) is operable to generate modeled data (105) from the point coordinate data and to segment the modeled data (124) into feature data (122) representing a plurality of features of the object (118). The data is organized so that features of the 3D objects can be automatically extracted for online query and retrieval. The processor (103) is operable to store the modeled data (124) and the feature data (122) in the database component (105) and retrieve modeled data (124) and feature data (122) from the database component (105) using search criteria representing oobject features of interest. The user interface (110) is operative with the processor (103) to allow a user input search criteria to processor (103) and to display data retrieved by the processor as a representation of an object feature.

### RELATED APPLICATION

This application claims the benefit of U.S. Provisional Patent Application No. 60/370,507, filed Apr. 4, 2002, entitled “3D Digital Library System,” which is incorporated herein by reference.

### U.S. GOVERNMENT FINANCIAL ASSISTANCE

Financial assistance for this project was provided by the United States Government, DARPA MDA972-00-1-0027 and NSF IIS9980166. The United States Government may own certain rights to this invention.

### BACKGROUND

This invention relates generally to information storage and retrieval. More specifically, it relates to a system and method for the storing, archiving, query and analysis of information relating to three-dimensional (3D) materials and objects. The system can be used within a distributed environment to catalog, organize and support interaction with 3D materials and objects at a feature-based level.

The understanding of 3D structures is essential to many disciplines, including scientific disciplines such as archaeology and physical anthropology. For example, (1) archaeologists study the 3D form of Native American pottery to characterize the development of prehistoric cultures; (2) lithic research seeks to understand the development of stone tool technology over time by conjoining the remains of individual lithic reduction sequences; (3) comparative quantitative analysis of the 3D joint surfaces of human and nonhuman primate bones and the effects of surface area, curvature, and congruency on the mechanics of a joint can further the understanding of physical anthropologists who focus on the reconstruction of manipulative and locomotor behavior of early humans. To date, the methods that anthropologists use to measure, record, and classify 3D data such as calipers, photographs, drawings, and the use of classification schemes that reduce objects to simplified descriptors are inadequate for accurately representing such complex data.

Within the past decade, technologies for capturing 3D objects have emerged and improved dramatically, offering the possibility to obtain and store accurate mathematical models of objects in digital form. Notwithstanding this progress, heretofore no system has provided 3D data representation, storage, retrieval, semantic enrichment, application-specific feature extraction and development of a visual query system in a distributed environment.

### SUMMARY

In accordance with the invention, there is provided a computer system and method for the storage, archiving, query and retrieval of information relating to 3D objects. The system includes data acquisition means for acquiring point coordinate data about a three-dimensional object, a database component, a processor and a user interface. The processor is operable to generate modeled data from the point coordinate data and to segment the modeled data into feature data representing a plurality of features of the object. The data is organized so that features of the 3D objects can be automatically extracted for online query and retrieval. The processor is operable to store the modeled data and the feature data in the database component and retrieve modeled data and feature data from the database component using search criteria representing object features of interest. The user interface is operative with the processor to allow a user input search criteria to processor and to display data retrieved by the processor as a representation of an object feature.

The point coordinate data can be surface data or volume data. The modeled data can comprise 3D triangular mesh data segmented into subsets of vertices. Extracted features can include points, curves, surface data and volume data. Segmentation of the modeled data is performed to simplify the data and to organize the data into features or regions that are meaningful for applications or to users. One advantageous method for segmenting the modeled data uses a watershed segmentation method with improved curvature estimation. Another advantageous method uses a hybrid segmentation scheme. Data compression can be used to compress the modeled data. An advantageous method for compressing the modeled data uses B-spline curves. Another advantageous method uses subdivision surface compression. Two advantageous methods for segmenting volume use Weibull E-SD fields and Greedy connected component labeling refinement.

The user interface includes a graphic user interface that provides a visual query system and method that allows a sketch-based search of the database. Representative object shapes can be selected from a palette and modified, or a freeform profile sketch can be created using the visual query. The initial query request can be made in a variety of modes including text, vector graphics, and interactive 2D and 3D models. The user interface also can include text and numeric fields for parallel query of descriptive and derived data within the databases. The visual query interface displays search results, which can include textual data and graphic data, including 2D and 3D representations of objects that match the search criteria.

The system and method can be used with models to address various types of data selected to represent different design challenges, volumetric and spatial elements, and modeling requirements.

### BRIEF DESCRIPTION OF THE DRAWINGS

The accompanying drawings, which are incorporated in and constitute a part of the specification, illustrate the presently preferred embodiments and methods of the invention Together with the general description given above and the detailed description of the preferred embodiments and methods given below, they serve to explain the principles of the invention.

FIG. 1 is a functional block diagram of an exemplary computer for system storing, archiving, query and retrieval of information relating to 3D objects in accordance with the invention.

FIG. 2 shows an example of an XML schema according to the present invention.

FIG. 3 shows an exemplary region editor screen display for editing modeled data representing 3D objects.

FIG. 4 shows an exemplary query input screen display for inputting sketch-based, numeric, and text-based search criteria.

FIG. 4 is a flowchart of the visual query process.

FIG. 6 shows an exemplary screen for displaying results of a query in the form of thumbnail images and summary data for 3D objects returned by the search.

FIG. 7 illustrates an exemplary screen for displaying further detail of a specific 3D object selected from among the search results of FIG. 6.

FIG. 8 is a diagram illustrating data flow, knowledge abstraction and query according to the invention.

FIG. 9 illustrates an example of a triangulated, highly decimated point cloud data set representing a surface of an object.

FIG. 10 shows in more detail the data flow and structure of the geometric modeling module of the system of FIG. 1.

FIG. 11 shows in more detail the data flow and structure of the feature extraction, analysis and index generation module of the system of FIG. 8.

FIG. 12 has been intentionally omitted.

FIG. 13 shows two pieces of an object, i.e. a core and flake of a stone artifact, which pieces fit together and each of which pieces has been segmented to extract its surface features for comparison.

FIG. 14 shows curvature based segmentation.

FIG. 15 shows merging similar regions by increasing the water depth.

FIG. 16 shows a comparison of (A) a Gaussian curvature plot and (B) a mean curvature plot.

FIG. 17 shows (A) the min-max box for arbitrary axes and (B) the min-max box for the axes of the norm ellipse of the points.

FIG. 18: Figure showing local surface fit for curvature estimation.

FIG. 19: Considering the curvature sign may yield an incorrect segmentation.

FIG. 20 shows an example where a triangle Tᵢ will be such a gray area: (A) shows an example of segmentation using the watershed method with no hard boundaries; and (B) shows the segmentation example of FIG. 20A using the watershed method with such a boundary solution.

FIG. 21 illustrates the creation of triangles on boundaries of an original mesh according to the hybrid method.

FIG. 22 shows a mesh segmented using the watershed method and illustrating no hard boundary.

FIG. 23 shows feature vertices and edges of a mesh.

FIG. 24 shows the steps of the hybrid segmentation method.

FIG. 25 shows creation of triangles on feature edges of an original mesh.

FIG. 26 shows assigning regions for the case having multiple labels with multiple common labels.

FIG. 27 shows segmentation of mechanical parts using the hybrid method.

FIG. 28 shows segmentation of a turbine and a wheel using the hybrid method

FIG. 29 shows segmentation of a bone using the hybrid method.

FIG. 30 shows mesh traversal and parallelogram prediction method for Edgebreaker algorithm.

FIG. 31 shows mMesh traversal and recording of the error vector in the B-Spline algorithm.

FIG. 32 shows Left: normal case for recreating the geometry and topology. Right: handling of special case if the vertex has been visited or recorded before.

FIG. 33 shows: Example of Cow. Left: Triangle Mesh representation. Right: B-Spline approximation to the edge mid points. Each color represents a different B-Spline.

FIG. 34 shows: Stanford Bunny Top left: Triangle Mesh representation. Top right: Zoomed in view of the mesh. Bottom left: B-Spline approximation to the edge mid points. Bottom right: Zoomed in view of the B-Spline curves.

FIG. 35 shows an example of compression.

FIG. 36 shows a remeshing process according to one aspect of the invention.

FIG. 37 shows a flow chart of the remeshing process of FIG. 36.

FIG. 38 shows In the Loop subdivision, each subdividing level produces two types of vertices: vertex points and edge points as shown in FIG. 38.

FIG. 39 shows

FIG. 40 shows the construction and comparison of a number of well-known data sets.

FIG. 41 shows (A) Polygonal Mesh with watershed defined areas for complete vessel and (B) Polygonal Mesh with watershed defined areas for partial vessel.

FIG. 42 shows shows feature segmentation of complex shaped vessel.

FIG. 43 shows descriptive elements of ceramic vessel.

FIG. 44 illustrates four kinds of vessel bases, i.e.: (a) convex base; (b) flat base with zero curvature; (c) concave base; and (d) composite base.

FIG. 45 shows a schema used for archaeological vessels.

FIG. 46 describes a schema used for lithics.

FIG. 47 shows a distribution experiment of a LCM volume data: (a) A real LCM volume data; (b) The distribution of the data

FIG. 48 shows the Weibull distribution with different shape parameters a and scale parameter b=1.2 and v₀=0.

FIG. 49 shows function tB(t,t)/2. It reaches maximum 0.72 at t=0.42.12

FIG. 50 illustrates classification of noise in a box by using two parameters: s1 and s2. (A) Normal sample case: {64, 52, 64, 46, 50, 54, 62, 43}, where s1=4.475 and s2=4.9; (B) High noise case {240, 52, 64, 46, 50, 54, 62, 43}, resulted from case (A) just added one high noise term on purpose, where s1=0.825 and s2=3.6; (C) Low noise case {6, 52, 64, 46, 50, 54, 62, 43}, resulted from case (a) just added one low noise term on purpose, where ₛ1=3.45 and ₛ₂=0.575; (D) Low noise case {6, 52, 64, 46, 50, 54, 62, 234}, resulted from case (A) just added one low noise term and one high noise term on purpose, where ₛ1=0.725 and ₛ₂=0.525.

FIG. 51 shows randomly generating Weibull distribution using (7) with the scale parameter b1.2 and three distinct shape parameters a=0.75, a=3 and a10. (a) The whole volume data (b) the partial volume data with two co-centric spheres

FIG. 52 shows generating 3D Weibull distributed volume data with distinct shape and scale parameters. In (A), the blue part (cube) with a=0.75 and b=1.2, the red part (outside sphere) with a=3.0 and b=16.58, and the green sphere (inside) with a=10.0 and b=63.58. The images are rendered using Ray-Casting.

FIG. 53 shows E-SD plot of 3D control volume data above. The cone part on the left corresponds to cube outside of spheres, the disc at the middle to the external sphere, the small region on the right-top to the internal sphere. (a) Cube out of spheres (b) external sphere (c) internal sphere.

FIG. 54 shows the segmentation of control 3D Weibull distributed volume data. The color is RGB(155, v, 0), where v is the value at the point (x, y, z).

FIG. 55 shows test bed for our Weibull E-SD modeling scheme. They come from two different experiments. The size of image (A) is 512×512×124, the gray-level is from 0 to 255, and there is only one cell, its spindle is at the up part of the cell. The size of image (B) is 512×512×146, has the same gray-level with (A).

FIG. 56 shows the E-SD plots of image (A) and (13) of FIG. 55, respectively. The colors have the same means as FIG. 53. In (A), the size of window is (178, 237; 4, 27) corresponding to the segmentation (A) in FIG. 57, and the threshold e T=34, so there is a blank on the left side. There are two clear fingers. In (13), the size of window is (167, 255; 2, 30) corresponding to the segmentation (13) in FIG. 57, and the threshold e T =34, so there is a blank on the left side. There are two clear fingers. The box size is 2×2×2.

FIG. 57 shows the spindle segmentation of FIG. 55, respectively. The color is RGB(0, v, 0), where v is the value at the point (x, y, z). It are rendered by using OpenGL point clouds. The segmentation in (A) includes 3902 boxes, and 11308 boxes in (B).

FIG. 58 shows the region corresponding to the small finger in FIG. 58A. It is rendered by using OpenGL point clouds from two different views.

FIG. 60 shows a test bed for our volumetric segmentation scheme. FIG. 60A shows an LSCM image of GFAP-labeled astrocytes and DAPI stained nuclei, in which the green highlights regions targeted with GFAP labeled astrocytes, and the red regions identify DAPI, which consistently targets nuclei cells. FIG. 60B shows a LSCM image of GFAP-labeled astrocytes and electrode implant, in which the red targets implant and the green GFAP. Both are rendered by MIP in 3D.

FIG. 61 is a plot of function g(a) defined by equation (3) for four samples which are generated by Weibull pdf with b=1:2, and v0=0:0 and a=0:7; 2; 3, or 10, respectively. And 0.7, 2.1, 3.05 and 9.8 are the roots of g(a)=0 corresponding to the samples.

FIG. 62 shows the Weibull parameter a-b histogram for the LSCM image shown in FIG. 1(a) and the color legend, where N(a;b) is the number of voxels which satisfy Weibull parameters are a, and b

FIG. 63 shows an example of hierarchy frame for a 2D image.

FIG. 64 shows segmentation (a) before GCCL, and (b)after GCCL. Both are rendered by point clouds in 3D.

FIG. 65 illustrates smoothing connected components using convolution: a GFAP labeled astrocyte (a) before smoothing, and (b) after smoothing, and a nuclei (c) before smoothing and (d) after smoothing

FIG. 66 illustrates the segmentation results of the LSCM image of the GFAP-labeled astrocytes and DAPI stained nuclei (FIG. 60A)

FIG. 67 shows the connection analysis for GFAP labeled astrocytes in LSCM image FIG. 60A

FIG. 68 illustrates the segmentation results of the GFAP and implant LSCM image FIG. 1(b), (a) two channel data, and (b) the GFAP-labeled astrocytes, and (c) the electrode implant segmented

### DESCRIPTION

Reference will now be made in more detail to the presently preferred embodiments and methods of the invention as illustrated in the accompanying drawings, in which like numerals refer to like parts throughout the several views.

The present invention provides a system and method for the storing, archiving, query and analysis of information relating to 3D objects. The system can be used within a distributed environment to catalog, organize and support interaction with 3D materials and objects.

### The Computer Network System

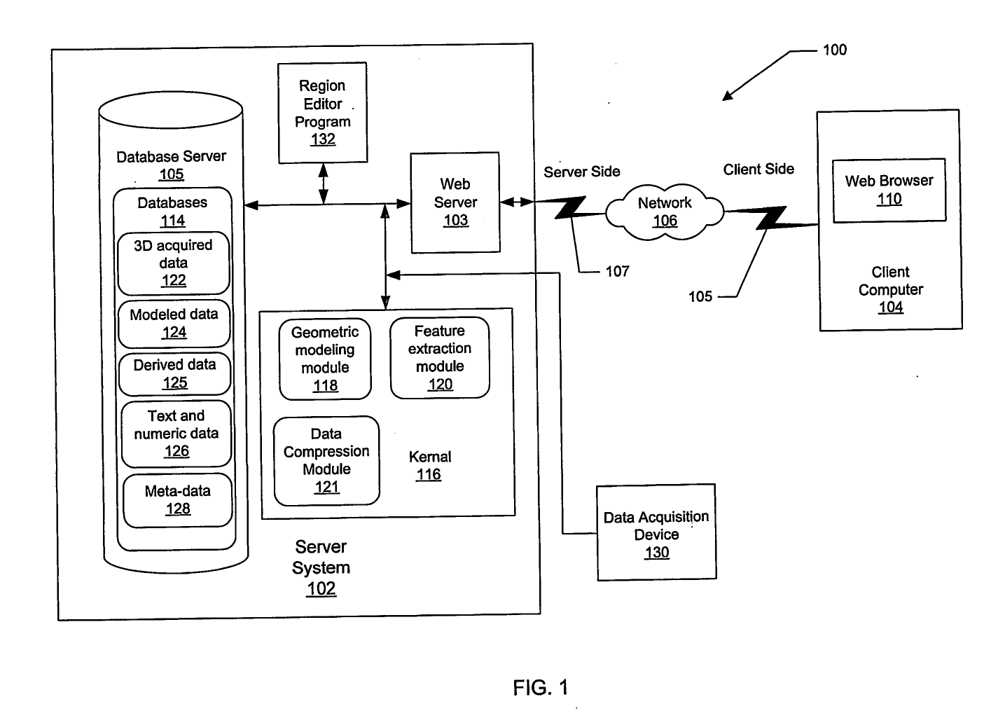

FIG. 1 illustrates in schematic block diagram form an exemplary computer network system 100 for practicing the invention. The computer network system 100 includes a server computer system 102 and a client computer system 104, which are connected by data connections 105, 107 to a computer network 106, e.g., an intranet, the Internet and/or the World Wide Web, so that the client computer system 104 and the server computer system 102 can communicate. As will be readily apparent to persons skilled in the art, the client computer system 104 is intended to be representative of a plurality of client computer systems 104, each of which may communicate with the server computer system 102 via the network 106, whether sequentially or simultaneously. It is to be understood that the terms client and server are to be construed in the broadest sense, and that all such constructions of the terms are intended to fall within the scope of the appended claims.

With reference to the network 106, it is contemplated according to the present invention that each of the clients 104 may access and communicate with the network 106 through any data communication technology. For example, the client 104 may comprise one or more personal computers that are part of a conventional local area network (LAN) and the data connections 105, 107 may be provided by dedicated data lines, Personal Communication Systems (PCS), microwave, satellite networks, wireless telephones, or any other suitable means. For example, the client computer 104 that can be connected to the Internet via a phone network, such as those provided by a local or regional telephone operating company, or a coaxial cable line. In any case, client(s) 104 are adapted to communicate with the network 106 such that information may be transmitted to and from the server 102, e.g., through one or more routers, wide area networks (WANs), satellites, hubs, repeaters, bridges and gateways, as is known in the art. Data transmissions are typically passed from network to network in packets that include not only the substantive aspects of the data transmission, but addresses, error checking information and the like.

The computer network system 10 advantageously makes use of standard Internet protocols including TCP/IP and ITTP. TCP/IP is a common transport layer protocol used by a worldwide network of computers. HTTP is a known application protocol that provides users access to files (which can be in different formats such as text, graphics, images, sound, video, etc.) using a standard page description language known as Hypertext Markup Language (HTML), DHTML or XML. Known HTML web browsers allow for graphical user interface (GUI) based access to HJML documents accessible on servers communicatively linked to the client 104. These documents are commonly referred to as “web pages.” Although the client 104 and the server computer 102 are coupled together via the Internet, the invention may also be implemented over other public or private networks or may be employed through a direct connection and any such communication implementation is contemplated as falling within the scope of the present invention.

### Server Computer System

The server computer system 102, which has a conventional architecture, includes: a central processing unit (CPU), which may be implemented with a conventional microprocessor; means for temporary storage of information, which may be implemented with random access memory (RAM); and means for permanent storage of information, which may be implemented with read only memory (ROM); and means for mass storage of information, which may be implemented by hard drive or any other suitable means of mass storage known in the art.

It will be obvious to someone of ordinary skill in the art that the invention can be used in a variety of other system architectures. As described herein, the exemplary system architecture is for descriptive purposes only. Although the description may refer to terms commonly used in describing particular computer system architectures the description and concepts equally apply to other computer network systems, including systems having architectures dissimilar to that shown in FIG. 1.

Still referring to FIG. 1, the server computer system 102 includes a Web server 103, and a database server 105. The Web server 103 manages network resources and handles all application operations between the browser-based clients 104 and the server side applications. The database server 105 includes a database management system (DBMS), a collection of programs that enables the storing, modification and extraction of information from databases 114. The Web server 103 facilitates communication and data exchange between the client 104 and database 114.

One or more data acquisition devices 130 can be used to generate raw 3D data about an object and to input the raw 3D data to the server 102. Some examples of suitable data acquisition devices 130 include laser scanners for acquiring 3D surface data and MM scanners, CAT scanners or Laser Confocal Microscopes for acquiring 3D volume data It will be understood, however, that the data acquisition devices 130 can include any device that generates digitized 3D data from an object.

A program kernal 116 executes on the server computer system 102 and implements the logical operations of the system, as described below. The kemal 116 includes a geometric modeling module 118, which can derive 3D and 2D modeled data from the raw 3D data. A feature extraction, analysis and indexing module 120 can operate to provide cataloging, description and interactive access to the modeled data, as well as to stored textual and descriptive data about the object. A data compression module 121 can compress certain data for enhanced storage and transmission.

A region editor program 132 also executes on the server computer system 102. The region editor program 132 functions to break the mesh down into “meaningful” connected subsets of vertices called “regions.”

The database 114 can comprise a number of different databases for storing various data element. These data elements include: 3D acquired data 122, such as that generated by the data acquisition device 130; modeled data 124, which the geometric modeling module 118 generates from the 3D acquired data; derived data 125, which the extraction, analysis and indexing module derives from the modeled data 124, and textual and numeric data 126. The database 114 also stores metadata 128 for describing the data and how the data is formatted. The schema discussed herein further describe the metadata 128.

The 3D acquired data 122 can be 3D surface data, such as that generated by optically scanning the surface of an object, or it can be 3D volume data that includes information about the interior of an object, such as that obtained from MM scans, CAT scans or Laser Confocal Microscope volume data. The modeled data 124 is data that has been structured or modeled from the acquired data 122 using suitable models, such as triangular meshes, surface representation models or volume representation models. The derived data 125 includes data derived from the modeled data, such as object features or mathematical descriptive date extracted from the modeled data. The text and numeric data 126 can include, for example, area curvature distribution and the like.

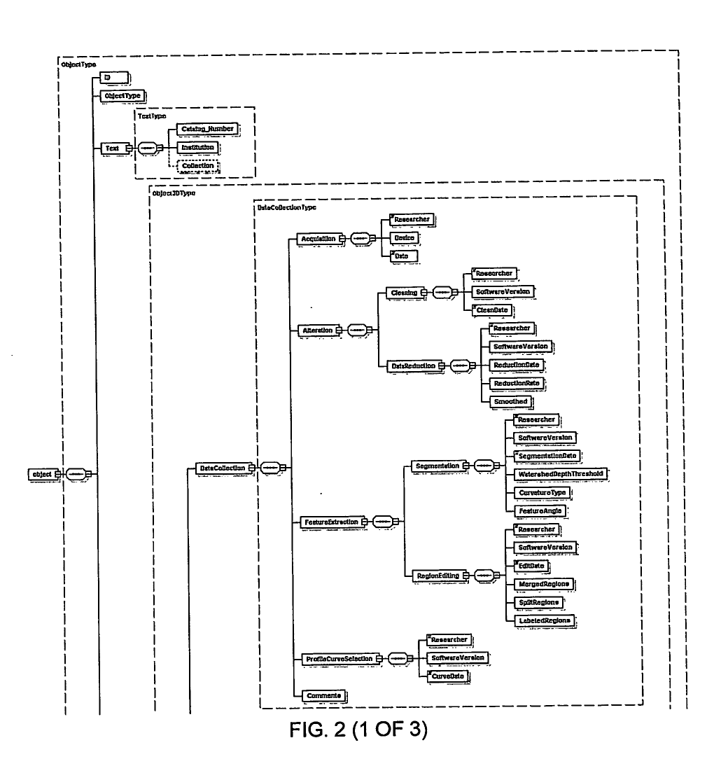

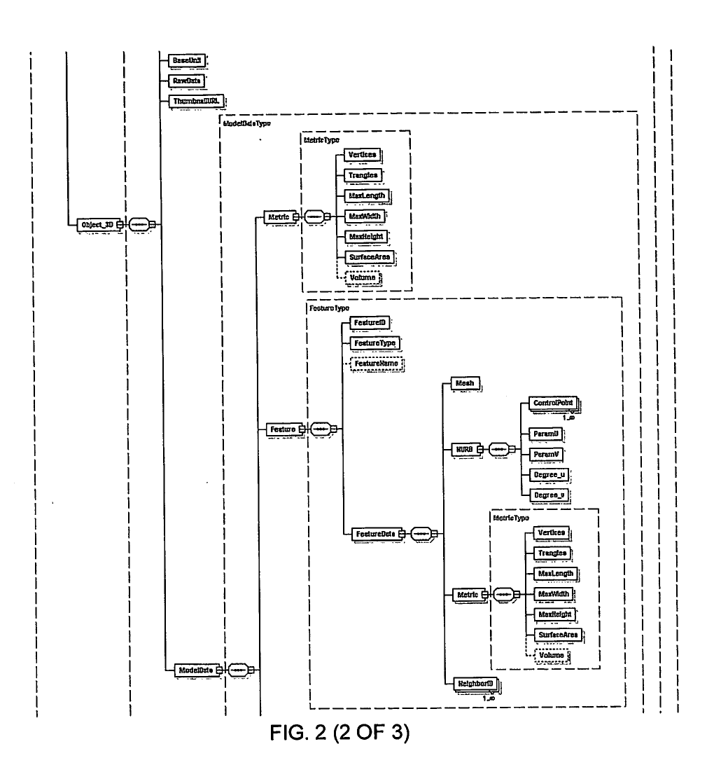

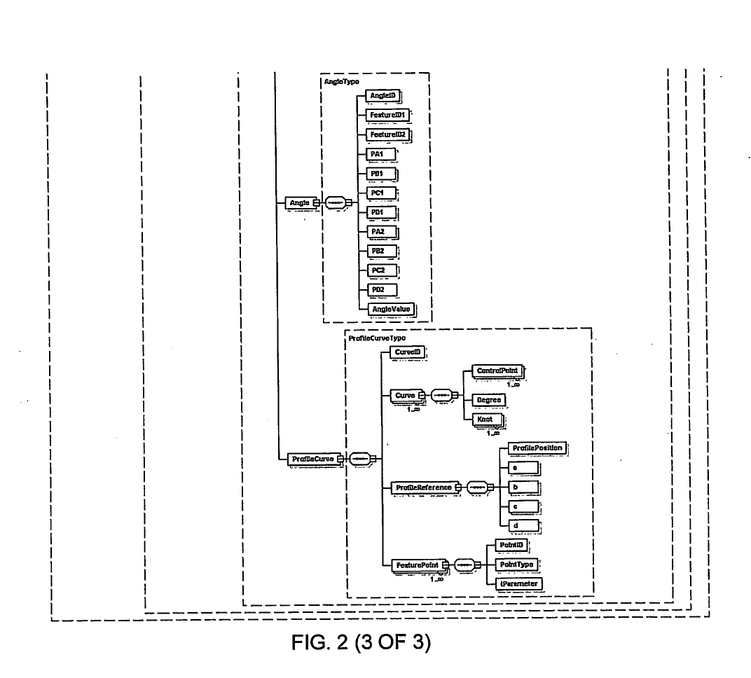

The data elements are organized, cataloged and described according to a schema to facilitate efficient query of and interaction with the data In a presently preferred embodiment, the schemas are written in XML (eXtensible Markup Language). XML is a standard format for structured document/data interchange on the Web. Like HTUL, an XML document holds text annotated by tags. Unlike HTML, however, XML allows an unlimited set of tags, each indicating not how something should look, but what it means. This characteristic helps facilitate information sharing. FIG. 2 depicts an example of an XML schema according to the present invention. The schema can include application specific categories and can be organized to differentiate general information (e.g., provenence, time period) and 2D information (e.g., height, length) from 3D information. The 3D information data structures at the top-level house original binary data files, modeled files, and derived features. One level down the hierarchy, cognitive pattern primitives (CPPs) store the basic shape data that form the building blocks out of which meaningful features are constructed. The schema allows shape grammar and shape algebra to be used to provide a natural language syntax to write a shape as a construct of tokens (CPPs) and combination rules. To link this spatial, modeled, and constructed data to descriptive data in existing databases, the schema provides a master identification number for use as the key to link data elements for a given artifact. This model is consistent with Dublin Core cataloging structures and emerging data standards within the discipline. This design permits a query engine to link the data elements with additional data in other databases by mapping appropriate data fields between the databases using a master ID#.

### Client Computer System

Still referring to FIG. 1, the client 104, which also has a conventional architecture, includes: a central processing unit (CPU), which may be implemented with a conventional microprocessor; means for temporary storage of information, which may be implemented with random access memory (RAM); and means for permanent storage of information, which may be implemented with read only memory (ROM); and means for mass storage of information, which may be implemented by hard drive or any other suitable means of mass storage known in the art; one or more input devices for inputting information into the computer, which may be implemented using a conventional keyboard and mouse, and an output device for display graphical output to the user, such as a conventional monitor. The client 104 includes conventional hardware and software for communicating over the network 106. In a presently preferred embodiment, this includes a Web browser software application 110, which executes on the client 104 to access information available on the Internet. Any conventional browser 110 is contemplated for use according to the present invention, e.g., Netscape Navigator or Microsoft Internet Explorer, provided that the browser supports JAVA and HTML 3.0 or better. The system and method of the present disclosure advantageously utilizes the full functionality of such browser programs, as are known to persons skilled in the operation and use thereof.

### Graphical User Interface

The client 104 utilizes a GUI by which a user can view, store, modify information in and extract information from the database 114. In the presently preferred embodiment, the GUI comprises a collection of HTML pages transmitted to the client 104 by the Web server 103 and displayed by the Web browser 110. The GUI includes interactive surface and volume visualization capabilities and quantification tools to extract curvature, volume, scale, and linear dimensions for each data set and allows the user to generate a sketch-based of the database 114.

### Region Editor

Referring to FIG. 3, an exemplary client screen display 208 is provided from which certain aspects of the region editor 132 may be described. Client screen display 200 is representative of region editor screen layouts that may be viewed by users of clients 104. A display window 180 displays modeled data as an image 182 and numeric data. The user can edit the modeled data using a toolbar 184.

### Visual Query

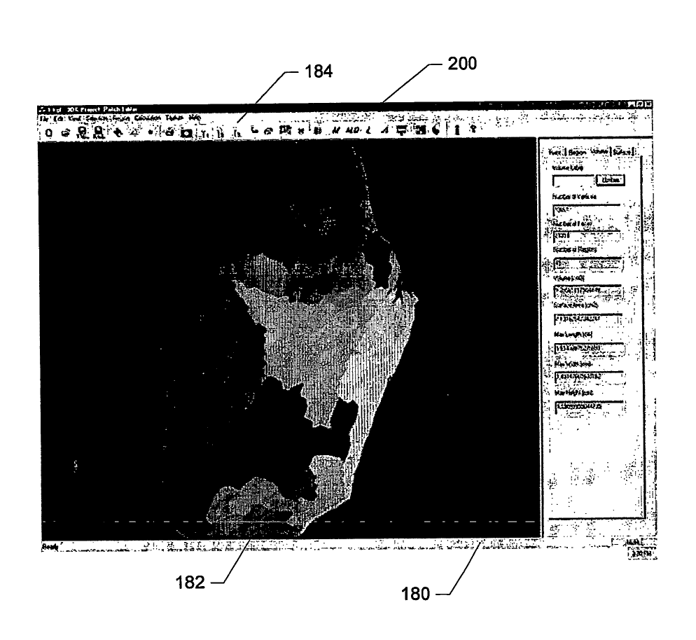

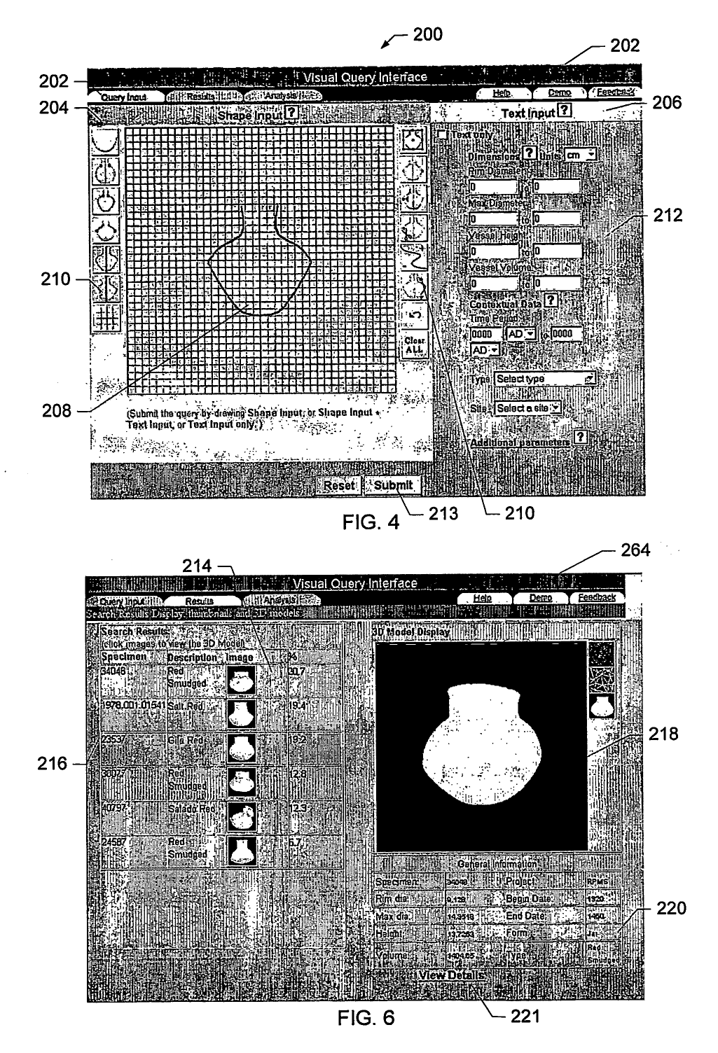

The GUI also includes a visual query interface, which allows users to input, analyze, refine and limit searches of the database 114. The visual query interface combines a sketch-based search capability with traditional text and metric data. Referring to FIGS. 4-7, an exemplary client screen display 200 is provided from which certain aspects of the visual query interface may be described. Client screen display 200 is representative of visual query screen layouts that may be viewed by users of clients 104. The client screen display 200 can display a query input screen 202 including a shape input window 204 and a text input window 206. The shape input window 204 allows a user to input a query image 206, which can be in the form of vector graphics or a 2D and 3D image. The query image 208 can be created as a freeform profile sketch or it can be selected from a palette of stored representative object shapes. Using a toolbar 210, the user can manipulate the query image 208 in real time to refine searches. The text input window 206 includes input fields 212 for inputting textual and numeric search parameters. These support parallel query of descriptive and derived data within the databases 114. The user can manipulate and resubmit the query image in real time to refine searches. After a user has entered the desired criteria into the query input screen 202, a “submit” button 213 can be selected to submit the query to database 114.

Referring to FIG. 5, when the user submits a query, the client 104 sends the search criteria to the Web server 103 as binary and textual data (step 250). The server system 102 then searches the databases 114 to match text and numeric, and calculated feature data, with the search criteria. A Common Gateway Interface (CGI) program accepts the data from the Web server 103 and parameterizes the search criteria (step 252). The kernal 116 then extracts features, using appropriate feature extraction algorithms as described below, from the sketch and executes a search of the database 114 (step 254). In a presently-preferred embodiment, Java Server Pages (JSP) are used to implement the dynamic database queries, but it will be understood that other suitable technologies such as Active Server Pages (ASP) also can be used. The database server 105 queries the database 114 (step 256) and returns the search results to the kernal 116. The kernal 116 then compiles and tabulates the search result data (step 258). In a presently-preferred embodiment and method, XML is used represent the search results. Query results from the database 114 are stored in XML format, and are visualized via a pre-designed Extensible Style Language (XSL) file. The XSL file provides the data needed to view detailed information for any of the returned objects without need for further interaction with the server 102 and databases 114. This includes thumbnail images and descriptive data for a predefined number of objects in the search results. The Web server 103 sends the processed search results to the client 104, where they are cached (step 262) and displayed by client 104 via the Web browser 110 (step 264), which extracts thumbnail and summary data from the XSL file (step 414) and displays the thumbnail and summary data in the initial search result screen.

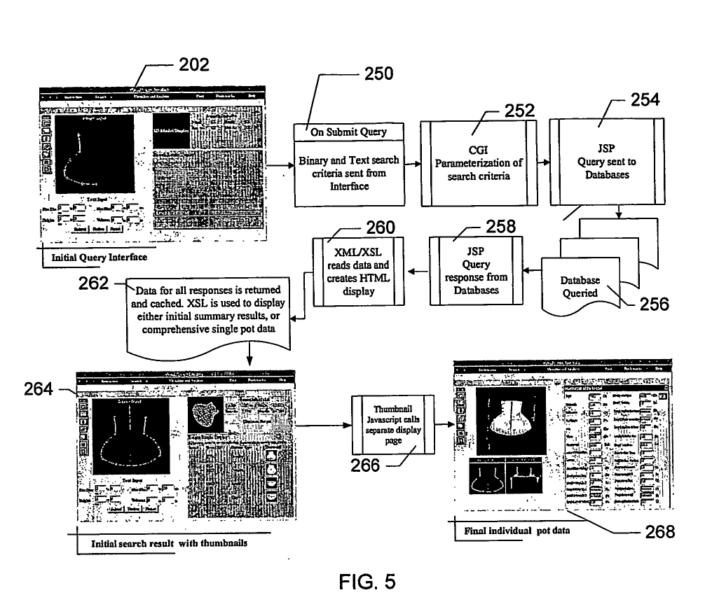

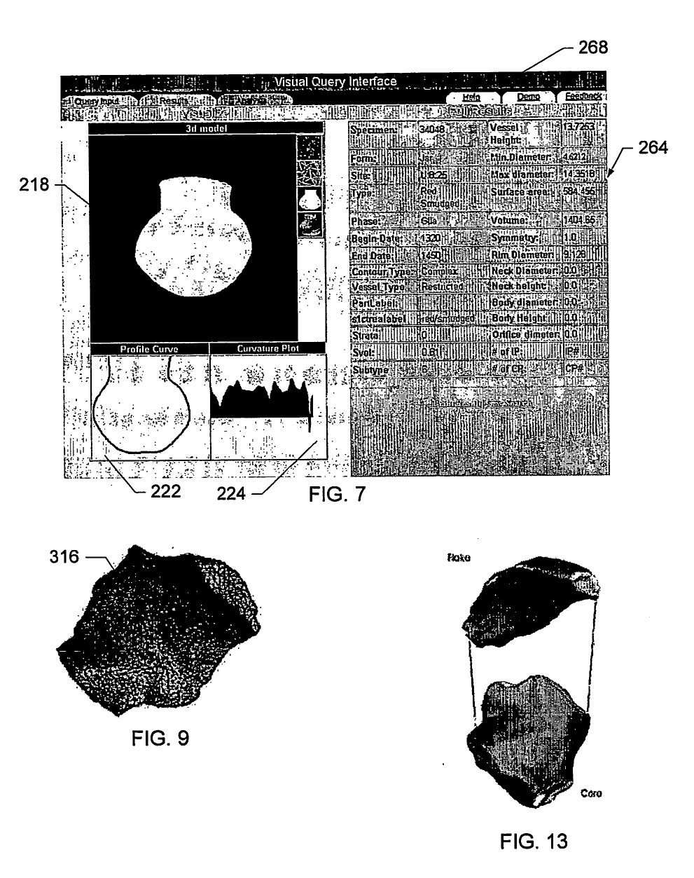

FIG. 6 illustrates an exemplary search result screen display of initial search results. after the client 104 receives the search results, it displays those search results in the result window 204. The displayed results can include thumbnail images 214 of objects having features matching the search criteria as well as and descriptive data 216 for those objects. When a user selects one of the returned thumbnail images 214, which prompts the client browser 110 to extract a manipulable 3D model of the selected object and detailed descriptive data. The client browser 110 then displays the 3D model 218 of the selected object along with additional descriptive data 220 for that object. The user can modify the query sketch by returning to the initial search result screen or new search screen. To view more details associated with the selected thumbnail image, the user can select a detail link 221 which will cause a separate display page to be called (step 266) and displayed as a full results display 268. FIG. 7 illustrates an example of a screen display of the full results of a search. The full results display 268 includes additional 2D, 3D and descriptive data for the selected thumbnail, including features such as a 2D profile curve data 222, curvature plot data 224 and full textual and numeric data 226.

### Systems Operation

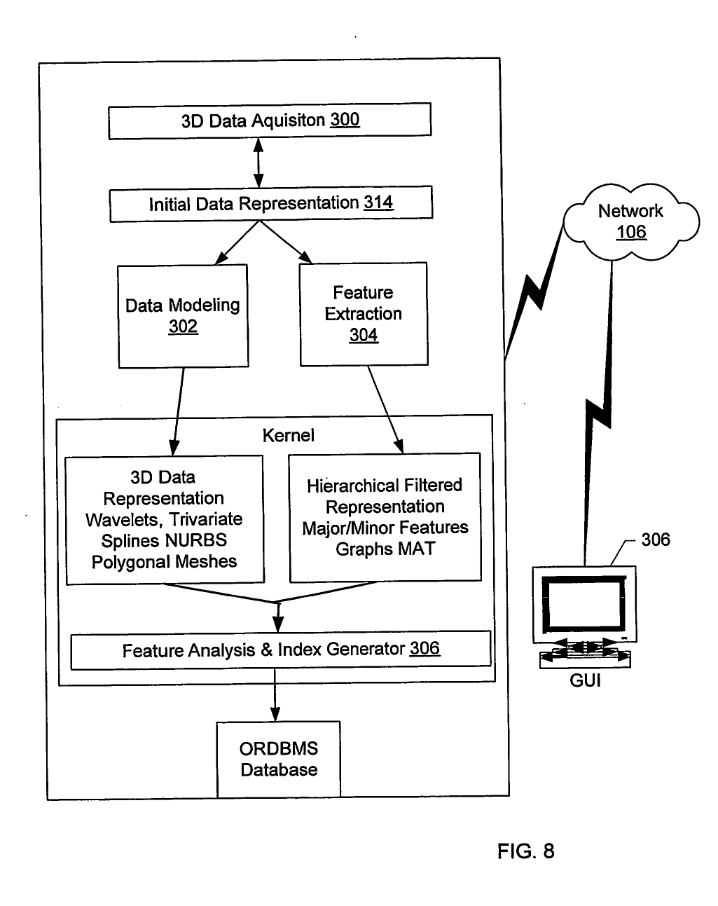

Referring to FIG. 8, additional aspects of the operation of the system 100 will now be described in further detail. Generally, operation of the system includes a data acquisition process 300, modeling of the acquired data 302, segmentation and feature extraction 304, feature analysis and index generation for storage of data 306, and online display and query of the stored data 308.

### Data Acquisition

In the data acquisition process 300, 3D raw data is input to the system 100. This raw data can be 3D surface data, such as that generated by optically scanning the surface of an object, or it can be 3D volume data which includes information about the interior of an object, such as that obtained from MRI scans, CAT scans or Laser Confocal Microscope volume data. In the example of 3D surface data, when an object is scanned using a laser scanner, several tens or hundreds of thousand point coordinates are generated, each representing a location on the object. This collection of points is referred to as a ‘point cloud.’ It has no structure, and is simply a file containing point coordinate data as x, y, z values. Point cloud information also can be generated using computer programs, either interactively or automatically from mathematical functions, as is well-known in the art. In either case, to work with this point cloud, it has to be structured or modeled.

### Geometric Modeling

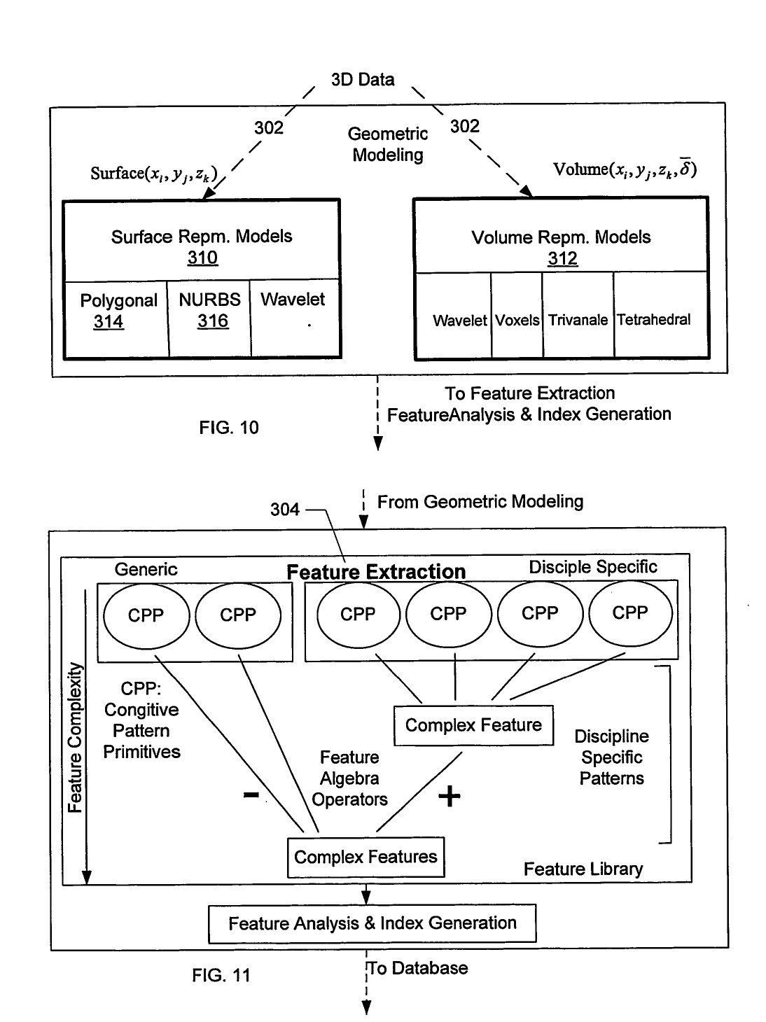

The geometric modeling module 118 operates on the acquired 3D data to perform geometric modeling (step 302) of that data. FIGS. 8, 10 and 11 illustrates the data flow and structure of the geometric modeling module 118. Geometric modeling can include modeling of 3D surface data into surface representation models 310 as well as modeling of 3D volume data into volume representation models 312. (FIG. 10)

### Polygonal Meshes

One advantageous method to model 3D data is to triangulate the point cloud to generate a mesh of triangles (Step 314) 314 having the digitized points as vertices. 3-D triangular meshes are a well-known surface modeling primitive used extensively to represent real world and synthetic surfaces in computer graphics. Each triangle ‘knows’ about its neighbors, which is the structure that allows fast processing of the geometry represented by the triangulation. FIG. 9 illustrates an example of a triangulated, highly decimated point cloud data set representing a surface of an object 316, i.e. a ventral surface of a stone flake. It is important to stress that the same set of vertices or data points could have several triangulations. The emphasis therefore, is on the vertices themselves, rather than the ‘surface’ as represented by the triangles.

### Surface Models

Because triangulation is a modeling primitive, the geometric modeling module 118 uses additional modeling steps to simplify the data and extract regions or object features that are meaningful for applications or to users. For example, to study surface contour shapes the surfaces must be modeled. If an object is inherently smooth, it is advantageous to represent its surface by a smooth data format. One advantageous surface representation model is via a parametric surface such an a NURBS (Non-Uniform Rational B-Spline) data set 316. A NURBS data set consists of control points (besides degree and parameterization) arranged in a grid of points, roughly representing a given shape. Fitting points of polygonal meshes with least squares approximation generates such surface models. NURBS data sets provide a compact data representation and make it easy to calculate curvatures of objects to extract their essential shape characteristics. Using such representations enables one to rebuild models, analyze properties such as curvatures and make quantitative measurements, as well “repair” incomplete models. A NURBS surface can be represented as:

$$\overline{P} ( u , v ) = \frac{{\sum }_{i = 0}^{m} {\sum }_{j = 0}^{n} {w}_{i , j} {\overline{d}}_{i , j} {N}_{i , k} ( u ) {N}_{j , l} ( v )}{{\sum }_{i = 0}^{m} {\sum }_{j = 0}^{n} {w}_{i , j} {N}_{i , k} ( u ) {N}_{j , l} ( v )} \qquad ( 1 )$$

where dᵢⱼ, i=0, 1, . . . ,m; j=0, 1, . . . n are control points, wᵢⱼ are weights, N_{i,k}(u) and N_{j,l}(v) are B-Spline basis functions. When weights equal 1.0, this reduces to a non-uniform B-Spline surface.

### 2D Geometric Models

2D models can be used to simplify problems presented by 3D analysis. For example, 2D curves may be used to describe an object, such as a profile curve used to describe an archeological vessel. To obtain a profile curve, a cutting plane is projected through the 3D mesh representing the object, and intersection points with the mesh are extracted and ordered in a chain code. NURB curves can be generated by fitting points of the chain code with least squares approximation.

One of the important characteristics of a curve is the curvature. The curvature can be very useful for analysis and classification of object shape. In 3D space the curvature of curves is unsigned. However, for planar curves in 3D space, positive curvatures can be converted into signed curvatures. Curvature has useful information such as convexity, smoothness, and inflection points of the curve, and if this is information needed for analysis, cubic NURB curves can be used to approximate profile curves

$$\overline{P} ( u ) = \frac{{\sum }_{i = 0}^{n} {w}_{i} {\overline{d}}_{i} {N}_{i , k} ( u ) ( v )}{{\sum }_{i = 0}^{n} {w}_{i} {N}_{i , k} ( u )} \qquad ( 2 )$$

where \overline{d}ᵢ, i=0, 1, . . . , n are control points, wᵢ are weights, and N_{i,k}(u) are B-Spline basis functions. In one exemplary application, because measures of curvature such as convexity, smoothness, and inflection points of the curve were needed for vessel analysis, cubic B-Spline curves have been used to approximate profile curves of archeological vessels. The accuracy of these derived curves far exceeds the manually sketched or mechanically derived curves currently used to describe these vessels. The result is a profile curve from which appropriate features such as corner points, end points, and symmetry between both halves of the profile curve can be readily computed and extracted.

FIG. 7 illustrates a vessel image 218, its profile curve 222 and the signed curvature plot 224 of the curve.

### Feature Extraction and Segmentation

Referring to FIGS. 8 and 11, after modeling of the acquired data (step 302), the feature extraction, analysis and index generation module 120 performs feature extraction and segmentation (step 304) so that appropriate feature data can be extracted for study. Although features (such as corner points on a pot, joint surfaces on a bone, and flake negatives on lithics) are a diverse set, they can be extracted in accordance with the invention using a common set of algorithms. As shown in FIG. 11, extraction of features from such objects and the use of these features to search for particular shapes involve multiple levels of analysis and extraction algorithms. As a common denominator, however, the features are built from cognitive pattern primitives (CPP), which are essentially the geometrically meaningful feature building blocks. Examples of CPPs include curves, for example a part of a profile curve, and surfaces such as segments of the surface of an object. Building features from these primitives requires a construction method that allows the CPPs to be arranged and connected in various ways and also for these connections and arrangements to be described mathematically. Features can be defined, then, by a set of CPPs and a set of operators to connect and arrange these CPPs.

Extracting features from modeled data can take on various forms depending on the desired information. According to one exemplary feature extraction method, features are separated into four categories: point, curve, surface data and volume data. The extraction of point features, curve features and surface data features will now be described with reference to an exemplary application, i.e. the study of ceramic vessels.

### Extracting Point Features: Corner Points

Using chain codes and NURB curves as described above, profile curves can be extracted from modeled data. These profile curves can have a number of points of interest to a user, such as corner points. Corner points can be described as an abrupt change in the orientation of an object wall, or a distinct angle in the joining of object parts, such as neck and body of a vessel. For the automatic extraction of such points on a profile curve there is a need to adequately describe this feature mathematically. Hence, corner points are points of maximum curvature change on a profile curve and are extracted by comparing curvature values for all points on the profile curve.

The following algorithms have been developed to extract point features:

### Algorithm for Extracting End Point Features

Input: a profile curve represented by B-Spline curve and chain code respectively.

Output: end point features

1. end point 1 □ start point of chain code; end point 2 □ end point of chain code;

2. center point □ center point of chain code;

3. find the base section around center

4. if base section is flat or concave then
total end point number □ 4; end point 3 □ left terminate of base section; end point 4 □ right terminate of base section;
else {base is convex}
total end point number □ 3; end point 3 □ center;

5. calculate feature information for each end points, include space coordinates, parameter value, position on the chain code, and so on;

### Algorithm for Extracting Corner Point Features

Input: a profile curve represented by B-Spline curve and chain code respectively.

Output: corner point features

1. calculate curvature value for each points on chain code;

2. find points with local maximum (minimum) curvature value as candidates for corner points;

3. for all candidates
if angle at the candidate point<a predefined value then the candidate point is a corner point.

4. calculate feature information for each corner point, include space coordinates, parameter value, position on the chain code, and so on.

Inflection features and point of vertical tangency features can be determined because inflection point and point of vertical tangency can be found by analyzing curvature value and tangent lines.

When computing the angle between points (x₁, y₁), (x₀, y₀) and (xᵣ, yᵣ) in the algorithm for extracting corner features, the angle is sensitive to sample error. In order to reduce the error due to sampling, instead of taking (x₁, y₁) and (xᵣ, yᵣ) as points of the curve, the coordinates of these points are calculated by averaging the coordinates of a group of neighbors to perform a less noise-prone resampling.

Consider the midpoint (x₀, y₀) of n contiguous points in a chain code of a curve, where n is an odd number, and let p=n/2+1 be the point (x₀, y₀). Thus, the initial point of the angle (x₁, y₁) is calculated from the n/2+1 previous point as

$${x}_{l} = \frac{{\sum }_{i = 1}^{p} {x}_{l}}{n / 2 + 1} , {y}_{l} = \frac{{\sum }_{i = 1}^{p} {y}_{l}}{n / 2 + 1} \qquad ( 3 )$$

and similarly for the end point of the angle (xr, yr)

$${x}_{r} = \frac{{\sum }_{i = p}^{n} {x}_{l}}{n / 2 + 1} , {y}_{r} = \frac{{\sum }_{i = p}^{n} {y}_{l}}{n / 2 + 1} \qquad ( 4 )$$

### Extracting Curve Features: Profile Curves

Profile curves include various other sources of valuable information. For example, one could be interested in the symmetry between left and right side of the profile curve. This information can be extracted into a signed curvature plot, and provides a valuable tool for the evaluation of object symmetry. Further an ideal model can be generated from the profile curve and used to evaluate how a real object deviates from this model.

### Extracting Surface Features: Facets on Surface

Another level of feature extraction deals with surfaces. By extracting surface information, one can retrieve 3D information rather than reducing a 3D phenomenon to 2D information. To extract surface information, the complete object has to be segmented into discipline specific and geometrically meaningful surfaces. Examples of such surfaces are the different facets on a lithic artifact such as the ventral surface, partial dorsal surfaces, and heel. These surfaces form the building blocks in any effort to refit these artifacts into a complex 3D jigsaw puzzle. FIG. 13 shows two pieces of an object, i.e. a core and flake of a stone artifact, which pieces fit together and each of which pieces has been segmented to extract its surface features for comparison.

Segmentation in this context thus refers to the problem of extracting features or regions of interest from surfaces. According to one aspect of the invention, the computerized segmentation of triangular mesh surfaces uses absolute curvature estimates along with the basic ideas of a Watershed algorithm to identify regions of interest and similarity on the surfaces of objects. Applications of this method have been found particularly useful in recognizing facets on a lithic artifacts, such as the lithic artifact shown in FIG. 13. These regions in turn form the basis for searching for matches between stone artifacts.

Based on the idea of a watershed as used in geography, in which a watershed forms the dividing line between drainage basins, the computerized watershed segmentation scheme defines minima to which water would flow from the peaks surrounding that minima. In contrast to a geography application, where this principle uses elevation in relation to neighboring areas as the defining characteristic for subdivision, this application uses absolute curvature allowing the recognition of peaks as well as valleys as the separating lines between watersheds. It was found that absolute curvature aided by smoothing equations yielded superior results to Gaussian curvature.

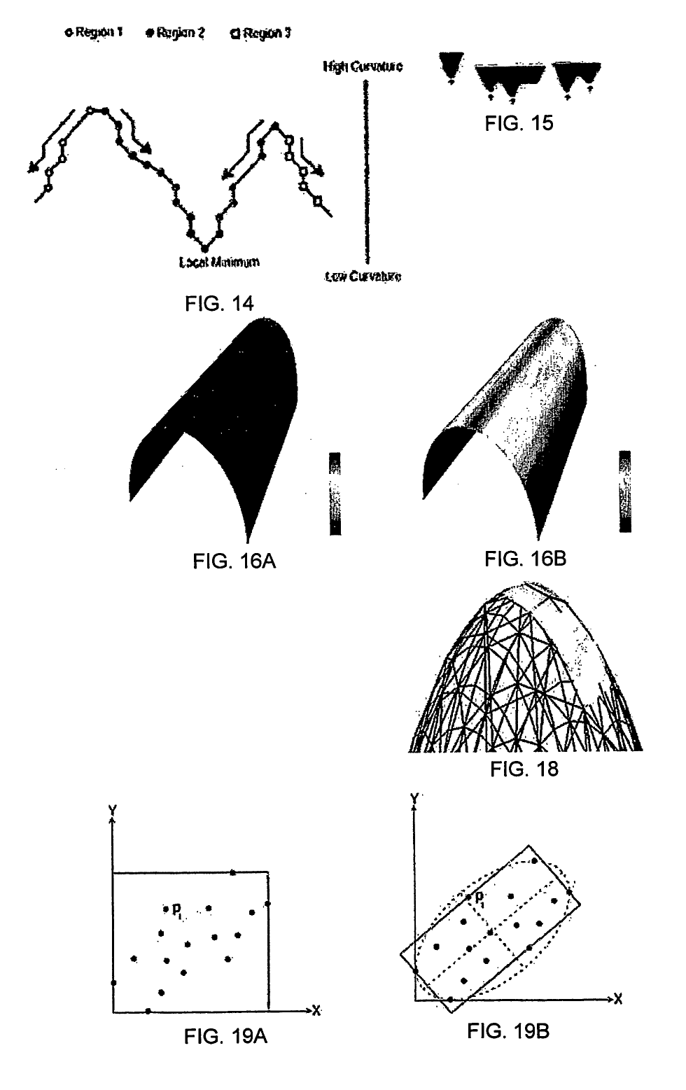

A first step in the segmentation process is the computation and storage of curvature at each vertex or data point in the original point cloud. (See FIG. 14) The curvature calculation for each point is based on a patch of nine or more points, around a particular vertex and the vertex itself. Next, absolute curvature minima are selected and form the “sink-holes” from individual regions. Subsequently, vertices are assigned to a specific minimum by determining the way the imaginary water would travel (down the steepest drop in absolute curvature in this case). The initial regions are typically too numerous to be useful, therefore, we increase the “watershed depth” to merge adjacent similar regions (See FIG. 15). Making the action of determining the watershed depth user defined we ensure flexibility to meet researcher needs. While significant depths that allow for the recognition of flake scars are typically found at similar watershed depths, these depths tend to be different for other application such as the recognition of joint surfaces or parts of a pot such as neck, body & base (FIG. 15). The segmentation algorithm is described in more detail below.

Methods for Extracting Curve Features

### Improved Curvature Estimation for Watershed Segmentation of 3-Dimensional Meshes

One advantageous method for extracting curve features from 3D meshes according to the invention uses an improved curvature estimation scheme for Watershed segmentation of the 3D meshes. The method improves upon the scheme proposed in A. Mangan and R. Whitaker. Partitioning 3D Surface Meshes Using Watershed Segmentation, IEEE Transactions on Visualization and Computer Graphics. Vol. 5, No. 4, Oct-Dec 1999 (Mangan and Whitaker) for segmenting a 3D polygonal mesh representation of an arbitrarily shaped real world object.

The domain of the problem, called a 3D mesh (denoted by ) consists of a set of n points (vertices vᵢ εE³; 0≦i<n) and a set of planar convex polygons (faces) made up of these vertices. 3D meshes are currently a popular surface modeling primitive, used extensively to represent real world and synthetic surfaces in computer graphics. In order to generate meshes, real world objects are often either digitized, i.e. point samples are collected from the surface of the object and their connectivity generated or sampled as a volume from which an isosurface is extracted. Alternately, the points (and their connectivity) are generated using computer programs, either interactively (e.g. using a surface design tool) or automatically (e.g. from a mathematical function). A mesh is a digital or discretized structure representing some continuous surface.

Segmentation means breaking down an existing structure into meaningful, connected sub-components. In the context of 3D meshes, the sub-components of the structure being broken down are sets of vertices called regions which share some “commonality.” A value λᵢ could be associated with each vertex vᵢ in the data set which somehow encapsulates the characteristics of the locality of the vertex. The definition of segmentation is one in which regions consist of connected vertices which have the same λ (within a tolerance). Curvature is selected as the mathematical basis for region separation, i.e. the scalar value λ. Previously, curvature estimation from 3D meshes has been dealt with by extracting curvature from a locally fitted quadratic polynomial approximant or by various discrete curvature approximation schemes. Vertices having the same curvature value would be grouped into regions, separated by vertices with high curvature (which serve as region boundaries).

The segmentation scheme described herein is derived from the watershed algorithm for 3D meshes described in Mangan and Whitaker. The watershed algorithm for image segmentation is well known in the 2D image segmentation field. Mangan and Whitaker generalize the watershed method to arbitrary meshes by using either the discrete Gaussian curvature or the norm of covariance of adjacent triangle normals at each mesh vertex as the height field, analogous to the pixel intensity on an image grid which drives the 2D watershed segmentation algorithm. Although the novel algorithm described herein is derived from Mangan and Whitaker, it differs in the curvature estimation scheme details and is far more stable for real world noisy data.

Surface Curvature

The quality of results from the watershed segmentation algorithm depends substantially on the accuracy and stability of the estimated curvature values. Curvature at the mesh vertices should faithfully reflect the local properties of the underlying surface. Additionally, it is useful to have a curvature calculation technique that can a) estimate curvature accurately on mesh boundaries where there usually aren't enough vertices distributed evenly around the vertex in question, and b) is relatively unaffected by noise in the data.

To provide an understanding of the improved curvature estimation scheme, various terms used in the theory of surface curvature will be briefly described.

The parametric surfaces considered are of the form
x=x(u); u=(u,v)ε[a,b]⊂R² (1)

where u and v are parameters which take real values and vary freely in the domain [a, b]. The functions x(u, v)=(x(u, v), y(u, v), z(u, v)) are single valued and continuous, and are assumed to possess continuous partial derivatives.

The first fundamental form, denoted by I is given by
I=\dot{x}.\dot{x}=Edu²+2Fdudv+Gdv² (2)

where
E=xᵤ²=xᵤ.xᵤ, F=xᵤ.xᵥ, G=xᵥ²=xᵥ.xᵥ. (3)

The second fundamental form, denoted by II given by
II=Ldu²+2Mdudv+Ndv², (4)

where
L=Nxᵤᵤ, M=Nxᵤᵥ, N=Nxᵥᵥ. (5)
and N is the surface normal at point x.

The normal curvature of the surface at point x in the direction of tangent t is given by

$${κ}_{0} = {κ}_{0} ( x ; t ) = \frac{II}{I} = \frac{{( {Lu}^{′} )}^{2} + 2 {Mu}^{′} {v}^{′} + {( {Nv}^{′} )}^{2}}{{( {Eu}^{′} )}^{2} + 2 {Fu}^{′} {v}^{′} + {( {Gv}^{′} )}^{2}} \qquad ( 6 )$$

Since the normal curvature is based on direction, it attains maximum and minimum values, called the principal curvatures. The principal curvatures, K₁ and K₂, can be combined to give us Gaussian curvature, given by

$$K = {κ}_{1} {κ}_{2} = \frac{LN - {M}^{2}}{EG - {F}^{2}} \qquad ( 7 )$$

Gaussian curvature is invariant under arbitrary transformations of the (u, v) parameters of a surface as long as the Jacobian of the (u, v) transformation are always non-zero. Gaussian and mean curvature are invariant to arbitrary rotations and translations of a surface because of the invariance of the E, F, G, L, M, N functions to rotations and translations.

Discrete Curvature Schemes

For the purpose of comparison, we first consider the two discrete curvature estimation schemes used in Mangan and Whitaker, i.e. the discrete Gaussian curvature scheme and the norm of the covariance of the surface normals of the triangles adjacent to the vertex at which curvature is being calculated.

Discrete Gaussian

The platelet Pᵢ of a vertex vᵢ is defined as the set of all triangles in the mesh sharing vᵢ as a vertex. The discrete Gaussian curvature K at vertex vᵢ is given by

$$K = \frac{{2}_{π} - Σ {α}_{j}}{\frac{1}{3} Σ {A}_{j}} \qquad ( 8 )$$

where aⱼ is the angle subtended at vᵢ by each triangle j in Pᵢ, and Aⱼ is the area of that triangle.

A problem that presents itself immediately is how to find the platelet of a vertex on the boundary of a mesh that is not closed (e.g., a mesh representing a sphere would be closed, i.e., have no boundary, while one representing a bounded plane would not be closed). The platelet of a boundary vertex would be incomplete, giving rise to an inaccurate computed value for curvature. One option is to simply ignore boundary vertices while computing curvature (setting their curvature to some fixed value). However, this often gives rise to unpleasant results during segmentation because such vertices tend to establish their own regions distinct from the rest of the mesh.

A solution to the problem would be to extend the mesh beyond the boundary in some “meaningful” way, allowing a curvature computation using the extended platelet. Such an extension is not trivial. It would have to somehow follow the shape of the mesh (and additionally, it is desirable that the extension be symmetric) in order for the boundary vertices to blend correctly into the existing mesh.

Gaussian curvature is an isometric invariant property of a surface. An isometric invariant is a surface property that depends only on the E, F, G functions (and possibly their derivatives). Isometric invariants are also known as intrinsic surface properties. An intrinsic property does not care how the surface is embedded in higher dimensional space. On the other hand other curvature metrics such as mean and absolute curvature are an extrinsic property which does depend on the embedding in 3D space. Intrinsic properties do not change sign when the direction of the normal vector of the surface is reversed. This is because the first fundamental form does not depend on the surface normal, while the second fundamental form does. Hence, Gaussian curvature maintains its sign when the direction of the normal vector is flipped whereas mean curvature (described below) flips its sign.

Isometric invariance is an undesirable property as far segmentation is concerned. For example, in FIG. 16, we would ideally want the left and right halves of the surface segmented into separate regions at the ridge. The Gaussian curvature plot shows that the curvature is constant throughout. The segmentation, being based on curvature distribution, would be unable to distinguish the halves. The mean curvature plot, on the other hand, shows the ridge being distinctly marked by high curvature. As an additional disadvantage, Gaussian curvature being the product of the principal curvatures, is more sensitive to noise.

Norm Method

The second method used in the original paper computes the norm of the covariance of the surface normals of the triangles adjacent to the vertex at which curvature is being calculated. This method, which we shall refer to as the Norm method, is more resilient to noise in the data. It is better than using Gaussian but does not perform as well as metrics used in the improved curvature described herein. This also has no direct geometric significance.

Improved Curvature Schemes

The principal curvatures can be combined in other useful and geometrically meaningful ways such as mean, RMS and absolute curvatures.

Mean curvature is given by

$$H = \frac{( {κ}_{1} + {κ}_{2} )}{2} = \frac{1}{2} \frac{NE - 2 MF + LG}{EG - {F}^{2}} \qquad ( 9 )$$

The mean curvature, being the average of the principal curvatures, is less sensitive to noise in numerical computation than the principal curvatures.

Root mean square curvature (RMS) is a good measure of surface flatness and is given by

$${κ}_{rms} = \sqrt{\frac{( {κ}_{1}^{2} + {κ}_{2}^{2} )}{2}} \qquad ( 10 )$$

and can easily be computed as
κᵣₘₛ=\sqrt{4H²−2K} (11)

A value of κᵣₘₛ=0 at a point indicates a perfectly flat surface in the neighborhood of that point.

Absolute curvature is given by
κ_{abs}=|κ₁|+|κ₂| (12)

Mean and RMS curvatures have a closed form as given by equations (9) and (11) and these do not require actual computation of principal curvatures. κ₀ and κ₁ are expensive to compute and hence the cost of computing Absolute curvature is considerably higher than computing mean and RMS counterparts.

Curvature Estimation

Curvature estimation from a triangulated mesh can be a non-trivial problem depending on the accuracy required and the method used. Our method uses a technique where the surface is approximated locally by a biquadratic polynomial whose second order mixed partial derivatives are calculated. These in turn allow computation of the E, F. G, L, M, N functions. An added advantage of fitting a surface locally is that the sensitivity of the surface to noise can be “adjusted” by using smoothing equations.

The parametric surface used is a tensor product Bézier surce and is given by:

$$x ( u , v ) = {\sum }_{i = 0}^{2} {\sum }_{j = 0}^{2} {b}_{i , j} {B}_{i}^{2} ( u ) {B}_{j}^{2} ( v ) ; u , v ∈ [ 0 , 1 ] \qquad ( 13 )$$

bᵢⱼ are called Bézier control points: in their natural ordering they are the vertices of the Bézier control net.

We perform a standard least squares fit to a set of vertices in order to compute the bᵢⱼ. The following were used to improve the local fit of the surface (FIG. 18).

1. Use double star of the vertex as input data points.

2. Add smoothing equations to the least squares solution

Selecting more vertices around the vertex for which the curvature is being computed ensures there are no gaps and the resulting surface does not behave wildly. The second option invokes constraints that a good control net would satisfy. One such constraint is to minimize the twist of the control net, which, for a surface is its mixed partial ∂²/∂u∂v. The twist surface of b^{m,n} is a Bézier surface of degree (m−1, n−1) and its vector coefficients have the form mnΔ^{1.1}bᵢⱼ. Geometrically mnΔ^{1,1}bᵢⱼ measures the deviation of each sub-quadrilateral of the Bézier net from a parallelogram. Minimizing the twist has the effect of making each sub-quadrilateral close to a parallelogram. The constraint can be stated as follows:
Δ^{1,1}b_{i,j}=0; 0≦i≦m−1, 0≦j≦n−1. (14)
From Equation 14, the condition can be restated as
b_{i+1,j+1}−b_{i,j+1}=b_{i+1,j}−b_{i,j}. (15)

Finally, fitting a surface of higher degree than 2 gives the surface greater freedom to match the underlying data points. However, surfaces of higher degree come at a higher computational cost. Moreover, fit offered by any surface of greater degree than a quadratic is usually a case of diminishing returns. A second-degree surface suffices for evaluation of second order partial derivatives.

The first three solutions presented above make the linear system over-determined. This system can be solved using least-squares methods. However, we need additional information i.e. parameter values associated to each vertex. This is solved as follows.

The data points (vertices) can be parameterized by projecting them onto a plane and scaling them to the [0, 1] range. If the data points (in 2D) are distributed as shown in FIG. 17A, with the min-max box as shown, scaling them to the [0, 1] range results in areas in the domain with no data points in them. This is undesirable as explained previously. To get a better parameterization we obtain as small an enclosing box as possible. This can be done by selecting a local coordinate frame such that the min-max box is minimized. This problem can be solved by finding the axes of the smallest ellipse that completely encloses the points. The axes of such an ellipse, called the norm ellipse, would then result in the smallest min-max box for the point set (see FIG. 17B).

The Watershed Algorithm

The watershed algorithm will now briefly be described. More details can be found in the in Mangan and Whitaker and the literature cited therein Once the curvature κᵢ at each vertex vᵢ in the mesh has been computed and stored, the segmentation can begin. κᵢ here represents a generic curvature metric and can be Gaussian, absolute, etc. During segmentation, a label will be assigned to each vertex v2 in the mesh indicating to which region the vertex belongs.

The 3D watershed segmentation scheme aims to segment the mesh into regions of relatively consistent curvature having high curvature boundary vertices. It is instructive to imagine the curvature distribution “function” (or the height function) as a surface on the given surface. The watershed algorithm operates on this (curvature) surface.

Convex areas (elevations) on the object have a high magnitude of curvature with a positive sign, while concave areas (depressions) have a high magnitude of curvature with a negative sign (except for curvatures which are positive by definition). High positive curvature would appear as a ridge on the curvature distribution function, while a high negative curvature would manifest itself as a valley. Since the original watershed segmentation algorithm segments the surface into regions separated by areas of high curvature, the valleys would not act as region separators as would be expected (see FIG. 19A). We only considered the magnitude of curvature (FIG. 19B) to solve this problem.

Results and Conclusions

A flexible segmentation program was implemented, with user control provided for changing parameters and thresholds in order to arrive at the desired segmentation of a surface. Here we show the results of our segmentation process.

Among continuous methods, mean curvature was more resilient to noise in numerical computation since it averages the principal curvatures. Being an extrinsic property, mean curvature produced results closer to the expected results which were based on user perception of shape. RMS curvature had its advantages when dealing with specialized segmentation. However, absolute curvature resulted in segmentations that generally outperformed all others. Like mean, the absolute curvature is the summation of (the absolute values of) κᵢ and κ₂ giving it greater noise resilience. Moreover, it is positive by definition unlike mean and Gaussian curvatures.

Comparison of Curvatures and their Estimation Techniques

Continuous curvature estimation methods resulted in more accurate curvature estimates than discrete methods. This was because:
Surfaces could be fitted to larger vertex neighborhoods, increasing the closeness of the fitted surface to the actual underlying surface.
Smoothing equations tended to offset the effect of missing data points and high frequency noise in the data set.
Boundary vertices did not need special consideration as in the discrete case since the surface could be fitted to more vertices on one side of the boundary.

Segmentation using different curvature metrics. Use of Mean and RMS results in almost the same quality segmentation as use of Absolute at a cheaper computation cost.

Segmentation of human trapezium (thumb joint) was performed using three methods for curvature approximation. Discrete Gaussian and Norm methods resulted in too many regions inconsistent with the geometry of the surface.

Segmentation of a lithic using three methods for curvature approximation. Discrete Gaussian and Norm methods produce geometrically inconsistent region where as absolute curvature results in correct segmentation.

| | |
|---|---|
| Worst | Gaussian (K) |
| | Mean (H) |
| | RMS (κᵣₘₛ₎ |
| Best | Absolute (κ_{abs)} |

### Table 1: Comparison of Curvature Measures for Segmentation

From the foregoing, it can be seen that an advantageous method for segmenting a 3D mesh has been presented using a 3D mesh watershed segmentation scheme. The segmentation is based on curvature, and therefore several curvature estimation techniques have been implemented and analyzed. The robustness of segmentation has been improved by increasing the accuracy of the curvature estimates by use of mean, RMS and absolute curvatures. The method successfully segmented several real world data sets, both digitized and synthetic, and often noisy, primarily because of the effort that went into developing better curvature estimation techniques.

The method can be implemented in a program is semi-automatic since the result is dependent on the merging threshold user input. One of the reasons why a single threshold does not produce the desired result on all data sets is that surfaces come in various sizes, and curvature is not scale invariant. Uniformly scaling the smallest bounding box of the input surfaces to a fixed size alleviates the problem to some extent. In fact, it was noted that surface data sets of the same type (e.g., pots) responded with very similar results for the same threshold values. The other reason for this is that a perfectly valid segmentation may disagree with the “expected” user perceived segmentation. This was especially true in this research since the segmentation goal for data sets from different disciplines was driven by the requirements of experts from those disciplines.

### A Hybrid Approach to Feature Segmentation of Triangle Meshes

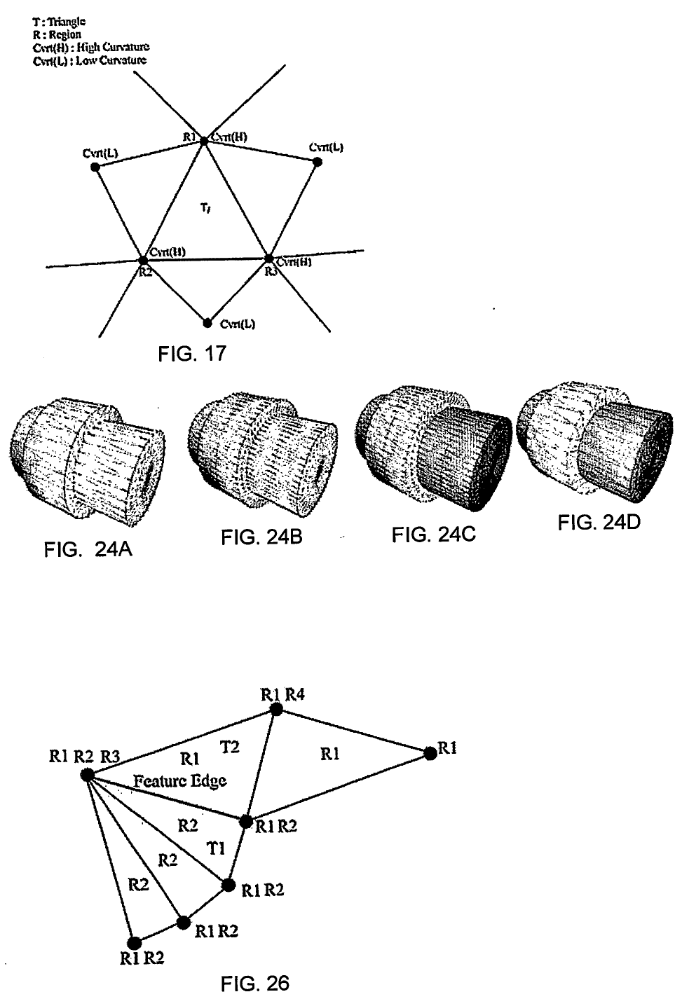

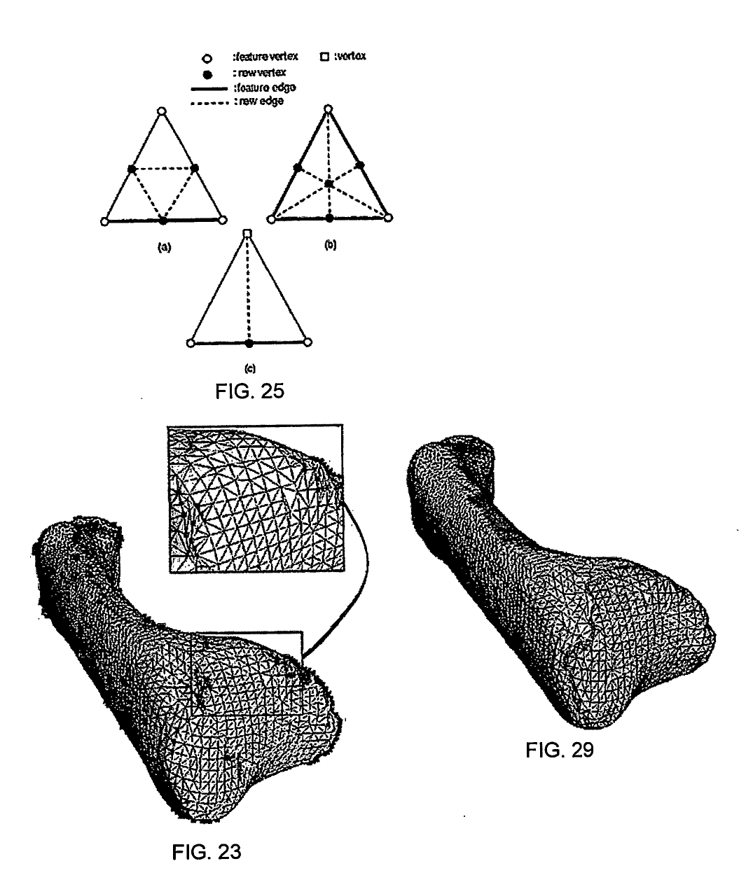

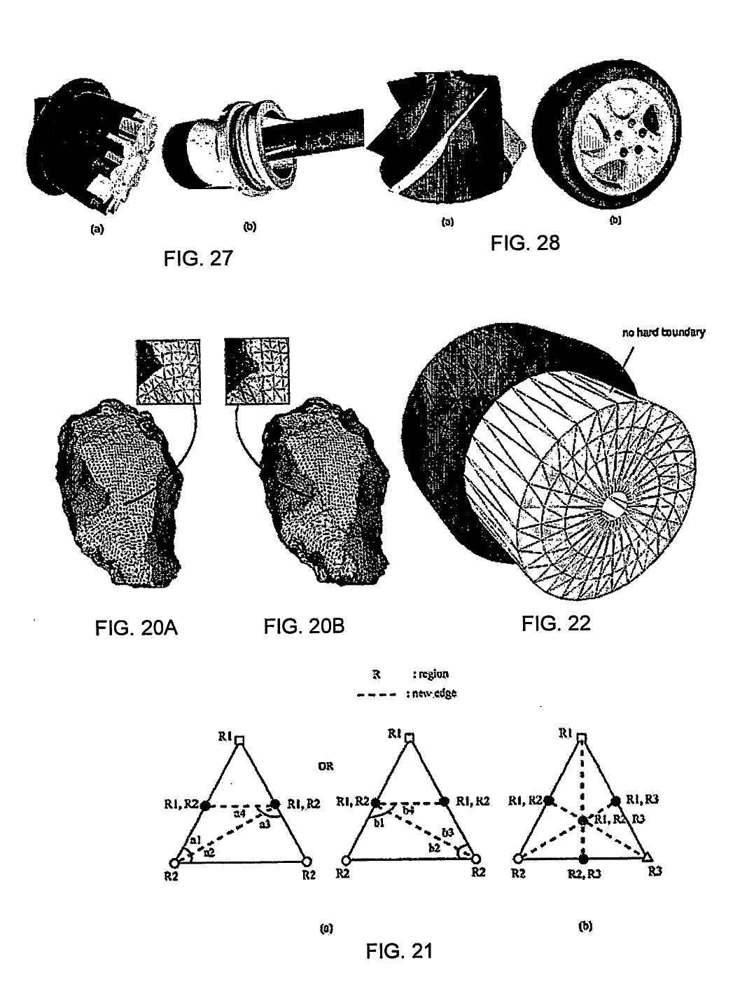

Another advantageous method for providing feature segmentation of triangle meshes according to the invention will now be described. Previous approaches for segmentation of polygonal meshes use a vertex-based method. A significant drawback of the vertex-based method is that no hard boundaries are created for the features or regions. Each vertex of an object has its own region information. Therefore, triangles on boundaries have multi-region information. The three vertices of a triangle can be part of three different regions, whereas the triangle itself would be a “gray” area, i.e. it would not belong to any one region. FIG. 20 shows an example where a triangle Tᵢ will be such a gray area. FIG. 20A shows an example of segmentation using the watershed method with no hard boundaries. In FIG. 20A the boundary triangles are shown in the white region. This means the regions will not have hard boundaries or edges. This is a known artifact of vertex-based Watershed segmentation and is acknowledged in Mangan and Whitaker. To provide a solution for this “no hard boundary” problem, the vertex-based method of feature segmentation creates new triangles by adding mid-points to the edges that have different region labels. FIG. 20B shows the segmentation example of FIG. 20A using the watershed method with such a boundary solution.

FIG. 21 illustrates the creation of triangles on boundaries of an original mesh according to the hybrid method. FIG. 21A shows the creation of triangles on boundaries of an original mesh for a triangle shared by two regions. FIG. 21B shows the creation of triangles on boundaries of an original mesh for a triangle shared by three regions. Referring to FIG. 21, each new vertex contains multiple labels. This is an extension of the original algorithm. For the selection of the label(s) of a vertex which has multiple labels, the common label of the vertices of the triangle is selected. In FIG. 21A, there are two possible diagonal splits to make triangles. We select the diagonal which satisfies max(min_{1≦i≦4}aᵢ, min_{1≦i≦4}bᵢ) where aᵢ and bᵢ are interior angles formed by the diagonals, i.e. select the diagonal that results in the best aspect ratio. Triangle meshes representing mechanical (CAD) objects are frequently sparse in some areas, with just enough vertices to define each area. This is usually a result of the optimal triangulation from a CAD program or decimation process. In this case, the Watershed method may not segment the object properly or may even lose important regions on the objects. In FIG. 22, the main regions of the object are treated as boundaries because there are not enough vertices in the regions. The boundary solution mentioned above will not solve this problem because the method does not create new regions from the boundary regions and the boundary regions will be lost. Moreover, some regions of this object are not segmented properly. This problem is caused by the vertices on feature edges with similar curvatures and those vertices may be treated as the same region. We solve this problem with our proposed no hard boundary approach.

Feature Segmentation Based on Dihedral Angle

This method uses an edge-based method for defining boundaries. A Feature Edge is defined as an edge shared by two planes whose normal vectors make an angle greater than a certain threshold. The edges obtained are integrated into curves, and these curves are classified as jump boundaries, folds (roof edges) and ridge lines. Jump boundaries and folds are used to segment the mesh into several regions. The boundary lines are also treated as Feature Edges.

The main disadvantage of the Feature Edge-based method is that this results in many disconnected Feature Edges and thereby incomplete Feature Loops. FIG. 23 shows this problem. Feature Edges are shown in the shaded spots.

Hybrid Approach

The hybrid method will now be described. This method creates regions with complete Feature Loops.

FIG. 24 shows the steps of the Hybrid method. As explained before, optimally triangulated meshes pose problems for the Watershed segmentation method. To overcome this, all of the feature edges in the mesh are identified using a threshold (angle). First, a Feature Vertices are defined as vertices that make up a Feature Edge. The reverse is not necessarily true; if both vertices of an edge are Feature Vertices, it does not automatically qualify the edge as a Feature Edge.

FIG. 25 illustrates the creation of triangles on feature edges of an original mesh.

Step 1—All Feature Vertices are first defined based on a threshold angle (dihedral angle) as explained above.

Step 2—Next, new vertices are added. Vertices are added to edges of all triangles that have all three vertices as Feature Vertices. See FIG. 25. The new vertex is added at the mid point of each edge. We then connect them as shown to create four new triangles. If the triangle has three Feature Edges, then the center point of the triangle is added and six new triangles are created as shown in FIG. 25B. Addition of vertices requires fixing of the topology as illustrated in FIG. 25C. The triangle shown is a neighbor of the triangle to which we added the vertices. This can lead to a hanging vertex problem. To fix this, we connect the new vertex with the vertex on the opposite edge to create two new triangles. As a result of the above, we have two kinds of new vertices; those that lie on the Feature Edges (labeled FV high) and those that do not (labeled as FV low). The reason for labeling is explained below.

Step 3—Watershed Segmentation

Next, we apply Watershed segmentation to our modified mesh. We use absolute curvature for our examples. Other curvature estimation methods may be used. Feature Vertices FV high are assigned the label of maximum curvature. Since they lie on a Feature Edge, assigning them high curvature ensures that a Feature Edge will be preserved as a hard edge. The rest of the vertices in the mesh follow the same procedure as described in the Watershed algorithm for computing curvatures at the vertices. The Feature Vertices contain their own region labels as well as labels of the neighboring vertices. The addition of vertices has an impact on the Descent and Region Merge operations of the Watershed process [9]. This is done to solve the \no hard boundary” problem which has been described and discussed before in this paper.

Step 4—Removing Vertices Added in Step 2

To restore the mesh to its original form we must remove the vertices added to the mesh in step 2 above. This process restores the topology of the mesh also.

Step 5—Collating Triangles into Regions

The goal of this step is to assign triangles and not vertices to different regions. This is achieved as follows:

1. Case: All vertices have the same label

This is simplest of the cases. The triangle is assigned the region label of its vertices.

2. Case: One vertex has a single label

This is the case when one vertex has a unique label but the other two vertices have multiple labels. The triangle is assigned the region of the vertex with single label.

3. Case: Multiple labels but only one common label.

The three vertices of the triangle have multiple labels each, however, there is only one label that is common. The triangle is assigned the region label that is common to the vertices in the triangle.

4. Case: All edges are Feature Edges

The triangle qualifies as a region by itself and gets assigned a unique region identifier.

5. Case: Multiple labels and multiple common labels

It is possible that the each vertex of a triangle has multiple labels and there is more than one common label. To explain this we will use the example in FIG. 26. Triangle T1 has vertices with region labels R1 and R2. One of the vertices also has the label R3. First, we check if a neighboring triangle shares a Feature edge with T1. In this case, we find T2 shares common Feature edge with T1. We then compare the common vertex labels of Ti (R1 R2) with common label(s) of T2 (R1). The label that does not belong to the set of common vertex label(s) of the neighboring triangle is assigned to the targeted triangle (R2).

If the targeted triangle has more than one feature edge, then the above process is repeated for each neighboring triangle that shares a feature edge 2. Each such neighbor contributes one or more labels. Then T1 is assigned the label that is common between the contributed labels. The targeted triangle may have no feature edge. It means that the triangle is in the same region as the regions of the neighboring triangles. So, the region label of any neighboring triangle is selected as the label of the targeted triangle. 2 Note that if all three edges are feature edges, then it is dealt under Case 4.

Results and Conclusions

The hybrid method relies on the Watershed method and additionally uses advantages of the dihedral angle method. The hybrid method does segmentation of smooth objects as well as mechanical objects. It also solves the “no hard boundary” problem. FIG. 27 shows two mechanical parts. FIG. 27A is a gear and FIG. 27B is a housing. FIG. 28A shows a turbine. Notice that each blade has been segmented into a different region. FIG. 28B is a wheel (rim and tire). It is segmented into the following regions i.e. the tire, rim, bolt holes and a hole for mounting the wheel. These are correctly segmented. All examples are from public domain data sets.

FIG. 29 shows the bone data (from FIG. 23) segmented using the hybrid method. We have pointed out the shortcomings of the most popular segmentation approaches for triangle meshes and devised a hybrid method that overcomes these shortcomings. Future work would involve automatic selection of threshold values both for watershed and dihedral angles.

### Data Compression Algorithms

As previously described, according to one aspect of the invention, the data compression module 121 compresses modeled data for enhanced storage and transmission. Two advantageous compression methods are (1) triangle mesh compression using B-spline curves and (2) compression using a subdivision surface scheme. Each of these compression methods will now be discussed.

### Triangle Mesh Compression Using B-Spline Curves

As more sophisticated objects are modeled or digitized, their triangle mesh representation becomes more complex and hence the size of such data increases considerably. Due to their large size, these files are difficult to transfer and take a long time even for viewing. Triangle Mesh Compression techniques exploit the geometric properties of the mesh representation to encode them into smaller files. A novel lossless compression scheme using B-Splines is described.

A triangle mesh representation consists of information about geometry and connectivity, also known as topology. Geometry defines the location of vertices in a (Euclidean) coordinate system. They are represented as triplets (x, y, z). Connectivity defines the sets of points that are connected to form triangles or faces of the mesh. Triangles are given by three index values, which identify the three vertices bounding the triangle.

Geometry information is usually compressed by quantizing the vertices. Based on the number of bits chosen to represent the floating point numbers, the location of the vertex is converted to integers on a grid. Note that even though there is loss in the geometric accuracy due to quantization, it is still referred to as Lossless compression. Lossless refers to the connectivity i.e. the triangle mesh is reproduced after decompression topologically exactly the same as the input mesh. A suitable prediction scheme is used and the displacement between the predicted and actual point is stored as an error vector. When the prediction is accurate, the error vectors are very small and hence can be stored using fewer bits. Connectivity compression is achieved by designing a traversal scheme, which encodes the unique path taken during mesh traversal, using predefined rules and tables.

The present novel compression scheme uses B-Splines and is loosely based on the ideas presented in the Edgebreaker algorithm described in J. Rossignac, Edgebreaker: Transactions on Visualization and Computer Graphics, 1999; J. Rossignac and A. Szymczak, triangle meshes conmpressed with Edgebreaker, Computational Geometry, Theory and Applications, 14(1/3), 119-135, November 1999; and J. Rossignac, A. Safonova, and A. Szym, Edgebreaker on a Corner-Table, Conference, Gemoa, Italy. May 2001 (Edgebreaker). A brief description of the Edgebreaker algorithm follows.

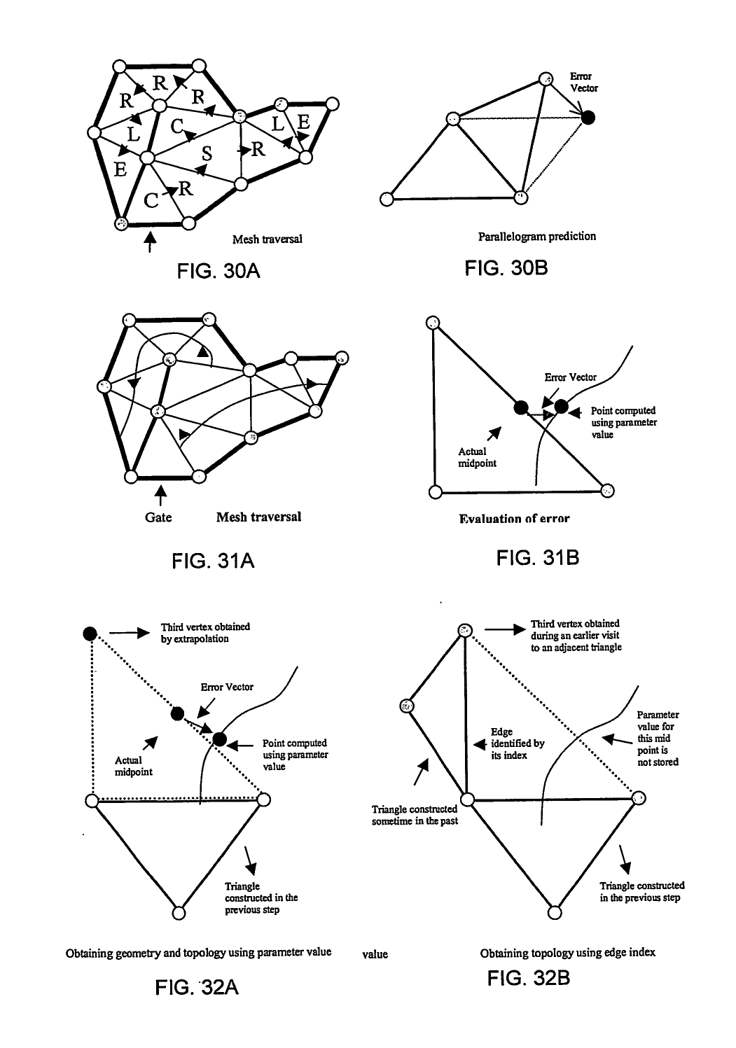

A “seed triangle” is randomly picked from the mesh. Starting from it, the mesh is traversed one triangle at a time, based on rules of traversal. The edge through which the seed triangle is entered is called a “gate.” The path taken is written as a combination of codes. When a triangle is entered, it is marked as visited; all of its vertices are also marked as visited. As we move from one triangle to another, the farther vertex of the entered triangle is predicted based on the three vertices of the first triangle, using parallelogram prediction (FIG. 30). The difference between the predicted vertex and the actual vertex is then stored as an error vector.

The error vectors are stored only for vertices which have not been visited yet. Hence, after the traversal, the number of codes would be equal to the number of triangles and there is exactly one error vector corresponding to each vertex.

The topology is encoded as a series of codes corresponding to the mesh traversal, and the geometry is encoded as error vectors. Using this information, the original mesh is reconstructed during decompression.

During our tests we noticed that topology encoding makes up for roughly 10% of the compressed file (compressed using Edgebreaker). The challenge then is to reduce the compressed file size related to the geometry. Hence there is a need for a better prediction algorithm than the parallelogram method. We experimented with B-Splines. The dual benefit of using our method are that even though we use the mesh traversal method of Edgebreaker during compression we do not store any codes, and, the error prediction is improved. The connectivity is the automatic result of the algorithm. First we describe the compression.

Compression

The B-Spline compression scheme uses the same traversal rules as described in Edgebreaker. However in our method, when we move from one triangle to the neighboring one, the mid point of the common edge is recorded. Once all the triangles are visited, many sequences of triangles, called triangle strips, are obtained. Each such strip has a corresponding sequence of edge mid points, to which a B-Spline curve is fit using least squares approximation. The order in which the B-Spline curves are generated is recorded (FIG. 31). The parameter value, corresponding to each midpoint on the curve, and the error vector, which is the difference between the actual position of the midpoint and the one computed using the parameter value, are also recorded.

The parameter value is stored only if the vertex opposite to the gate has not been visited yet. If it is marked as visited due to the traversal of an adjoining triangle earlier in the compression process, the index of the edge that is shared with that adjoining triangle is stored for referencing it during decompression. This avoids storing the already visited vertices multiple times.

Decompression

After the compression process, we obtain an ordered set of B-Spline control points, the parameter values corresponding to the midpoints of edges and the error vector associated with each midpoint. The two vertices forming the gate edge are also given.

During decompression, the B-Spline curves are evaluated at their set of parameter values in the order in which they were created. Each point thus evaluated on the curve is then displaced by the corresponding error vector to generate a mid point (FIG. 32). This mid point, along with one of the two points obtained during the previous step (during the first step, they would be the gate vertices) is used to determine the third vertex forming the triangle.

Points that are revisited store a reference to the edge common between the current triangle and the adjoining one visited previously. This edge is used to locate the actual point, which is then used to construct the current triangle.

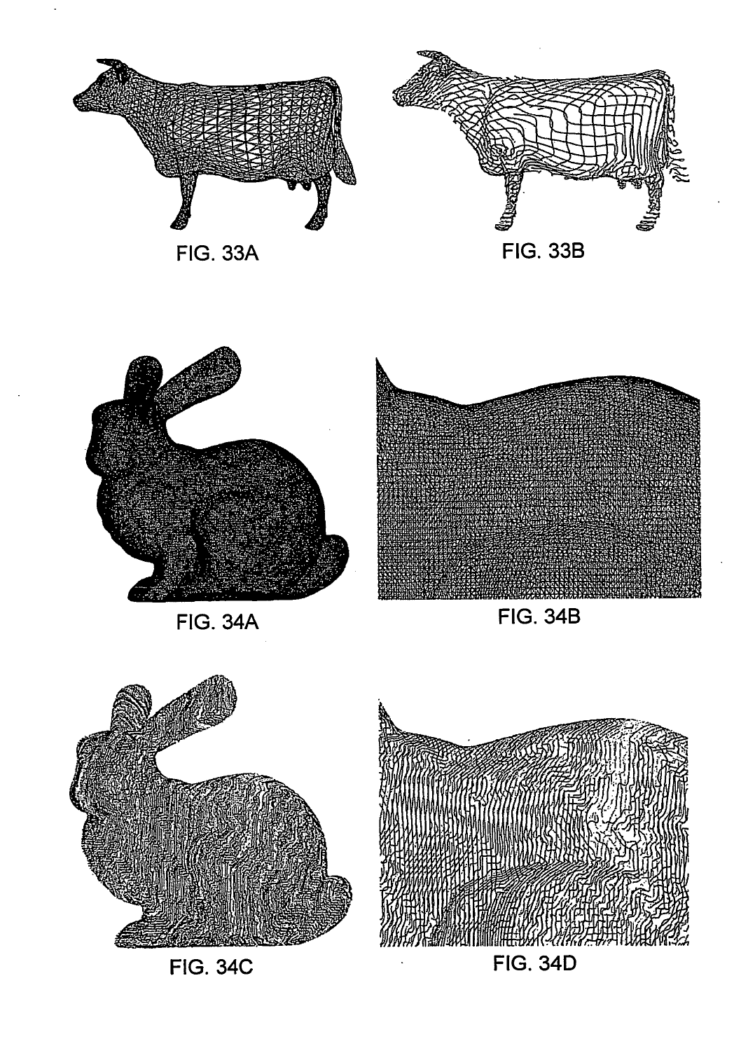

Preliminary results obtained by compression using the B-Spline scheme are very encouraging. The control polygon points and the error vectors are stored as triples of floating point numbers, each stored using 8 bits. The number of bits used to store parameter values is dynamically computed based on number of points on the B-Spline curve and is typically 5 bits. The B-Spline curves used for our experiments are of degree five and have uniform parameterization (FIGS. 33 and 34).

We note the following two differences from Edgebreaker algorithm. First, information about both geometry and topology is encoded into the B-Spline curves. Hence, unlike Edgebreaker, our method does not store codes for topology. Second, the error vectors associated with mid-points using B-Splines are about ten times smaller than the error vectors obtained in Edgebreaker, which uses parallelogram prediction. On an average, the compressed file size is 10% smaller than that of Edgebreaker.

### Compression using a Subdivision Surface Scheme

Subdivision surfaces are finding their way into many Computer Aided Design and Animation packages. Popular choices include Loop, Catmull-Clark, Doo-Sabin etc. Subdivision surfaces have many design advantages over traditional use of NURBs. NURB surfaces always are problematic when multiple patches meet.

Reverse engineering (RE) is associated with the idea of scanning physical objects and representing the resulting dense cloud of points with mathematical surfaces. In RE the goal is to convert the dense point of scanned points into a patchwork of NURB surfaces with most effort going into automating the process. With the emergence of subdivision surfaces as popular modeling tools, it only follows that a similar process be devised for this class of surfaces. Our paper looks at developing one such method for Loop surfaces.

Given a dense triangular mesh, we would Eke to obtain a control mesh for a Loop subdivision surface which approximates the given mesh. This process benefits subdivision surfaces in animation and manipulation that need speed over accuracy with an ability to manipulate the control mesh and to regenerate the smooth surface quickly. Like subdivision wavelets in a multi-resolution analysis, our method can perform level-of-details (LOD) with arbitrary topological meshes useful in applications requiring a fast transfer, less storage, and a fast rendering and interaction. The resulting coarse control mesh is approximately 6.25% of the original mesh therefore this method can also be used as a lossy compression scheme.

Given dense unorganized data points such as a point cloud from a range scanner, a triangle mesh can be constructed by various methods known in the art. However, triangular meshes obtained are piecewise linear surfaces. For editing, modeling, etc. dense triangle meshes are not an optimal solution. Dense triangle meshes with lot of detail are expensive to represent, store, transmit and manipulate. A tensor product NURBS (Non Uniform Rational B-Splines) and B-splines are the most popular smooth surface representations. Considerable work has been done on fitting B-spline surfaces to three-dimensional points. This process is often called the Reverse Engineering process wherein a digital representation of the physical object is created.

A B-spline surface is a parametric surface, and it needs a parametric domain. Previously, some have proposed methods for parameterizing a triangular mesh and unorganized points respectively for a single surface patch A single B-spline patch can only model surfaces with simple topological types such as deformed planar regions, cylinders, and tori. Therefore, it is impossible to use a single non-degenerate B-spline to model general closed surfaces or surfaces with handles. Multiple B-spline patches are needed for arbitrary topological surfaces; however, there are some geometric continuity conditions that must be met for adjacent patches. Therefore, using NURBS/B-splines is not the most desirable approach since it requires high-dimensional constrained optimization. A subdivision surface scheme such as Loops, does not suffer from these problems, has compact storage and simple representation (as triangle base mesh) and can be evaluated on the fly to any resolution with ease. It does not require computation of a domain surface.

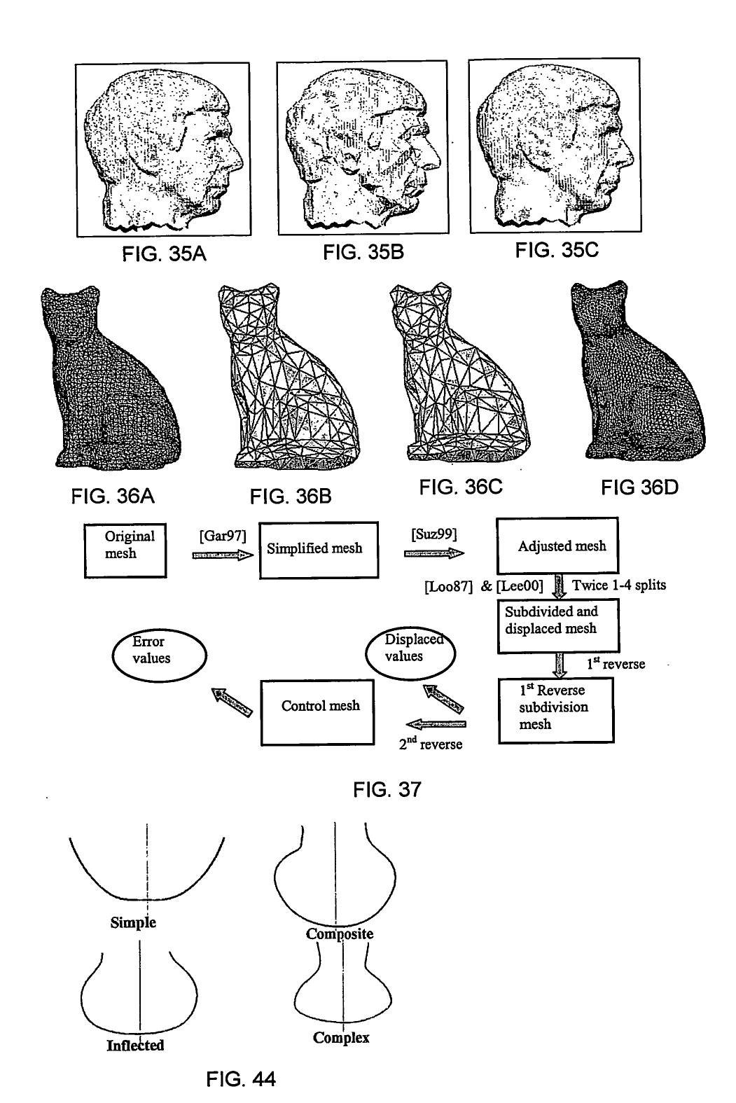

Similar in nature to subdivision wavelets, we would like to obtain a control mesh approximating original surface with small magnitude of details (as a scalar function) needed to best reconstruct an approximation of the original mesh (FIG. 35). The benefit of using a scalar-valued function is that its representation is more compact than its traditional counterpart, a vector-valued geometry representation. One of our contributions is to obtain a control mesh with very small magnitude of displaced values (details) in order to have a very high compression ratio while preserving surface details given a semi-regular (subdivision connectivity) of the original mesh.

Subdivision Surfaces

A subdivision surface is defined by a refinement of an initial control mesh. In the limit of the refinement process, a smooth surface is obtained. Subdivision schemes previously have been introduced based on quadrilateral meshes. These schemes generalized bi-quadratic and bi-cubic tensor product B-splines. The triangular based subdivision scheme was introduced by Loop which was a generalization of C² quartic triangular B-splines.

Remeshing

Remeshing means to convert a general triangle mesh and into a semi-regular mesh. It is called a semi-regular mesh because most vertices are regular (valence six) except at some vertices (vertices from a control mesh not having valence six).

Semi-regular mesh can be used for multi-resolution analysis. Through the remeshing process a parameterization can be constructed and used in other contexts such as texture mapping or NURBS patches.

The overview of our method is as follows: an original mesh is simplified by a quadric error metric (QEM) based on Garland, M., and Heckbert, P. S. Surface simplification using quadric error metrics. Proceedings of the 24th annual conference on Computer graphics and interactive techniques August 1997 to get a simplified control mesh. We decimate the mesh to 6.25% of the number of original triangles. Based on Sizuki, H., Takeuchi, S., and Kanai, T Subdivision Surface Fitting to a Range of Points. Computer Graphics and Applications, Proceedings. Seventh Pacific Conference, 1999, the control mesh is then adjusted such that after some levels of subdivision the control mesh vertices lie close to the original surface. The adjusted control mesh is then subdivided using the Loop's scheme Loop, C Smooth subdivision surfaces based on triangles. Master's thesis, University of Utah, Department of mathematics, 1987 for two levels obtaining subdivided mesh with its number of triangles close to that of the original mesh. Based on Lee, A., Moreton, H., Hoppe, H. Displaced Subdivision Surfaces. Proceedings of the annual conference on Computer graphics (SIGGRAPH 2000), 2000, the subdivided mesh vertices are then displaced to the original surface. Our remeshing process is shown in FIG. 36. Most or all vertices, however, require displacements during this process even if the control mesh has been adjusted previously. With that in mind, we need to reverse the process of Loop subdivision scheme to obtain a better control mesh with smaller and fewer displacement values (details). A flow chart of our process is shown in FIG. 37.

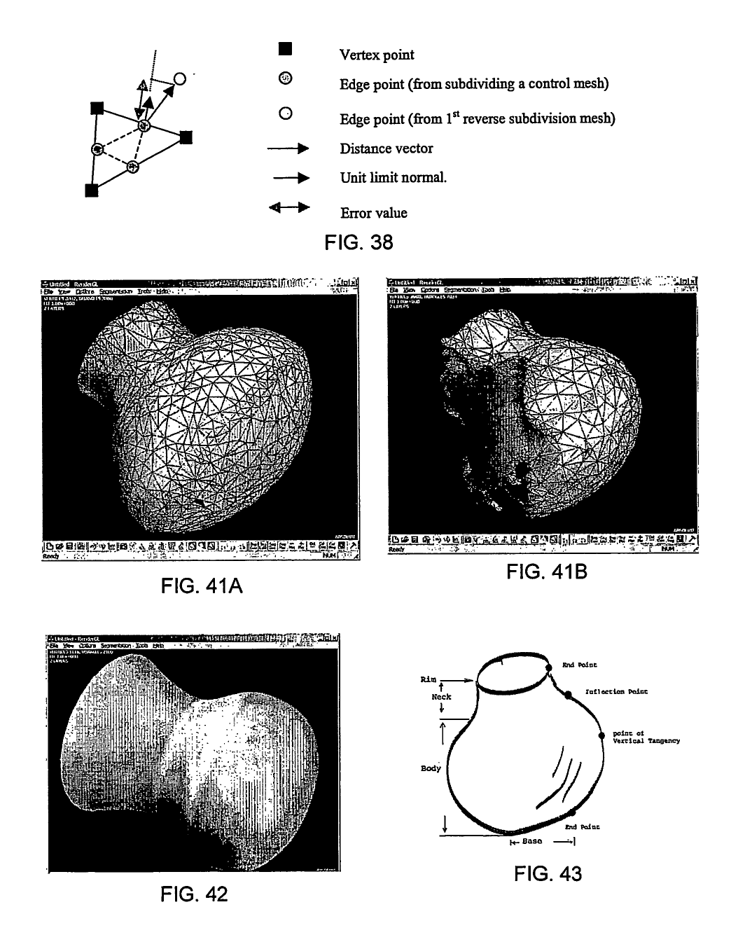

In the Loop subdivision, each subdividing level produces two types of vertices: vertex points and edge points as shown in FIG. 38. After obtaining the subdivided and displaced mesh, the mesh is semi-regular (subdivision connectivity) and all vertices lie on the original surface.

$${M}_{( n + m ) xn} [ \begin{matrix}{v}_{1}^{i - 1} \\ {v}_{2}^{i - 1} \\ . \\ . \\ . \\ {v}_{n - 1}^{i - 1} \\ {v}_{n}^{i - 1}\end{matrix} ] = [ \begin{matrix}{v}_{1}^{i} \\ {v}_{2}^{i} \\ . \\ . \\ . \\ {v}_{n - 1}^{i} \\ {v}_{n}^{i} \\ {e}_{1}^{i} \\ {e}_{2}^{i} \\ . \\ . \\ . \\ {e}_{m - 1}^{i} \\ {e}_{m}^{i}\end{matrix} ] {M}_{nxn} [ \begin{matrix}{v}_{1}^{i - 1} \\ {v}_{2}^{i - 1} \\ . \\ . \\ . \\ {v}_{n - 1}^{i - 1} \\ {v}_{n}^{i - 1}\end{matrix} ] = [ \begin{matrix}{v}_{1}^{i} \\ {v}_{2}^{i} \\ . \\ . \\ . \\ {v}_{n - 1}^{i} \\ {v}_{n}^{i}\end{matrix} ] [ \begin{matrix}{v}_{1}^{i - 1} \\ {v}_{2}^{i - 1} \\ . \\ . \\ . \\ {v}_{n - 1}^{i - 1} \\ {v}_{n}^{i - 1}\end{matrix} ] = {M}_{nxn}^{- 1} [ \begin{matrix}{v}_{1}^{i} \\ {v}_{2}^{i} \\ . \\ . \\ . \\ {v}_{n - 1}^{i} \\ {v}_{n}^{i}\end{matrix} ] \\ Where , \\ v is a vertex point \\ e is an edge point \\ i is subdivision level \\ M is a Loop subdivision matrix$$

The first reverse step applies to the mesh to obtain a coarser 1^{st} reverse subdivision mesh. We don't choose a subdivision matrix in FIG. 39A because both vertex points and edge points are used in solving linear system of equation. The subdivision matrix is not a square matrix, and we need to do least-square approximation via the normal equations to obtain the control vertices. If that has been done, displaced values would have been required for all vertices (both vertex points and edge points), and by doing that it defeats our goal of having fewer number of required detail values (displaced values and error values) and small magnitudes needed for high compression . Therefore, only the subdivision matrix for vertex points as shown in FIG. 39B is used instead. Here, the matrix is a square matrix and is invertible assuming a vertex general position. We could solve for exact control vertices. For large linear system, we use Gauss-Shedel iterative approach to solve the linear system. Now, we need to calculate displaced values and save them for a reconstruction phase. To get them, we internally subdivide the 1^{st} reverse subdivision mesh one level. The vertex points of this subdivided mesh (level 1) are about 25% of total vertices, and they all have zero displaced values. The edge points may or may not require displaced values. The percentage of edge points requires zero displaced values as shown in Table 2. Note that the computation for displaced values for edge points at this level is to find the distance along each vertex limit normal intersecting with the original surface.

In the second reverse step, we again solve for the control vertices of the 1^{st} reverse mesh in similar- manner to that of the first reverse step. However, the error values (or what we call the displaced values in the first reverse step) for the edge points are computed differently as shown in FIG. 38. The error values are computed as a dot product of edge point unit limit-normal and vector from its position (obtained from subdividing the solved control mesh) to its corresponding position (obtained from the 1^{st} reverse subdivision mesh). The end result is a very small coarse mesh plus some details using which one can approximate the input mesh. The coarse mesh can be used as a model much like the NURBS/B-spline control mesh or the model and detail can be used as a lossy compression scheme.

We reconstruct and compare a number of well-known data sets as shown in FIG. 40. After obtaining control meshes, we losslessly compress them using software by 3D Compression Technologies Inc. to further reduce the output file size. For the encoding of details (error values and displaced values) we vary the quantization level from 8 to 12 bits per detail value for comparison. Magnitude of Loop vertex limit normal is used as a scaling factor to further reduce the already small detail values. We compare the result between 8-bit and 12-bit detail encoding and found that by encoding with lower bits (8 bits), the reconstructed surface is as good as that of the higher bits (12 bits). In addition, 8-bit quantization would produce higher number zero details, which can be further encoded using variable-length scheme. In the variable-length encoding, each detail value is either encoded by 1 bit for zero detail value or 9 bits otherwise. The ninth bit is to indicate the required detail encoding. As a result, our output surfaces have high fidelity of original surface details as well as high compression ratio. Table 1 below shows percentage of vertices requiring no displacedment values at different levels. Comparison of the quantitative compression results among 8-bit detail encoding, 12-bit detail encoding, and 9-bit variable-length detail encoding (OPTZ) are shown in Table 3.

TABLE 2
Zero displacement at each level (with 8-bit quantization).

| | | | % of no. of vertex | | Total % of no. |
|---|---|---|---|---|---|
| | | | points (all vertex | % of no. of edge | of points |
| Data | | | points require zero | points with zero | requiring zero |
| #V | Level | #V | displacement) | displacement | displacement |
| Spock* | Control mesh | 1,039 | | | |
| 16,389 | 1 | 4,121 | 25.21 | 15.97 | 41.18 |
| | 2 | 16,417 | 25.10 | 62.65 | 87.75 |
| Igea* | Control mesh | 2,102 | | | |
| 33,587 | 1 | 8,398 | 25.02 | 8.86 | 33.88 |
| | 2 | 33,586 | 25.00 | 20.47 | 45.47 |
| Bunny+ | Control mesh | 2,206 | | | |
| 35,280 | 1 | 8,818 | 25.02 | 13.60 | 38.62 |
| | 2 | 35,266 | 25.00 | 24.34 | 49.34 |
| Horse* | Control mesh | 3,032 | | | |
| 48,485 | 1 | 12,122 | 25.01 | 55.02 | 80.03 |
| | 2 | 48,482 | 25.00 | 72.15 | 97.15 |

TABLE 3
Quantitative compression results.

| | | | Output | | | | | | |
|---|---|---|---|---|---|---|---|---|---|
| | | | Control mesh | | | | | | |
| | | | | Size | Size | | | | Compress |
| Input | | | | before | after | Details (displacement) | | | (control |
| | #V | Size | #V | 3DCP | 3DCP | 8 bits | 12 bits | OPTZ | mesh + |
| Data | #T | (KB) | #T | (KB) | (KB) | (KB) | (KB) | (KB) | OPTZ) |
| Spock * | 16,389 | 575 | 1,039 | 36.13 | 3.54 | 15.87 | 22.87 | 6.21 | 98.30% |
| | 32,718 | | 2,044 | | | | | | |
| Igea * | 33,587 | 1,181 | 2,102 | 73.82 | 5.85 | 31.18 | 46.18 | 27.15 | 97.21% |
| | 67,170 | | 4,198 | | | | | | |
| Bunny + | 35,280 | 1,240 | 2,206 | 77.5 | 6.16 | 32.5 | 48.5 | 26.76 | 97.35% |
| | 70,556 | | 4,408 | | | | | | |
| Horse * | 48,485 | 1,704 | 3,032 | 106.5 | 6.21 | 44.5 | 67.5 | 9.25 | 99.09% |
| | 96,966 | | 6,060 | | | | | | |

Legend:
Data with * courtesy of Cyberware; + courtesy of Stanford Univ. Computer Graphics Lab
#V = Number of vertices
#T = Number of triangles
KB = Kilo-Bytes
3DCP = Lossless compression by 3DCompress.com software (performed on control-meshes)
OPTZ = Optimized encoding scheme (variable-length encoding)

According to the novel method disclosed, we can approximate any arbitrary topological boundary and non-boundary surfaces with high compression and details. We have combined subdivision surface and scalar-valued displacement for our surface reconstruction. Our domain surface is obtained in such a way that it is close to the original surface, the magnitude of displaced values tends to be very small and is favorable as a compression scheme. With the high compression and faithfully detailed surface, the method is can be used for applications such as mesh compression, animation, surface editing and manipulation.

### Curve Matching Algorithm

According to another aspect of the invention, the system can perform curve matching to compare the similarity or dissimilarity of two shapes. As used herein “shape” means a two or three-dimensional curve. One of the important characteristics of a curve is its curvature. Curvature is very useful for analysis and classification of curve shape. We assume A and B to be free form curves such that, either curvatures can be computed, or these can be approximated by a function or a parametric curve of degree two or higher. In 3D space the curvature of curves is unsigned. However, for planar curves in 3D space, we can represent curvature as a signed quantity.

A curve matching method according to the invention compares two curves to obtain a measure, which decides the similarity on the analysis of the curvature plots of the curves. The curvature plot of the curve with smaller chord length is slid along the curvature plot of the longer one. The difference in areas of the curvature plots is obtained and the minimum difference value is attributed to the amount of match between the curves.

The method of curve matching has been implemented on the profile curves of pots, which profile curves are constructed by fitting a least squares curve to the points obtained by intersecting a 3D vessel with a cutting plane.

Curvature

The curvature of a curve measures its failure to be in a straight line. The faster the first derivative X′(t) turns along the curve X(t), the larger is its curvature. Curvature is defined as the rate of change of the unit tangent vector X′(t). For a straight line, the curvature is zero as its second derivative vanishes. For a circle, the curvature is constant. Let X(t)=(x(t), y(t), z(t)) be a curve, then the curvature at t, k(t), is defined as

$$k = k ( t ) = \frac{‖ \dot{X} \hat{} \ddot{X} ‖}{{‖ \dot{X} ‖}^{3}} \qquad ( 1 )$$

where X=dX/dt and X=d²X/dt² and “” denotes the cross product. A three-dimensional curve has non-negative curvature. For planar curves, we may assign the signed curvature as,

$$k = k ( t ) = \frac{det [ \dot{X} , \ddot{X} ]}{{‖ \dot{X} ‖}^{3}} \qquad ( 2 )$$

The points at which the curvature changes sign are called inflection points. Therefore, a planar curve may have inflection points but, a three dimensional curve has none.

Curve Matching Algorithm

Given two curves as input, the curve-matching method according to the invention computes a measure that determines the similarity between the curves. For planar curves in 3D space, the curvature plot of the curve having the smaller chordlength is slid along the curvature plot of the other curve. The difference in areas of the curvature plot is computed by an integration routine such as the Trapezoidal rule or Simpsons rule. The minimum difference in area is noted and this, along with a weighted component of the difference in chordlengths of the curves, produces a measure which determines the similarity between curves.

Given two curves A and B to match, the first step is to evaluate the chordlengths of the curves. The two chordlengths are compared and the minimum of the two is used to select the length of the unit interval. What this means is that, the two curves are discretised into intervals of the same length. The selection of the unit interval length determines the precision of the result. The greater the number of discrete intervals, the more accurate is the similarity metric.

$$δ = \frac{min ( {l}_{A} , {l}_{B} )}{N} \qquad ( 3 )$$

where, l_{A} is the chordlength of curve A, l_{B} is the chordlength of curve B and N is the number of discreet intervals.

The parameter values of the two curves are then recomputed with respect to their chordlengths. To find the new parameter value, the following procedure is used:

A graph is plotted with the chordlength as the X-axis and the parameter value as the Y-axis. At discrete intervals of the curve, the corresponding parameter value is computed by interpolating the corresponding graph points. This procedure ensures that the curvature plot of the curve is drawn with respect to the chordlength.

After obtaining the new parameter values of the curves, the first derivative and second derivative are computed at the discretised points. They are used to compute the curvature at these points. These are the curvature function ƒ_{A} and ƒ_{B} of the curves A and B respectively.

The curvature plots of the two curves are then analyzed to measure the similarity between the two curves. The minimum difference of the two curvature functions determines the measure for curve matching.

$${Area}_{min} = {min}_{a} {\int }_{a}^{a + {l}_{A}} {[ {f}_{A} - {f}_{B} ]}^{2} \qquad ( 4 )$$

This can be viewed as sliding (this is discreet sliding) the curvature plot of the curve with smaller arc length along the curvature plot of the other, and the difference in curvature plot areas is calculated at all positions. Since, the curves and their curvature plots are in discrete form, with the same index representation, this is a matter of finding the area by trapezoidal rule. Different methods of computing this difference in area can be used, such as the trapezoidal rule, Simpsons rule, and Riemann sum. The trapezoidal is the simplest. For better results a more appropriate method may be used. The minimum curvature area difference (Areaₘᵢₙ) and its position (a) are noted from the above process.

Let (l_{A},ƒ_{A}) and (l_{B},ƒ_{B}) be the lengths and curvature functions of the two curves A and B. Then, the total difference (d) will be,

$$d = \sqrt{{{s}_{1} ( {l}_{A} - {l}_{B} )}^{2} + {s}_{2} {min}_{a} {\int }_{a}^{a + {l}_{A}} {[ {f}_{A} - {f}_{B} ]}^{2}} \qquad ( 5 )$$

In the above formula s₁ is a factor contributing to the difference in chordlengths of the curves and s₂ is the factor contributing to their shapes (curvature). A weighted combination of shape and size gives a good metric to match the curves. A percentage match value (permatch) can be computed using the following formula:

$$permatch = ( 1 - \frac{d}{{f}_{A}} ) * 100 \qquad ( 6 )$$

It can be observed that the percentage match is always between 0 and 100. The percentage match can be used as an important factor when querying a database for similar shapes. The best case occurs when a curve is compared with itself. In that case, the difference in the chordlengths is zero and the difference in the curvature plot area is zero. The value of the metric is zero. This is a perfect match: A=B. In other cases, when a curve A is compared with another curve B having a different chordlength and curvature plot, the difference in the chordlengths is positive and the difference in the areas of the curvature plot is also positive. The value of the metric is positive. The metric determines the amount of similarity.

The different combinations of the weights s1 and s2 in the above equation leads to different types of matches, i.e. partial matches, exact matches and shape matches. Variations in s₁ and s₂ and each of these different types of matches will now be described.

The first type curve matching that will be described is the partial match. Given two curves A and B, there is always a possibility that one curve is a part of the other. But where exactly do they fit each other? Sliding one curve over the other is quite computationally intensive because the orientation of the curves may differ. By using the method of curvature plots, one can slide the curvature plot of one curve over the curvature plot of the other curve, which is similar to sliding one curve over the other. Since the method uses curvature, which is transformation invariant, the problems caused by orientation of curves are avoided. For a partial match of curves, the shape and size of the curves are considered. In a partial match, the chordlengths of the two curves may or may not be equal. The curvature plot of the smaller curve is slid along the curvature plot of the bigger one. The difference in area is computed using the trapezoidal rule. In a partial match no weight is attributed to the difference in chordlengths. The minimum difference in area and its corresponding position are noted. This is the best possible partial match. A threshold can be taken as a user input, which determines how close the curves should be. The metric for curve similarity is as follows:

$$d = min {\int }_{a}^{a + {l}_{A}} {[ {f}_{A} - {f}_{B} ]}^{2} \qquad ( 7 )$$

where d is the measure for curve matching and ƒ_{A} and ƒ_{B} are the curvature functions of the two curves A and B, respectively. If the value of the measure d=0, then A=B. If the value of the measure d≦threshold, then A⊂B.

The next type of curve matching that will be discussed is the exact match. In the case of partial matches it was observed that the curvature plots and their analysis are a better tool to determine the similarity between curves. However, in partial matches, the difference in the chordlengths of the two curves was not taken into consideration. In the exact match type of matching both the shape and the size of the curves are taken into consideration while determining the similarity between them. The curvature plot sliding is used as the main tool here to determine similarity, hence, making this method transformation invariant.

In the exact match of curves, the chordlengths of the two curves may or may not be equal. Therefore, the curvature plot of the smaller curve is slid along the curvature plot of the bigger curve and the minimum difference in area is calculated by the trapezoid rule and the corresponding position noted. This position is the best possible partial match. A weighted difference of the chordlengths is added to obtain a metric for curve similarity as follows:

$$d = \sqrt{{s1 ( {l}_{A} - {l}_{B} )}^{2} + {s}_{2} min {\int }_{a}^{a + {l}_{A}} {[ {f}_{A} - {f}_{B} ]}^{2}} \qquad ( 8 )$$

where, d is the measure for curve matching, s₁ is the weight attributed to the difference in chordllengths, s₂ is the weight attributed to the difference in the areas of the curvature plots, l_{A} is the length of curve A, l_{B} is the length of the curve B, ƒ_{A} and ƒ_{B} are the curvature functions of the two curves A and B respectively. The value of the measure d determines the similarity between the curves.

The third type of curve matching is the shape match. Matching two curves by their shape must be size independent. For example, one may want to compare the similarity between a smaller circle and a bigger one. In this case, the shape matching metric should show a perfect shape match. Thus, to perform a shape match, the input curves are pre-scaled to the same size. The scaling is done with respect to the chordlength of the curves. The process of scaling is as follows:

Given two curves A and B as inputs, the first step is to compute their chordlengths. Let l_{A} be the chordlength of the first curve and let l_{B} be the chordlength of the second curve. Let s be the scaling factor. Mathematically, s is defined as

$$s = \frac{{l}_{A}}{{l}_{B}} \qquad ( 9 )$$

The curves are initially discretised and the curvature values are computed at the discretised points. The curve with smaller chordlength is now scaled by the scaling factor s, which essentially means that the chordlength values of the smaller curve are scaled by s and the curvature values are scaled by 1/s; After the process of scaling is completed, the difference in areas of the curvature plots is computed by one of the integration routines previously discussed. This difference in area is the metric determining the similarity between the two curves. The metric for curve similarity is as follows:

$$d = min {\int }_{0}^{a} {[ {f}_{A} - {f}_{B} ]}^{2} \qquad ( 10 )$$

If the value of the measure d=0,then curve A and curve B are of similar shape. Thus, two similar curves with different sizes be compared for shape using this method.

The foregoing method obtains a measure for matching two curves. The method provides an estimation of the shape similarity by the property of curvature of each of the curves. The difference in areas of the curvature plots of the two curves is estimated and this measure is used to determine the similarity. If the value of the measure is small then the shapes are similar and if it is large, they are dissimilar. According to the invention, this curve matching method described above can be used to query data sets for matching curves.

### EXAMPLE USES

The following examples serve to illustrate certain presently preferred embodiments and aspects of the invention. These examples are not to be construed as limiting the scope of the invention.

Three of the examples describe projects that involve archaeological and biological material, namely ceramic vessels, lithic artifacts, and bones. These projects are: (1) “3D Morphology of Ceramic Vessels” which has been used for archiving and searching information about the structure of ceramic vessels; (2) “Lithic Refitting” which has been used to (partially) automate the refitting process through 3D scanning and surface modeling; and finally (3) “3D Topography of Joint Surfaces” which has been used to automate segmentation of osteological features and quantify the surface area and curvature of joint surfaces and the congruency between reciprocal joint surfaces, allowing for the development of biomechanical models. Common to all of these projects are the following aspects of the invention: geometric modeling, feature recognition, and the development of a database structure aimed at making 3D models of these artifacts available online for query.

### Example 1

### 3D Morphology of Ceramic Vessels

3D knowledge plays an important role in archaeology. For example, archaeologists study the 3D form of Native American pottery to characterize the development of cultures. Conventionally, vessel classification is done by an expert and is subjective and prone to inaccuracies. The measurements are crude and in some case eyeballing is the method of choice.

As part of the 3DK project at Arizona State University in Tempe, Ariz., a system according to the present invention has been developed as a pilot project for the study of the 3D morphology of prehistoric Native American ceramic vessels. The aim of this pilot project is to learn about vessel uniformity, and variation with respect to function as indicators of developing craft specialization and complex social organization among prehistoric Native American cultures. To accurately capture the complex curvatures and vessel form and size variation, the use of metric rulers and visual inspection of 21) profiles is inadequate. Therefore, for the study of prehistoric pottery traditions, scalable, visual, and quantitative comparisons of curvatures have been developed according to the invention.

Archaeological vessels were scanned and defined as a set of three-dimensional triangulated meshes composed of points, edges and triangles. The original data was then modeled with parametric surfaces, extracting features to raise the level of abstraction of data and organizing vessel data based on XML schema. A Web-based visual query interface permits users to sketch or select sample vessel shapes to augment text and metric search criteria to retrieve original and modeled data, and interactive 2D and 3D models.

Key identifying features of the vessels were identified to support search and data retrieval, and a catalog of terms was developed to describe these features within the context of anthropological description, cataloging standards, and emerging metadata classifications. Mathematical models were developed to translate these features into measurable descriptions. Software was developed to extract features from the vessel data and to raise the level of abstraction of data. An additional result is generation of vessel measurements far more accurate than has been possible using the traditional tools of anthropology.

Shape information is obtained from scanned three- dimensional data of the archaeological vessels, using 2D and 3D geometric models to represent scanned vessels, extracting feature information from geometric models and storing the feature information in a database for Web-based retrieval. A Web-based Visual Query Interface (VQI) is used to archive and search vessels.

Based on 3D scanned data, 2D measurements (height, rim diameter, minimum diameter, maximum diameter) and 3D measurements (area, volume, volume of wall) were generated, and a measure of symmetry was developed. The pilot project used a control collection consisting of two Mexican flower pots, two Mexican mold-made pifiata pots, and three hand-built Tarahumara jars to verify the validity of the formulas generated. The prehistoric collections studied consist of a total of 87 Native American vessels from the Tonto Basin, Arizona, and Casas Grandes in northern Mexico. The control study and the two sets of prehistoric vessels are used to generate a quantitative analysis of vessel uniformity and symmetry. The automated measurements are important improvements, which facilitate the quantitative assessment of ceramic uniformity and standardization, indicators of the development of craft specialization, differentiation of labor, and the development of complex forms of social organization among prehistoric cultures.

For data acquisition, each vessel was scanned using a laser scanner to create a 3D scan of a given vessel. The data acquisition device 130 included two scanners. The first is a Cyberware Model 15 scanner, which is a mobile scanner having a width of about 75 cm and is particularly useful for smaller objects. The second laser scanner is a Cyberware Model 303ORGB/.NS scanner, which is large stationary scanner allowing the capture of large objects. Both of these scanners are marketed by Cyberware, Inc. of Monterey, Calif. Both scanners are equipped with a turntable on which the object to be scanned is mounted. Resolution and accuracy of the scans are a result of the distance between the scanning head and the object. The large scanner is therefore less accurate than the small scanner. Specifics on accuracy and resolution of the laser scanners are available from Cyberware, Inc. While individual scans take only 17 seconds, the total average scanning time for each vessel is about two hours, depending on complexity, color, texture, etc. The scanning produces data as a highly dense “point cloud” of information that visually describes, but does not physically represent the vessel.

The vessel data was modeled with parametric surfaces by overlaying a three-dimensional triangulated mesh onto the point cloud data to define the vessel as a set of three-dimensional triangulated meshes composed of points and triangles. Post processing included filling of holes (due to scanner “oversight”), removing noise, etc. A Ball Pivoting algorithm was implemented to convert point cloud data sets into triangle meshes. In some cases light decimation was performed to reduce the density without losing accuracy of the overall structure. The result is valid point set and topology data for each scanned vessel. The result is a model of the vessel that is composed of parametric surfaces with physical, measurable attributes.

Mostly archaeological vessels are (approximately) surfaces of revolution, and studying contour shape will suffice to gather shape information about the whole object. According to archaeological definition, there are four kinds of feature points on profile curves to calculate dimensions and proportions of vessels. They are End Points, Points of Vertical Tangency, Inflection Points and Corner Points found on the vertical profile curve of a vessel. End Points (Eps) are points at the rim (lip) or at the base (i.e. top and bottom of vessels). Points of Vertical Tangency (VTs) are points at the place where is the maximum diameter on spheroidal form or minimum diameter on hyperbolic form. Inflection Points (IPs) are points of change from concave to convex, or vice versa Corner Points (CPs) are points of sharp change on a profile curve. FIG. 43 illustrates these four kinds of feature points of vessel profile curves.

Four features are common to all vessels, i.e. orifice, rim, body and base. Orifice is the opening of the vessel, or the minimum diameter of the opening, which may be the same as the rim, or below the rim. Rim is the finished edge of the top or opening of the vessel. It may or may not be the same as the orifice. It may have a larger diameter. Body is the form of the vessel below the orifice and above the base. Base is the bottom of the vessel, portion upon which it rests, or sits on a surface. The base may be convex, flat, or concave, or a combination of these. FIG. 44 illustrates four kinds of bases, i.e.: (a) convex base; (b) flat base with zero curvature; (c) concave base; and (d) composite base.

From the foregoing definition for characteristic points and common features for all vessels, feature representation of vessels was formalized as follows:

<Point Feature>:=<End Point Feature>|<Point of Vertical Tangency Feature>|<Inflection Point Feature>|<Corner Point Feature>;

<Curve Feature>:=<Rim Curve Feature>|<Orifice Curve Feature>|<Base Curve Feature>;

<Rim Curve Feature>:=<End Point Feature><End Point Feature>;

<Orifice Curve Feature>:<Corner Point Feature><Corner Point Feature>;

<Base Curve Feature>:=<End Point Feature>|<End Point Feature><End Point Feature><Region Feature>:=<Neck Region Feature>|<Body Region Feature>|<Base Region Feature>;

<Neck Region Feature>:=<Rim Curve Feature><Orifice Curve Feature>;

<Body Region Feature>:=<Orifice Curve Feature><Base Curve Feature>;

<Base Region Feature>:=<Base Curve Feature>;

<Volume Feature>:=<Unrestricted Volume Feature>|<Restricted Volume Feature>.

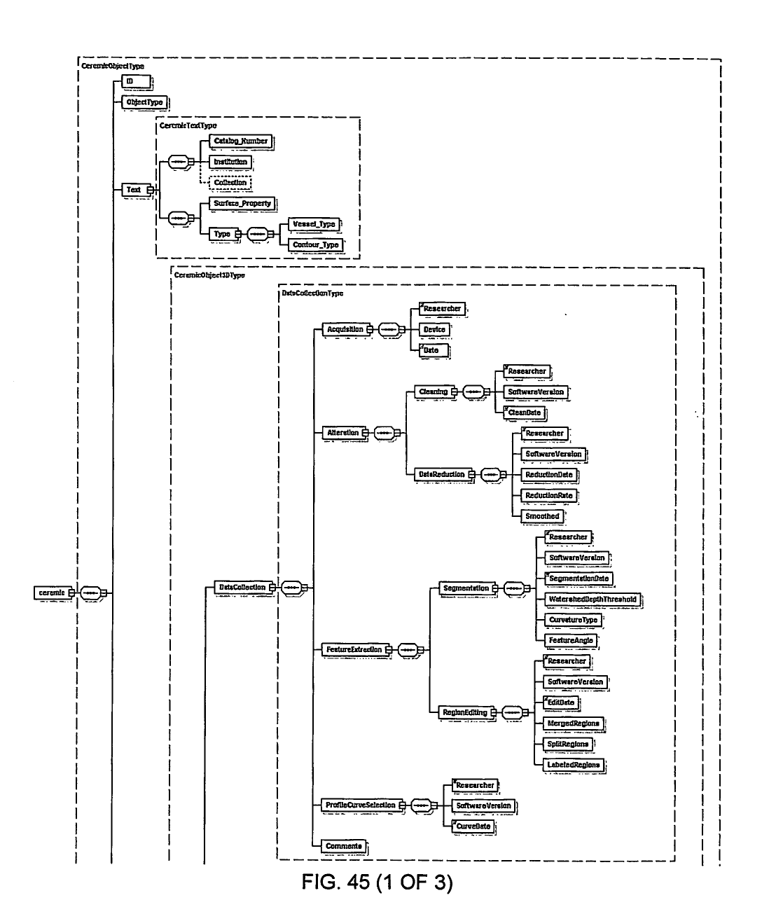

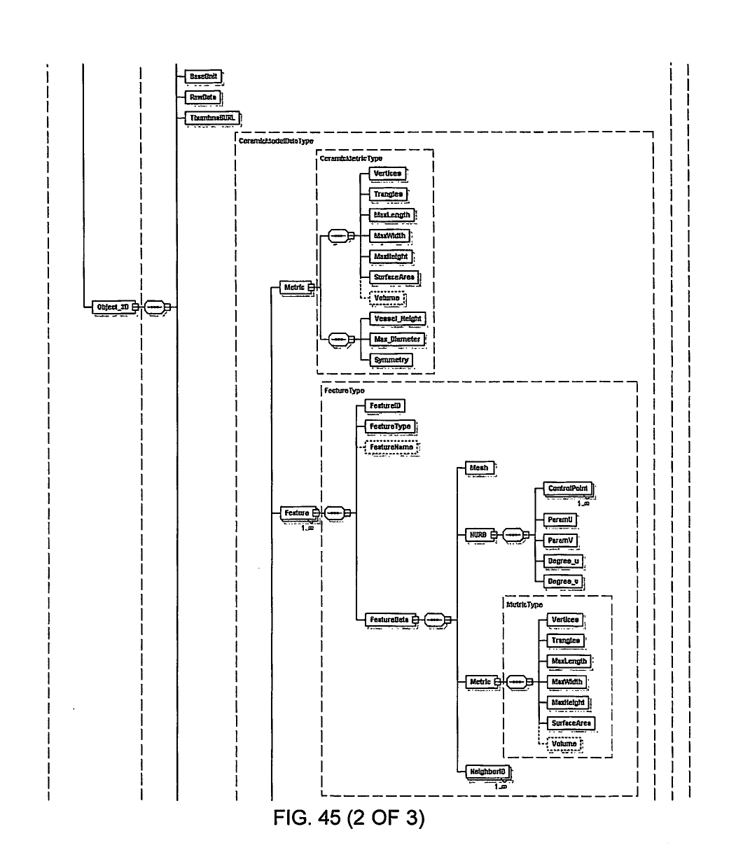

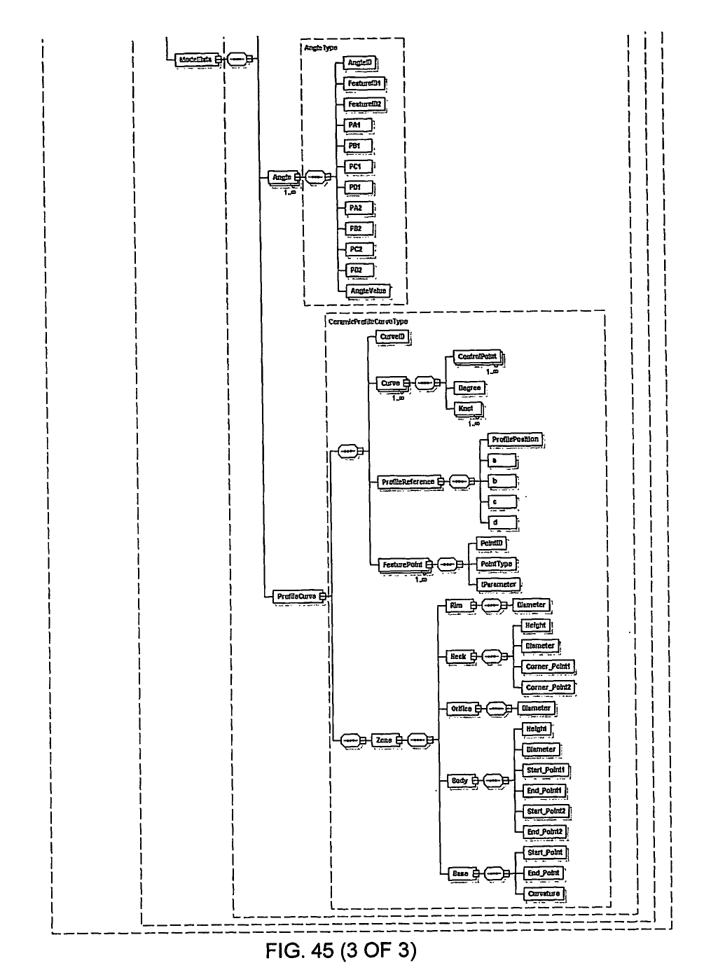

XML was used to represent information of vessels. An XML schema, as shown in FIG. 45, was designed to represent geometric information, feature information and measured value of archaeological vessels. Feature information is extracted from geometric information and is organized according to the feature formalism in the XML schema. Also feature information is used to index vessels stored in the database. The XML schema for a sample vessel with values is shown in Appendix 1.

As discussed above, the result of the 3D laser scan of the vessel and initial processing is a polygonal mesh composed of faces, edges and vertices and their connections. Surface models are generated from the scattered points of this polygonal mesh by least squares fitting and/or rotating profile curves. B-Spline surfaces are used to represent these surface models. The B-Spline models are used for model rebuilding, error analysis, closing holes and gaps found on the archaeological artifacts, and measured value getting.

The mathematical modeling algorithms described herein were used to pass surfaces through scanned point cloud data to generate measurable data from these relatively small, diverse data sets. Surface and volume modeling algorithms were applied to model and generate quantitative, descriptive data about the artifact. The data and processes developed grew from and are consistent with the descriptive vocabulary of ceramics researchers in Anthropology. The level of accuracy in documentation and measurement of the artifacts far exceeded traditional techniques used in the field. The binary and derived data about the vessel provide a record that can be re-analyzed in the future and provide a tool for research without physical access, at remote locations, or after repatriation of the vessel. FIG. 41 shows two examples of polygon meshes with watershed defined areas. FIG. 41A shows a complete vessel and FIG. 41B shows a partial vessel. FIG. 42 illustrates feature segmentation of a complex shaped vessel.

Archaeologists analyze vessels by defining various regions using a profile. The profile curve is obtained by passing a vertical plane perpendicular to the base through the vessel. Typically profile curves are sketched free hand, often by tracing and duplicating half of the vessel to create a symmetric, but not necessarily accurate, representation. In this research the polygonal mesh model is used to generate a much more accurate profile curve than has been previously possible. The resulting profile curve is processed to remove noise due to scanning error at the rim. Vessels are initially cataloged into four broad shape categories—simple, composite, inflected, and complex.

A segmentation schemes based on curvature, as described herein, was used and therefore several curvature estimation techniques were used. The robustness of segmentation has been improved by increasing the accuracy of the curvature estimates. Due to the accuracy required for good segmentation, computing curvature is a complex, non-trivial task. In this research, multiple curvature estimation schemes were used and compared. The estimation schemes can be broadly classified into two categories—discrete and continuous. Discrete schemes extract curvature directly from the geometry of the mesh by estimating the local deviation of the mesh from a flat surface. Continuous schemes first approximate the mesh vertices locally with a polynomial surface, allowing calculation of various forms of curvature from the resulting analytic surface by methods of differential geometry.

The original scanned data, and the modeled and calculated data have been linked to existing record sets containing the traditional descriptive data about location, provenance, and collection of the vessels. The XML schema using a metadata schema derived from the Council for the Preservation of Anthropological Records (COPAR). Was used to catalog and organize the 2D and 3D vessel data. The schema defines data elements for a given artifact, and links data across multiple databases was developed and implemented to support research queries. The 2D data from existing databases can be incorporated by using the schema to translate and link the search processes with databases housing the 3D data. The project provides access to data from the existing ceramic vessel databases and additional spatial and volume data acquired for scanned vessels.

To provide efficient access, a scanned vessel database was developed. The database is structured to house the original binary data files, modeled files, derived measurement, features, and other descriptive data. A master pot identification number is used as the key to link these data elements with additional vessel data in existing databases. This structure permits additional databases to link to the query engine by adding a field with the master pot ID to each record set, and developing an XML schema and DTD to link related data fields between the databases. It is scalable as a proof of concept, is consistent with Dublin Core cataloging structures, and requires minimal coding to provide access to additional databases.

A visual query interface as described above was used to permit users to interact with the data using sketches or by selecting sample vessel shapes to augment text and metric search criteria to retrieve original and modeled data, and interactive 2D and 3D models.

This project successfully implemented a powerful system of 3D modeling and analysis techniques to provide descriptive data and support research into vessel shape and structure. It is interesting to note that even measurements that are relatively coarse from a computer science modeling perspective offer significant improvements in accuracy for ceramic researchers. The ability to search and compare these accurate models of vessels offers new tools to ceramic vessel researchers.

### Example 2

### Lithic Tool Manufacture and Refitting

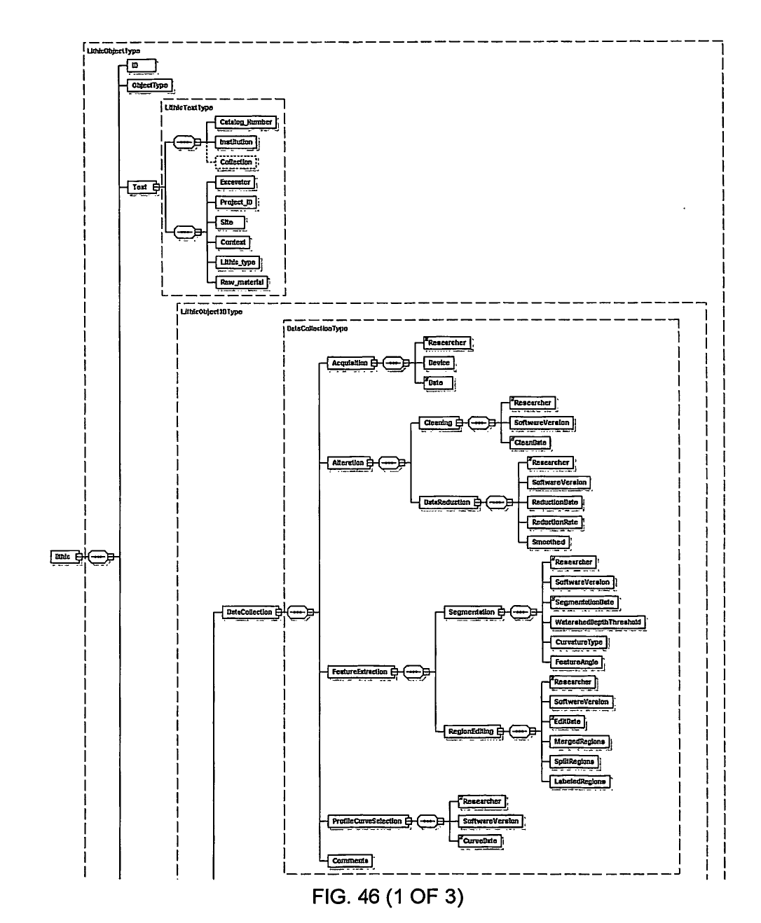

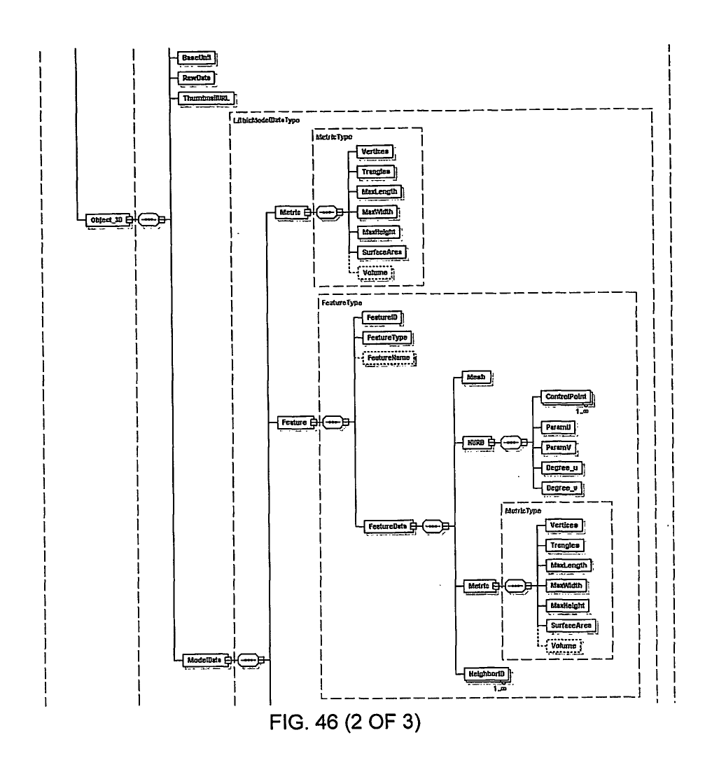

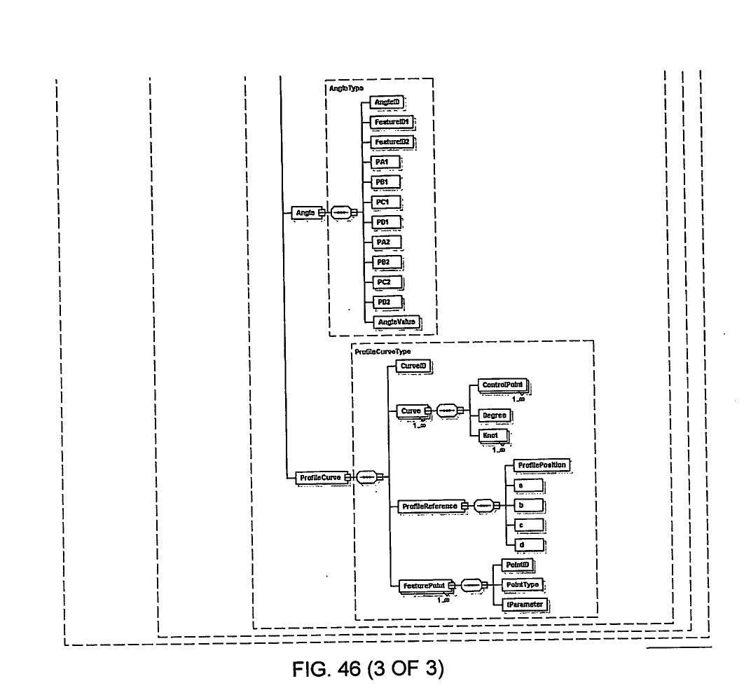

The goal of the lithic refitting pilot project is the reconstruction of stone tool manufacturing activities within prehistoric archaeological sites and related cultural behaviors by identifying sequences of conjoining lithic artifacts. Refitting lithic artifacts by manual trial and error is an accurate, but highly labor-intensive, method that requires the entire sample of artifacts to be present in a single lab. These conditions are not always possible given various antiquities restrictions. Automated 3D surface matching of conjoinable artifacts will dramatically enhance the efficiency of this valuable analytic method and extend the scope of searches to collections from different sites. Lithic refitting, or assembling the pieces of stone, broken apart by prehistoric people, has proven very useful in our attempt to better understand the prehistoric past. The technique is especially useful in technological studies, taphonomic research, and spatial analysis. The 3DK project is developing software that would reduce the time cost of refitting and facilitate development of an electronic database storing 3D images of lithic collections available for study by researchers all over the world. FIG. 46 describes the XML schema used for lithics.

### Example 3

### 3D Topography of Joint Surfaces

The objective of the “3D topography of joint surfaces pilot project” is to further the understanding of the abilities, limitations, and adaptations of our early human ancestors to make tools and walk upright by developing biomechanical models of manipulative and locomotor behavior using 3D osteological data. Use of calipers and visual inspection are inadequate to capture the complex curvatures of 3D joint surfaces and to control for body size differences in cross-species comparisons. This can be overcome by developing scalable, quantitative models of reciprocal wrist, hand, and knee joint surfaces that will allow for comparative quantative analysis of the effect of surface area, curvature, and congruency on joint mechanics in extant and fossil apes and humans.

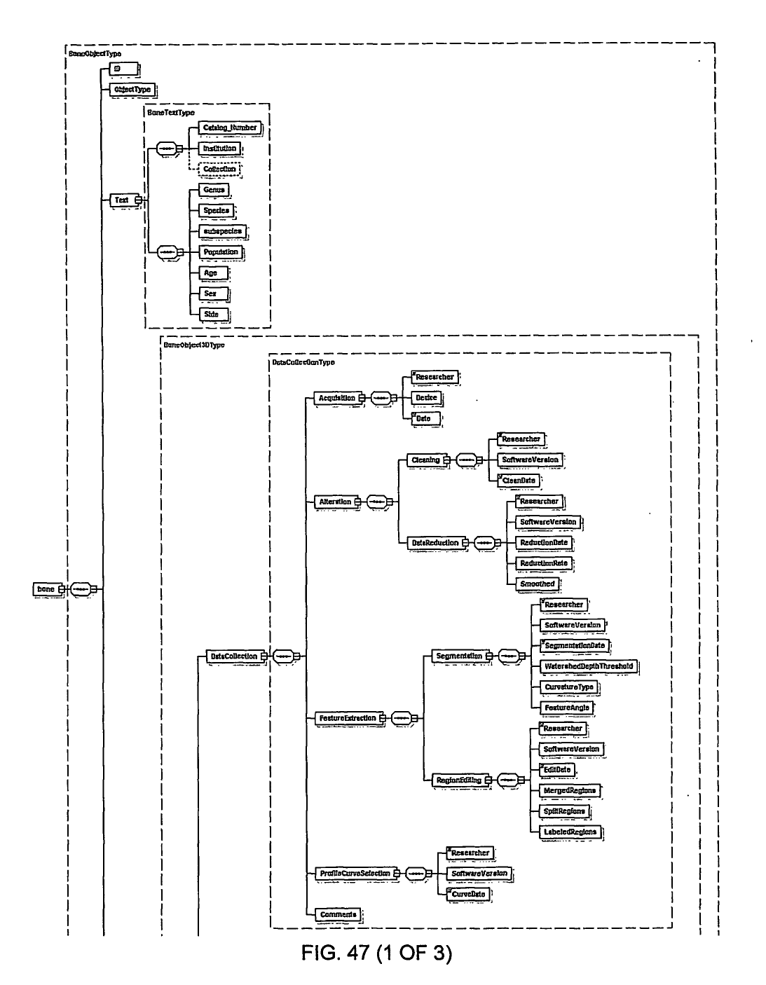

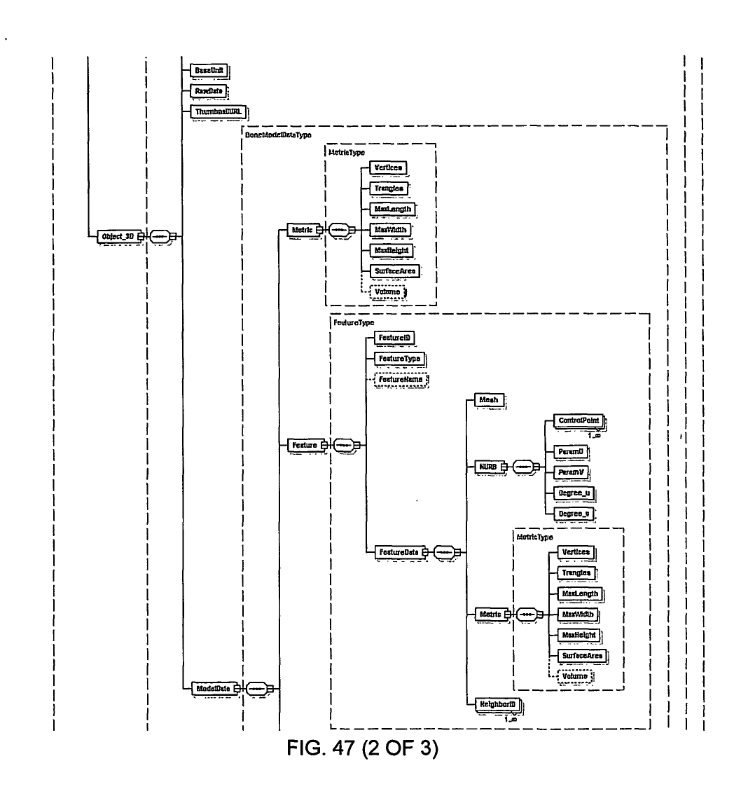

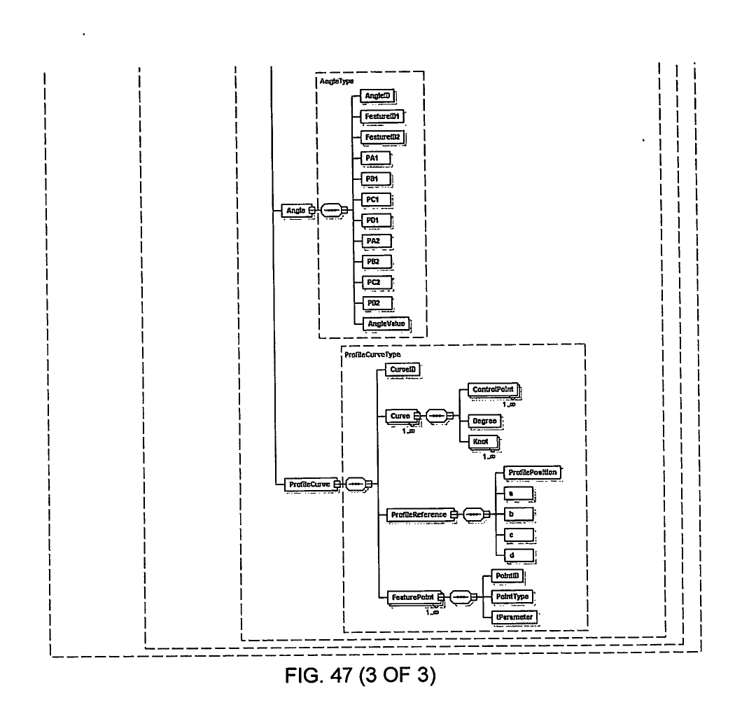

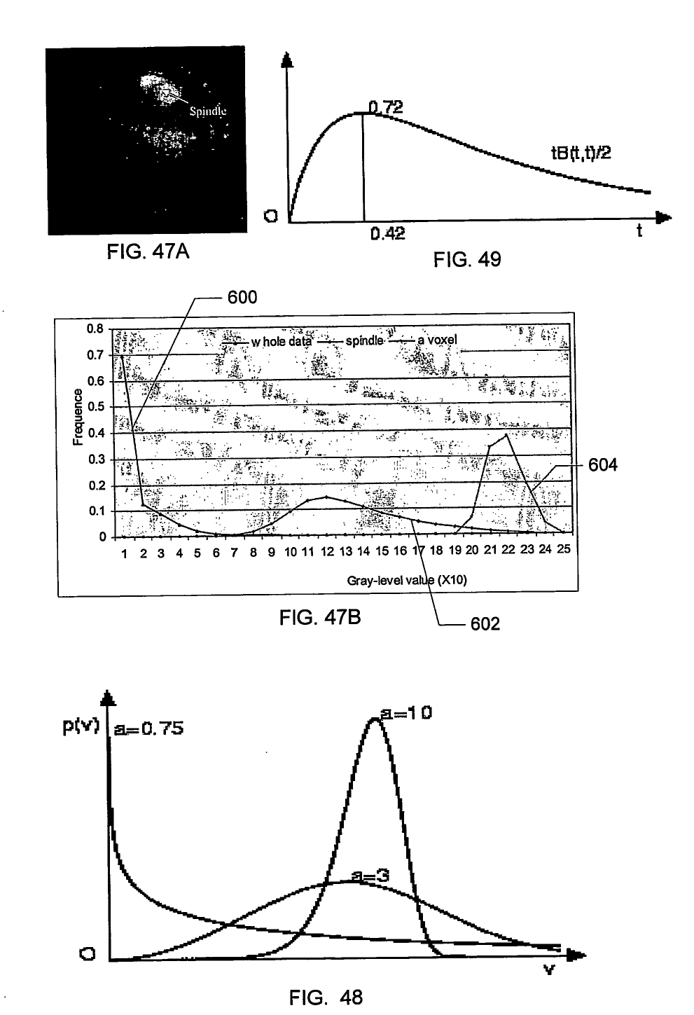

Since the project inception, more than 600 bones representing the wrist and hand joints of humans, chimpanzees, gorillas, orangutans, and gibbons have been digitized to create a database that will eventually include approximately 1000 bones representing the wrist, hand, and knee joints of humans and apes. With an aim to better understand the functional morphology of joint surfaces, the segmentation of features from a bone that are of particular interest to a physical anthropologist such as joint surfaces may be automated, avoiding manual digitization of such features that is both time consuming and labor intensive. The surface areas and curvatures of joint surfaces and the congruencies between reciprocal joint surfaces are then quantified and analyzed. Static and dynamic models can be built using digitized osteological data, together with musculoskeletal data from cadavers, and manipulative and positional behavioral data, to analyze the mechanics of manipulative and locomotor behavior. FIG. 47 shows the schema used for a bone.

### Feature Extraction from Volume Data

### Volume Segmentation Using Weibull E-SD Fields

According to another advantageous aspect of the invention, regions of volume data can be extracted for exploring the inner structure of the volume data by performing segmentation of volume data. Many tasks in volume visualization involve exploring the inner structures of volume data. For example, a cell biologist may be interested in the structure of the microtubule spindle apparatus in an egg. The rapid increase in data set sizes required for collecting images around the spindle apparatus, as well as the poor signal to noise ratio in the data set make it difficult to extract geometric features efficiently.

Segmentation of volume data is a process of voxel classification that extracts regions by assigning the individual voxels to classes in such a way that these segmented regions posses the following properties: (1) voxels within the same region are homogeneous with respect to some characteristic (e.g., gray value or texture); and (2) voxels of neighboring regions are significantly different with respect to the same characteristic.

The input data is on a 3D structured grid of vertices v(i,j,k), each associated with a scalar value. A voxel is considered as a κ×κ×κ cube, and each voxel is assigned two values: expectancy and standard deviation (E-SD). The Weibull noise index is used to estimate the noise in a voxel, and to obtain more precise E-SD values for each voxel. The segmentation method has been tested using synthetic data as well as real volume data from a confocal laser scanning microscope (CLSM). Analysis of this data shows distinct and defining regions in their E-SD plot. Under the guide of an E-SD plot, an object embedded in real and simulated 3D data can be efficiently segmented.

According to the volume segmentation method, the input data is on a 3D structured grid of vertices v(i,j,k), each associated with a scalar value, and a voxel is considered as a cube including κ×κ×κ 3D structured points, called a K-voxel. Each K-voxel is assigned two values: expectancy and standard deviation (E-SD). The expectancy in a voxel relates to its mean, and the standard deviation indicates the variability of the data within it. It is assumed that the E-SD values of voxels in a region are relatively homogeneous and different from that in other regions. Many voxels have the same E-SD value. If one plots the frequency of voxels tht have the same E-SD, then some areas in E-SD domain will be dense and some sparse. This plot is called the E-SD field of the volume data. As will be apparent to those of skill in the art, for a given volume data, the E-SD field depends on the size of κ-voxels selected, i.e., the value of κ.

A simple and efficient way to calculate the E-SD is to compute its average and the sample standard deviation. However, noise makes it difficult to calculate the E-SD values accurately. Under this situation, the result of the E-SD plot is not stable and is dependent on a statistical model of the data. A number of statistical frameworks have been proposed to model image and volumetric data. The observed image pixels have been modeled as Rayleigh distribution random variables with means depending on their position. A Gaussian-function was used for pixel relaxation labeling . Others instead proposed an exponential family of functions including Gaussian, Gamma, Rayleigh, and Possion to perform segmentation on 2D.

According to the present method, a Weibull probabilistic framework for segmentation of Confocal Laser Scanning Microscope (CLSM) volume data is described. The Weibull distribution, first introduced in 1939 by Swedish engineer W. Weibull, builds on empirical grounds in statistical theory of the strength of materials. The Weibull distribution includes three parameters, which are described below. An advantage of the Weibull distribution is that its kernel shape can be controlled by selecting different parameters for the gray levels of the input volume data.

The following description discusses spatially distributed objects, the Weibull distribution and the Weibull noise index, as well as how to use the Weibull distribution the along with our algorithms. 3D results from control data and two real CLSM volume data sets are presented.

Spatially Distributed Objects.

Consider volumetric data V, where the intensity of each image point p=(i,j,k)εV is given by ν(i, j, k) or ν(p), whose size is N=Nₓ×N_{y}×N_{z}. As used herein, distribution means the distribution of ν over a certain interval [a,b](a>0). The random variable X_{Ω}(v) is the number of points in a region Ω⊂V which have the value v, written as X_{Ω}. The density or frequency ƒ_{Ω}(ν) of a random variable X_{Ω} is defined as follows:

$${f}_{Ω} ( {v}_{0} ) = \frac{\vert {Ω}_{{v}_{0}} \vert}{\vert Ω \vert} \qquad ( 1 )$$

where Ωᵥ_{₀}{(i, j, k)εΩ|v(i, j, k)=v₀}, and |Ω| denotes the number of elements in Ω.

Assume that a homogeneous segment can be mathematically specified using two criteria: (1) the relative constant of regional expectancy and (2) regional variance of the intensity. These criteria are expressed as follows:

Definition 1.

A region K is called as a spatially distributed object (SDO), if the expectancy and standard deviation for each K-voxel A in K are relatively constant, i.e.
E[X_{Δ}]ε(e₁,e₂), and SD[X_{Δ}]ε(d₁,d₂), (2)

where e₁, e₂, d₁, and d₂ denote predefined constants, the random variable X_{Δ} is defined as X_{Ω} above.

In general, the expressions of expectancy and standard deviation in a κ-voxel are given as follows:

$$E [ {X}_{Δ} ] = \frac{1}{\vert Δ \vert} {\sum }_{( x , y , z ) ∈ Δ} v ( x , y , z ) , and SD [ {X}_{Δ} ] = \sqrt{\frac{1}{\vert Δ \vert} {\sum }_{( x , y , z ) ∈ Δ} {v}^{2} ( x , y , z ) - {E}^{2} [ {X}_{Δ} ]} , \qquad ( 3 )$$

where |Δ| denotes the number of elements in Δ. The SDOs are also called “agents” and regions of interest (ROI's). The goal of segmentation is to locate SDO's. The choice of e₁, e₂, d₁, and d₂ depends on the E-SD field.

However, if noise is present then equation (3) will not give accurate E-SD values. CLSM data which inherently includes noise and has a poor signal to noise ratio resulting in these inaccurate the E-SD values.

Confocal Laser Scanning Microscopy (CLSM) is a technique for obtaining high resolution scans of optical slices through a thick specimen without having to cut the specimen mechanically. Due to the precise lenses, the high coherency of the illuminating laser beam, and the confocal way of gathering backscattered light, accurate focusing at specific planar locations can be achieved. A typical optical section is between 0.1˜100 μm. Scanning through the whole specimen thereby gives a full 3D projection view of the specimen. This technique is very useful not only because it allows the volumetric analysis of biological data, but also because the techniques used in “staining” these specimens (i.e. laser excited dyes) increase the accuracy of these images as compared to images obtained from ordinary optical microscopes. Nevertheless, images are still noisy and blurred. Several sources of noise can be identified. These include (i) thermal noise induced by the photomultiplier, (ii) photon-shot-noise, (iii) biological background (autofluorescence), and (iv) unspecific staining. The quality of the image can be affected by a possible mismatch of refractive indices, tissue scattering, dye concentration inside the cell, and the histological methods used for staining. These factors contribute to a position-dependent noise and blurring, which makes the analysis of these images rather difficult.

Statistical theory has been used for segmenting medical and biological data. This assumes that the data follows a distribution. Intensity values in a region have been assumed to follow a Gaussian distribution. The Gaussian, Rayleigh, and Poisson distributions have been discussed separately. In our paper, before attempting to segment volume data using statistical theory, we first analyze the distribution. FIG. 47B shows the distribution of a CLSM data (see FIG. 47A. The plot 600 shows the distribution of the complete volume data (see FIG. 47A, which looks like the Poisson distribution. The plot 602 shows the distribution at the brightest region in FIG. 47A. This looks like a Gaussian distribution. The plot 604 illustrates the distribution in a 4-voxel.

Weibull Distribution

Weibull distribution is defined as follows:

$$p ( v ) = \frac{a}{b} {( \frac{v - {v}_{0}}{b} )}^{a - 1} exp [ - {( \frac{v - {v}_{0}}{b} )}^{a} ] , \qquad ( 4 )$$

where v≧v₀, a>0 is the shape parameter, b>0 is the scale parameter, and v₀ is the shift parameter (the minimum possible value of the random variable). In the CLSM data, the minimum possible density value is zero, i.e. v₀=0. Therefore, it is assumed that the shift parameter of the Weibull distribution v₀=0. FIG. 48 gives the Weibull distribution (4) with different shape parameters a and scale parameter b=1.2 and v₀=0. The expectancy and the deviation of the random variable Xobeying the Weibull distribution are given by:

$$E [ X ] = b Γ ( 1 + \frac{1}{a} ) + {v}_{0} , and {SD}^{2} [ X ] = {b}^{2} [ Γ ( 1 + \frac{2}{a} ) - {Γ}^{2} ( 1 + \frac{1}{a} ) ] , \qquad ( 5 )$$

where the gamma function is

$$Γ ( α ) = {\int }_{0}^{∞} {t}^{α - 1} {ⅇ}^{- t} ⅆ t .$$

It can be shown that when a=1.0, it is the Possion pdf; and when a=2.0, one has the Rayleigh pdf, and when a=3.0, it turns into the Gaussian pdf. When a>>1, the distribution tends to be a uniform pdf. Therefore, the Weibull model is a suitable model to fit the histogram distribution of these volume data and the regions within them whose statistical properties are unknown since the kernel shape can be controlled by selecting a different a value.

From equation (5), it is clear that the parameters a and b of the Weibull distribution depend on the expectancy and the standard deviation. We denote the ratio r=SD/E in equation (5) with v₀=0, and the relationship between r and the shape parameter a of its Weibull distribution is as follows:

$${r}^{2} = \frac{{SD}^{2} [ X ]}{{E}^{2} [ X ]} = \frac{Γ ( 1 + 2 / a )}{{Γ}^{2} ( 1 + 1 / a )} - 1 , \\ or \\ \frac{1}{{r}^{2} + 1} = \frac{{Γ}^{2} ( 1 / a )}{2 a Γ ( 2 / a )} = \frac{1}{2 a} B ( 1 / a , 1 / a ) = \frac{1}{2} tB ( t , t ) , \qquad ( 6 )$$

where the Beta function is

$$B ( x , y ) = {\int }_{0}^{1} {{t}^{x - 1} ( 1 - t )}^{y - 1} ⅆ t ,$$

a is the shape parameter of the WD and t=1/a. From equation (6), it can be seen that the shape parameter of the Weibull distribution is only dependent on ratio r in the E-SD plot. When t≈0.42, the RHS of equation (6) reaches its maximum, which is near the value 0.72. Unfortunately, the RHS of equation (6) is not a monotonic function of t (see FIG. 49). For each r, there are two roots. In order to overcome this difficulty, we first give some properties of the Weibull distribution:

Property 1

For every s>0, the s-moment of Weibull distribution is:
EX^{s}=b^{s}Γ(1+s/a).

Property 2:

If X₁,X₂, . . . , Xₙ are independent distribution random variables, and follow the Weibull law, then

$$\frac{1}{n} {\sum }_{1}^{n} {X}_{i}^{s} ⟶ {EX}^{s} for 1 \leq s < ∞ , as n \to ∞ .$$

Weibull Noise Index

Removing noise or improving the signal-to-noise ratio (SNR) of a given image is an essential step in segmentation, especially in high noise situations that can disrupt the shape and lose the edge information that defines the structure of objects. The traditional algorithms of denoising, such as Gaussian filter, reduce the noise but they do not maintain the edge information. When noise is removed, it is desirable, not only to smooth all of the homogenous regions that contain noise, but also to keep the position of boundaries, i.e., not to lose the edge information that defines the structure of objects.

Let ν₁, ν₂, . . . , ν_{κ}^{₃} represent κ³ image points in a given K-voxel. It is assumed that the value of a voxel is characterized by the Weibull distribution. If equation (3) is used to calculate the E-SD value, the results are not reliable due to noise, especially for a standard deviation. Therefore, one must find a way to distinguish whether or not the data distribution in a K-voexl is uniform. If it is not uniform, then what kind of noise is present? If few of the elements in a voxel are significantly larger and/or smaller than others, then these are called upper/lower noise. For example, in a 2-voxel, in which the set of the intensity at eight image points is {234, 52, 64, 46, 50, 54, 62, 3}, the element 234 is much larger than others, and is called an upper noise. The element 3 is significantly less than others, and is called a lower noise. In order to classify the noise in a κ-voxel, an auxiliary function g(s) is introduced:

$$g ( s ) = \frac{1}{n} \frac{{( {\sum }_{1}^{n} {v}_{i}^{s} )}^{2}}{{\sum }_{1}^{n} {v}_{i}^{2 s}} , \qquad ( 7 )$$

where sε(−∞, ∞), vₜ>0, 1≦i≦n, and n=κ³. By calculating equation (7) directly, we have the derivative of the function g(s) that satisfies: g′(s)≦0 for s>0, g′(s)≧0 for s<0, and g′(s)=0 if and only if v₁=v₂=. . . =vₙ. Also:

$$g ( 0 ) = 1 , g ( ∞ ) = \frac{{k}_{1}}{n} , and g ( - ∞ ) = \frac{{k}_{2}}{n} ,$$

where k₁ is the number of the elements which are equal to the maximum, and k₂ is the number of the elements which are equal to the minimum. It is obvious that 1≦k₁,k₂≦n, and k₁+k₂≦n.

Using Property 2, we know that

$$g ( s ) \approx \frac{{( {EX}^{ s} )}^{2}}{{EX}^{ 2 s}} = \frac{{t}_{s} B ( {t}_{s} , {t}_{s} )}{2} ,$$

where tₛ=s/a, and a is the Weibull distribution shape parameter in the κ-voxel. From the analysis above, the function tₛB(tₛ,tₛ)/2 reaches its unique positive maximum near 0.72 at t≈0.42. If k₁ and k₂ are small enough (k₁,k₂≦└0.14n┘^{†}) and there is a so such that g(s₀)=0.72, then we have
^{†}└x† is the maximum integer which is less than x.

a≈s₀/0.42 (8)

Definition 2:

If s₁>0 such that g(s₁)=0.72 (if k₁>0.72 n, set s₁=∞), then s₁>0 is called the Weibull upper noise index. If s₂>0 such that g(−s₂)=0.72 (if k₂>0.72 n, set s₂=−∞), then s₂>0 is called the Weibull lower noise index. In short, they are called the Weibull noise indices.

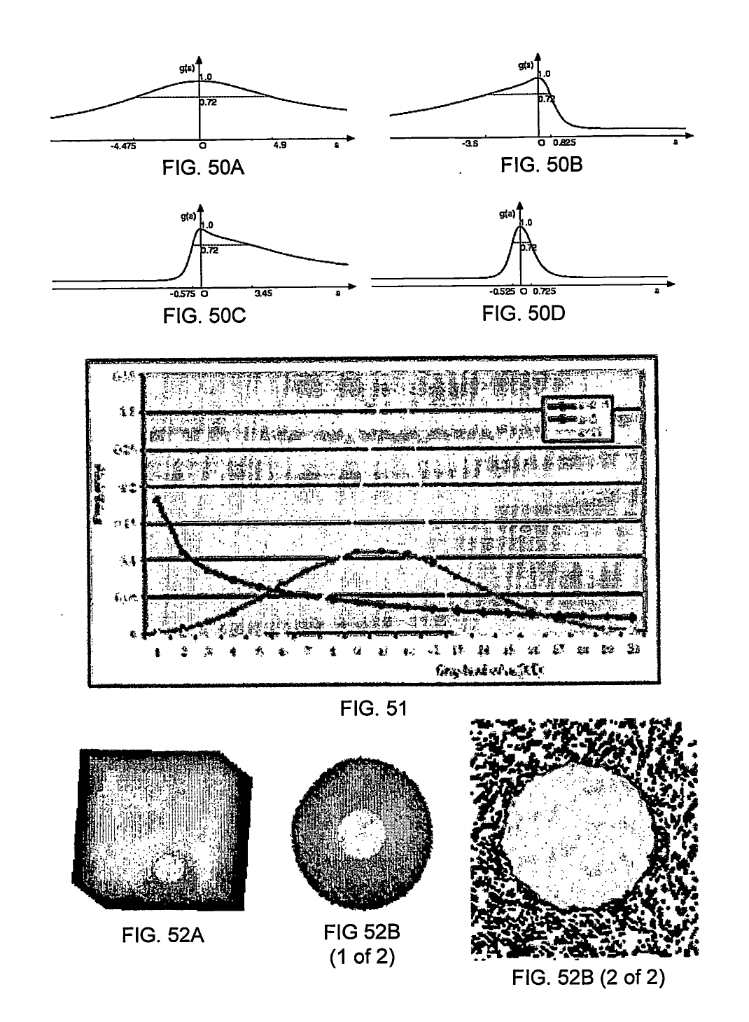

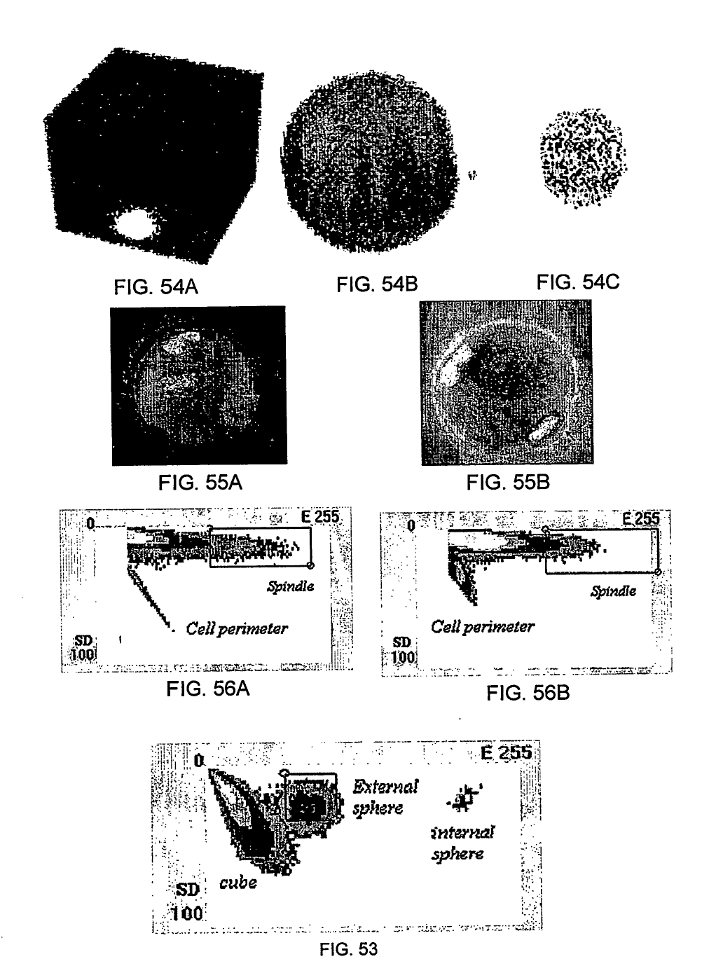

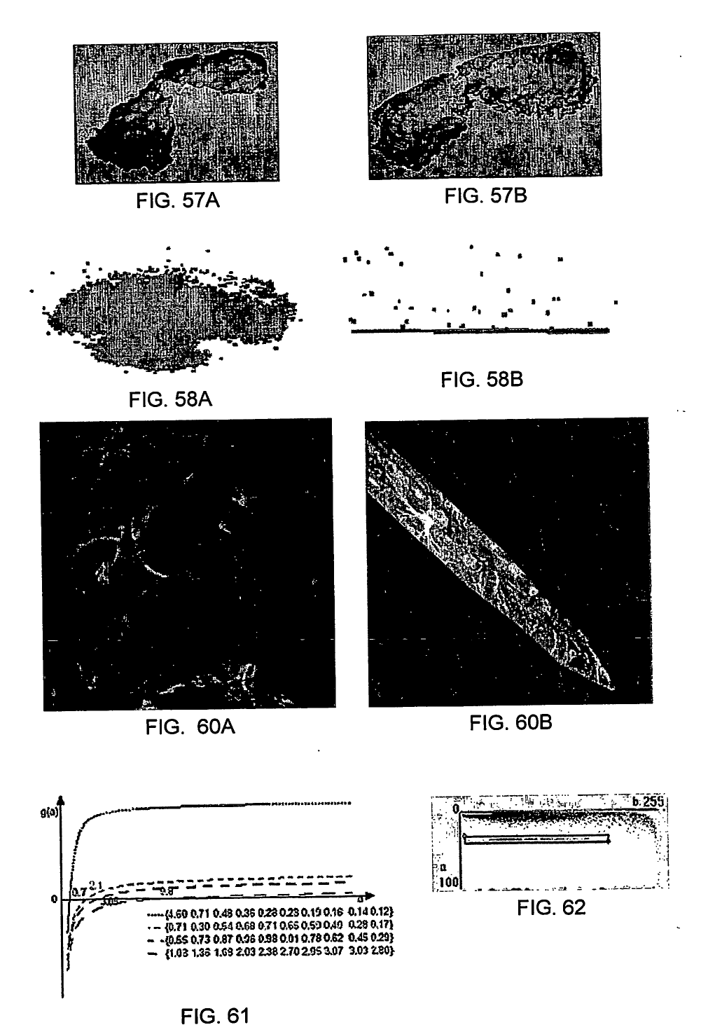

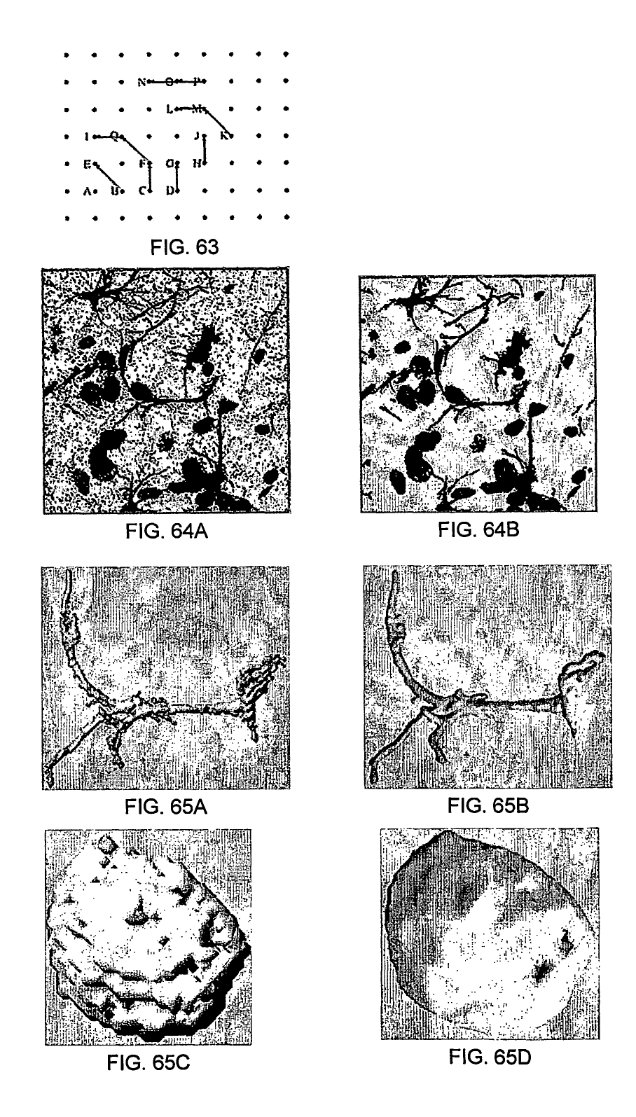

These two parameters are used to determine the “goodness” of voxel distribution as follows (see FIG. 50):.
For a κ-voxel, if the Weibull upper noise index s₁<1.26 and the lower noise index s₂>1.26, then there is upper noise in it.
For a κ-voxel, if the Weibull upper noise index s₁>1.26 and the lower noise index s₂<1.26, then there is lower noise in it.
For a κ-voxel, if the Weibull upper noise index s₁<1.26 and the lower noise index s₂<1.26, then there is upper and lower noise in it.
   Segmentation Algorithm
   Based on the analysis above, the algorithm for volume data segmentation is as follows:
Step 1:

Given a κ to determine the size of κ-voxel, initialize the SDO's predefined constant in equation (2): e₂>e₁>0,d₂>d₁>0, and the threshold of expectancy T_{c}>0.
Step 2:

Consider the jth κ-voxel. Use bisection to compute its Weibull noise index s₁, and s₂ which are the roots of the equation g(s)=0.72, where g(s) is defined by equation (7). If there is upper noise or lower noise or both, then remove the noise directly (i.e. delete the minimum or the maximum or both). Repeat at most └Cκ³┘times to execute Step 2;
Step 3

Calculate E-SD values using equation (3). If the expectancy is larger than the threshold T_{c}, add the κ-voxel to list A. If there are some κ-voxels which have not been dealt with, then go to Step 2.
Step 4:

Compute the frequency of the voxel in the list A, and create the E-SD plot. By using initial E-SD values e₂>e₁>0, d₂>d₁≧0, select the voxel which satisfies: e₂≧E≧e₁, d₂≧D≧d₁.

In this algorithm, the threshold Tₑ is used for controlling the size of list A above, and will cause the image to be rendered faster. The constant C in Step 2 is equal to 0.14. E-SD values (e₂, e₁; d₂, d₁) are obtained by moving a rectangle, called a window in the E-SD field, through user interaction.

The algorithm described above is simple and efficient. Its average complexity is O(L log L), where L is the number of boxes, defined by L=N/(κ³) where N is the number of points in the volume data. As will be apparent, if the grains (or κ-voxels) are coarser (i.e. κ is larger), then the algorithm is more efficient; however, the results of the segmentation will be coarser also. With different κ(κ=κₘᵢₙ, . . . , κₘₐₓ, κₘᵢₙ and κₘₐₓ are prespecified), the selected κ best fits the given volume data. By this fitting approach, the number of SDOs in volume data is determined. The minimum K, which shows the number of SDOs in E-SD field, will be chosen.

### EXAMPLES

In this section we will look at two examples illustrating the proposed method for segmentation. The first example examines artificial volume data generated using a Weibull distributed random number with different parameters. The second example uses real CLSM data from two different data sets, and demonstrates how this model can be used to segment such data. The hardware we used is a Dell Precision workstation 330, with P4 1.4 GHz CPU, and 1-GB RAM.

Controlled Experiment

In order to make the experiment comparable, a controlled experiment is done in the following way: we first segment a noise-free volume data (see FIG. 52A) and treat that segmentation as our reference, which includes a torus, an ellipsoid, and two deformed cubes of different sizes but with the same shape parameter a, in a 100×100×100 cube (see FIG. 52B). Every instance of a volume data with added noise is then denoised using a Gaussian filter with σ=1.3, and a Weibull noise index with 2-voxels or 3-voxels. The targets are then segmented from these images and compared to the reference objects. The comparison, based on the segmented volume, is done by identifiing the support function of the reference object and of the object segmented from a volume data with added noise, denoted by Sᵣ and Sₙ, respectively. That is S₈₆(x)=1 or 0, if x is in the segmented objects or not, where ξ={r,n}. Then, the volume deviation (error) of Sₙ from Sᵣ in the volume data V is defined as follows:

$$δ ( {S}_{n} , {S}_{r} ) = \frac{{\sum }_{x ∈ V} \vert {S}_{r} ( x ) - {S}_{n} ( x ) \vert}{{\sum }_{x ∈ V} {S}_{r} ( x )} .$$

These deviations are calculated to produce numbers that are comparable across different noise levels. Several levels of noise have been added to the test volume data to show the robustness of the filter. The noise that is added to every image point is a Weibull distribution with different scale parameters b: Y=min(255,C[−bln(1−X)]^{1/a}), where random variable X is the uniform distribution, a is the Weibull shape parameter and C is a constant for each object. Finally, the volume error from the simulated volume data is plotted in FIG. 51. As depicted in FIG. 51, the volume error corresponding to the Weibull noise index is significantly lower compared to those that result from applying a Gaussian filter. Segmentation results are shown in FIG. 52.

FIG. 6(i) shows the Weibull E-SD field of the noise-added volume data with the scale parameter b=10.0. Below we define where the colors in an E-SD field correspond to frequency. We denote by N(e,d) the number of the κ-voxels whose expectancy is e and standard deviation is d. The color at point (e, d) in the E-SD field is determined by log(N(e, d)). We set the color at point (e, d) as follows:

$$color ( e , d ) = \{ \begin{matrix}RGB ( 255 , 255 , 255 ) , & 0 \leq log ( N ( e , d ) ) < 0.5 \\ RGB ( 255 , 0 , 0 ) , & 0.5 \leq log ( N ( e , d ) ) < 1.0 \\ RGB ( 0 , 255 , 0 ) , & 1.0 \leq log ( N ( e , d ) ) < 1.5 \\ RGB ( 0 , 0 , 255 ) , & 1.5 \leq log ( N ( e , d ) ) < 2.0 \\ RGB ( 255 , 0 , 255 ) , & 2.0 \leq log ( N ( e , d ) ) < 2.5 \\ RGB ( 0 , 255 , 255 ) , & 2.5 \leq log ( N ( e , d ) ) < 3.0 \\ RGB ( 255 , 255 , 0 ) , & 3.0 \leq log ( N ( e , d ) )\end{matrix}$$

The colors in the E-SD field below have the same meanings. Next, the rectangle, called a window (see FIG. 6(i)), has two small circles at its left-top and right-bottom vertex, which give the values (e₂,e₁;d₂,d₁) to define the range of expectancy and standard deviation of a SDO.

FIG. 6(c) shows a slice of the noise volume data with the Weibull scale parameter b=5.0. The segmentation results, using our method and threshold method with Gaussian filter, are given in FIG. 6(d) and 6(e). Although it has lost some detail information, such as the deformation in the two cubes compared with the reference FIG. 6(b), the segmentation using our method keeps the number¹ and shape of objects. In contrast, segmentation performed by using threshold methods with Gaussian filter lost the number and shape of the objects.
¹ Different components are colored using different colors.

FIG. 6(f) shows a slice of the noise volume data with the Weibull scale parameter b=10.0, and the segmentation results from this noise data using our method and the threshold method with a Gaussian filter are given in FIG. 6(g) and 6(h). FIG. 6(i) shows the Weibull E-SD field of this noise volume data, and illustrates that the three different components present. Using our segmentation method maintains the number and shape of the objects, but using threshold techniques with Gaussian filter fails in segmenting the objects.

CLSM Data

In this example we use data from two different CLSM data sets designed for investigating the meiotic spindle within a mouse egg. The eggs were viewed on the Leica TCS NT confocal microscope. Multiple lasers allow for simultaneous imaging of the DAPI ( Argon TV [363 nm]) and ALEXA 568 Krypton[568 nm]) fluorophore-labeled samples. Using a 63× water objective, images were scanned between 0.2-0.4 μm intervals along the z-axis, 0.154 μM along the x/y-axis and collected through the volume of the entire egg.

FIG. 7 shows a CLSM test bed for our Weibull E-SD modeling scheme from different experiments. The data in FIG. 7(a) is collected using a Krypton laser and highlights regions targeted with an antibody to anti-α-tubulin at the upper left and brighter regions through the egg. The image in FIG. 7(a) shows a meiotic metaphase II arrested egg, and is composed of 124 slices within a 512×512 matrix, contains a gray-level from 0 to 255. The size of the data shown in FIG. 7(b) is 512×512×146, and has the same gray-level range as in FIG. 7(a). In FIG. 7(b) the egg has a meiotic spindle at the upper left and the remains of the primary polar body at the bottom right.

FIG. 8 shows the E-SD plots of FIG. 9. The colors have the same meanings as in FIG. 6(i). In FIG. 8(a), the size of the window is (170, 237; 4, 27) corresponding to the segmentation of the data shown in FIG. 9(a). In FIG. 8(b), the size of the window is (183, 255; 2, 30) corresponding to the segmentation of the data shown in FIG. 9(b). We set the threshold at______=34, and κ=2. The segmentation in FIG. 9(a) includes 3902 voxels, and 11308 voxels in FIG. 9(b).

FIG. 7. Test bed for our Weibull E-SD modeling scheme. The images come from two different data sets. In both images there is only one cell and its spindle is at the up part of the cell (labeled by biologist). The size of image (a) is______, its gray-level is from 0 to 255. The size of image (b) is 512×512×146, it has the same gray-level as (a).

FIG. 8. The Weibull E-SD fields from the data shown in FIG. 7. The colors have the same mean as in FIG. 6(i). In 8(a), the size of window is (178, 237; 4, 27) corresponding to the segmentation shown in FIG. 9(a). The threshold is______34, which creates a blank on the left side. There are two clear regions. In 8(b), the size of window is (167,255; 2, 30) corresponding to the segmentation shown in FIG. 9(b). The threshold is______34, which creates a blank on the left side. There are two clear regions too.

FIG. 9. The spindle segmentation corresponding to FIG. 7. The segmentation in 9(a) includes 3902 boxes, and 11308 boxes in 9(b).

What gives rise to such clear regions in Weibull E-SD field shown in FIG. 8 is unknown. A plausible explanation is that each region corresponds to a SDO. When we move the window on FIG. 8(a) to the small region, an area of cell perimeter in FIG. 7(a) is segmented (see FIG. 10).

Conclusion

We have proposed a coarse-grain approach for the segmentation of an object from volume data based on the Weibull E-SD field. We have shown that one can decide the noise index in a K-voxel by using the Weibull law, and use the E-SD field as a guide to segment an object. We have consistently demonstrated this approach on controlled as well as on real volume data.

### Statistical 3D Segmentation with Greedy Connected Component Labeling Refinement

A new approach for segmenting 3D voxel data sets will now be described. It is semi-automatic and consists of two phases. First, the initial segmentation is accomplished by voxel labeling using statistical maximum likelihood estimation techniques. The novelty of the present approach is that the type probability distribution function is not required a priori. A multi-parameter distribution that includes a variety of widely applicable distributions is utilized. The second phase refines the segmentation by the use of a new greedy connected component labeling (GCCL). The overall effectiveness of this new approach is illustrated with data examples of multichan-nel laser scanning confocal microscope (LSCM) images where the structure of GFAP (a protein) and nuclei, and the geometry of an electrode implant are extracted.

Multichannel laser scanning confocal microscopy (LSCM) equipped with a specific laser/filter combination to collect multiple fluorescence signals in a single scan is applied increasingly in experimental biological investigation. In this application, the confocal 3D images are collected from two channels. The stack of 2D images (each 2D image referred to as a “slice”) make up the volumetric data. A typical section is from 10˜φmm. It is composed of different shaped structures, for example, tree-shaped GFAP (a protein expressed by astrocyte cells), and blob-shaped nuclei (labeled with a DAPI stain) and sheet-shaped electrode implants. The segmentation of these regions can yield important biological information. For example, segmentation and subsegment determination of GFAP volume allows for quantitative analysis of the immune response to the implanted electrode. In LSCM in particular, measurement of the relative positions of regions labeled with different cells/implants can provide an insight into their inter-functional relationship. Due to image noise and different shapes of the cells/implants to be segmented, considerable effort is required to develop accurate image segmentation for localizing the structures.

Recently, several probabilistic frameworks to determine algorithms for the segmentation in an image have been given. It is now well known that to obtain efficient algorithms, the statistical properties of voxels should be taken into account. Members of the exponential family includes Gaussian, Gamma, Rayleigh, Poisson, and other familiar distributions that have been used to model real data. Indeed, there are several kinds of 2D images for which the pixel values are correctly described by such statistical law. Gaussian distribution is widely used to characterize the probabilistic feature of random variables of an image. ome ultrasonic medical images have been modeled using Rayleigh's law. Astronomical images have been presented using Poisson distribution and compared to the classical linear intercorrelation technique. Previously, it has been assumed that the probability density function (pdƒ) of the random fields, which describe the gray levels in the input image, belongs to the exponential family. However, a pdf with a single distribution shape will limit the use of the segmentation approach, and asks users to distinguish the different pdfs of input images. In accordance with the present, we use the Weibull pdf, whose kernel shape can be controlled by selecting different parameters.

When a statistical model-based method is used, both voxel and its neighbors should be considered, to estimate the parameters of the pdf for each voxel. Then, a histogram, called the Weibull a-b histogram, is generated. Using voxel labeling guided by the Weibull a-b histogram, the initial segmentation result can be obtained. However, due to the unavoidable noise in LSCM images, the initial segmentation is quite coarse, e.g. this results in many isolated small regions. In order to overcome the problem, we introduce a new algorithm of connected component labeling (CCL), called Greedy Connected Component Labeling (GCCL), to delete the unwanted small regions. CCL algorithms segment the domain of a binary image into partition that corresponds to connected components. CCL is one of the fundamental segmentation techniques used in image processing. The classical CCL algorithms pay more attention to the cost of memory but not time complexity. The most common approach to avoid making several passes over the image is to process the image in a sequential order and keep an equivalence table that stores the information about the equivalence of labels as-signed to the voxels from the same component. Others have used two passes in which the image is scanned in raster order, and the size of equivalence table is bounded to O(7N) for a N×N 2D raster image. Due to the increase in the size of a 3D image, GCCL takes into account the computation time cost as well as the smaller size of the equivalence table. In the GCCL algorithm according to the present invention, one pass for a 3D image is used, the size of local equivalence table is O(the width of connected component), and the time cost is O(N) with low constant, where N is the number of voxels in the image.

The algorithm according to the present invention has been tested using LSCM volume data shown in FIG. 60. FIG. GR1(a) shows a LSCM image of GFAP-labeled astrocytes and DAPI stained nuclei, in which the green indicates regions targeted with GFAP-labeled astrocytes, and the red regions identify DAPI, which consistently targets nuclei cells. FIG. 1(b) shows a GFAP and implant LSCM image, in which the red targets electrode implant devices and the green GFAP. FIG. 60A and 60B are rendered using maximum intensity projection (MIP).

Statistical Image Model

We will now introduce Weibull statistical modeling and describe how to create a Weibull a-b histogram and how to obtain an initial segmentation.

Weibull Modeling

Consider a 3D image I organized as a stack of 2D transverse slices, and the grid point set is denoted by I, whose size is Nₓ×N_{y}×N₂ where the intensity of each voxel (i, j, k)εI is given by v(i; j; k). The Weibull probability density function (pdƒ) of gray level of each voxel is given by

$$p ( v ) = \frac{a}{b} {( \frac{v - {v}_{0}}{b} )}^{a - 1} exp [ - {( \frac{v - {v}_{0}}{b} )}^{a} ] , \qquad ( 1 )$$

where v≧v₀; a≧0, b≧0; v₀≧0, and v is the gray level of the voxel, a is a shape parameter, b is a scale parameter, and v₀ is a shift parameter (the minimum possible value of the random variable). This triparametric distribution was introduced in 1939 by Swedish engineer, W Weibull, on empirical grounds in the statistical theory of the strength of materials. It can be shown that when a=1.0, it is the Possion pdƒ, when a=2.0, one has the Rayleigh pdf; and when a=3.0, it turns to the Gaussian pdf. When a>>1, the distribution tends to a uniform pdf. Therefore, the Weibull model is a suitable model to fit the histogram distribution of these images and the regions in them whose statistical properties are unknown since the kernel shape can be controlled by selecting a different a value. FIG. 61 shows the Weibull distribution equation (1) with different shape parameters a, the scale parameter b=1.2 and the shift v₀=0. For LSCM imaging, the minimum possible intensity value is zero, i.e. v₀=0. Therefore, in the discussion that follws, we assume that the shift parameter of the Weibull distribution satisfies v₀=0.

Assume that the observed image I is composed of two zones: the target having one (or several) simple connected region(s) and the background. Under this assumption, the target in the image is completely defined by a binary image T={T(i, j, k)|(i, j, k)εI} that defines a certain shape for the target so that T (i, j, k) is equal to one within the target and to zero elsewhere. Thus, the target in the image is the region: Ω_{T}={(i, j, k)εI|T(i, j, k)=1}.

The purpose of segmentation is, therefore, to estimate the binary image T for the target in the image. Without more a priori knowledge about the target, the maximum likelihood estimation is first introduced to compute the Weibull parameters.

Maximum Likelihood Estimation

The parameter estimates obtained using the maximum likelihood technique are unique, and as the size of the sample increases, the estimates statistically approach the true values of the sample. Let ν1; ν2; ¢¢¢; vn represent n voxels of image. It is assumed that the in-tensity of each voxel is characterized by the Weibull distribution. The likelihood function associated with the sample is the joint den-sity of n random variables, and thus is a function of the unknown Weibull distribution parameters (a; b). The likelihood function for a sample under these assumptions is given by the expression

$$L ( a , b ) = {\prod }_{i = 1}^{n} ( \frac{a}{b} ) ( \frac{{v}_{i}}{b} ) exp {( - \frac{{v}_{i}}{b} )}^{a} . \qquad ( 2 )$$

The parameter estimates are determined by taking the partial derivatives of the logarithm of the likelihood function with respect to a and b and equating the resulting expressions to zero. The system of equations obtained by differentiating the log likelihood function for a sample is given by

$$g ( a ) ≐ \frac{{\sum }_{i = 1}^{n} {v}_{i}^{a} ln ( {v}_{i} )}{{\sum }_{i = 1}^{n} {v}_{i}^{a}} - \frac{1}{n} {\sum }_{i = 1}^{n} ln ( {v}_{i} ) - \frac{1}{a} = 0 , b = {[ \frac{1}{n} ( {\sum }_{i = 1}^{n} {v}_{i}^{a} ) ]}^{1 / a} \qquad ( 3 )$$

In order to find the parameter a from equations (3), we first in- troduce a function g(a) defined by equation (3). For any sample v1;v2; ¢¢¢ ;vn with vi>0(1·i·n), we can directly compute that the derivative that satisfies g 0 (a)>0, and so g(a) is a monotonic as-cending function with shape parameter a, and lim a ! 0+g(a)=ᵢ¥, and lima !□□g(a)=kln(max(vi))ᵢ 1 n □□i=1 ln(vi)>0, where k, 1 is the number of the elements, which reach the maximum in the set fv1; v2; ¢¢¢ ;vn g. Therefore, for any sample v1;v2; ¢¢¢;vn with vi>0(1·i·n), g(a) has one and only one positive root. FIG. 3 shows the plot of function g(a) for different samples. Once a is determined, this value is inserted into equation (3) and b is cal-culated directly. From equation (3), it is easy to see that b is the a-moment of sample v1;v2; ¢¢¢;vn with vi>0(1·i·n), and a indicates the deviation of this sample. The less deviation, the larger the root of equation g(a)=0 (see FIG. 61). By the analysis above, we can use the bisection algorithm to solve equations (3) and get the Weibull parameters.

Voxel Labeling by Weibull a-b Histogram

Once the Weibull model is obtained, the segmentation problem amounts to assigning labels to each voxel in the volume. A straight-forward way is to label voxels as the target or the background by maximizing the individual likelihood function. This approach is called ML classifier, which is equivalent to a multiple thresholding method. Usually, this method may not achieve good performance since there is a lack of local neighborhood information to be used to make a good decision. Therefore, we incorporate the local neighborhood information at a voxel into a labeling procedure, thus improving the segmentation performance. Suppose v i; j;k is the intensity of a voxel (i; j;k) 2I in the image I, w i;j;k is a size d£d£d window centered at (i; j;k) for maximum likelihood estimation, where d is an odd integer greater than 1. We regard w i; j;k as the local region while we calculate the Weibull parameters for the voxel (i; j;k) using equation (3).

When the intensity value ranges from 0 to 255, then the value of the Weibull scale parameter b is also from 0 to 255 by equation (3). On other hand, the more uniform the region surrounding a voxel is, the larger the Weibull shape parameter a becomes. Experimentally, we set the upper boundary of the Weibull shape parameter a to be 100. The size of the window has influence on the calculation of the Weibull parameters. The window should be large enough to allow enough local information to be involved in the computation of the Weibull parameters for the voxel. Furthermore, using a larger window in the computation of the parameters increases the smoothing effect. However, smoothing the local area might hide some abrupt changes in the local region. Also, a large window may require sig-nificant processing time. Weighing the pros and cons, we choose a 3×3×3 or 5×5×5 window for estimating the Weibull parameters and have experimental data to back that choice.

A classical histogram is a statistical graph counting the frequency of occurrence of each gray level in the image or in part of an image. We extend this idea and define a histogram in the Weibull a-b domain. First, the Weibull shape parameter a and scale parameter b for each voxel are calculated. Second, for each Weibull parameter pair (a;b) 2 [0;100]£[0;255], count the number of voxels with this parameter pair. Here two issues arise in computing the frequency for each parameter pair. One is that the step of the Weibull a-b domain is (1,1). The other is that we set a low boundary for the scale parameter b, since b is the a-moment of the intensity sample surrounding a voxel. We should identify the target with higher intensity, not the background with lower intensity. Last, we have the frequency for each parameter pair logaritluized, and plotted against that pair, and colored as the legend shown in FIG. 62. The Weibull a-b histogram gives us a global description of the distribution of the uniform regions across intensity levels. We use a movable rectangle in the histogram to locate the range of the colored peak zone by moving its top-left or bottom-right vertex, and select all the voxels with the Weibull a-b parameter histogram being in this rectangle.

An advantage of segmentation using the Weibull a-b parameter histogram is that local information and global information are both taken into account in determining the segmentation, whereas in traditional histogram approaches only global information is con-sidered.

Segmentation Refinement using GCCL

Although LSCM images have a much high accuracy, these images are still noisy and blurred. Several sources of noise can be identified: thermal noise induced by the photomultiplier, photon-shot-noise, biological background (autofluorescence), and unspecific staining. The quality of the image depends also on possible mismatch of refractive indices, on tissue scattering, on dye concentration inside the cell, and the histological methods used for staining methods. These factors contribute to a position-dependent noise and blurring. Therefore, segmentation results using voxel labelling by the Weibull a-b histogram can be quite coarse and may lead to the problem that there are many isolated small segmented components, as shown in FIG. 64A. This is due to two reasons. First, a thresholding based segmentation is a binary representation of a region that either includes or excludes a given voxel as being in or out of the region. Second, the voxel labelling cannot distinguish the targets from the noise. On the other hand, voxel labelling can not show the shape of cells and implants segmented and the relationship among them, because voxel labelling only uses the in-formation around a voxel.

We wish to correct these problems by deleting the unwanted small regions and finding structural and quantitative information in an image using connected component labelling (CCL), which seg-ment the domain of a binary image into partitions that correspond to connected components. Here, two voxels are 6-connected if at most one of their 3D coordinates differs by 1, 18-connected if at most two coordinates differ by 1, and 26-connected if all three coordinates are allowed to differ. A 6/18/26-connected path through the 3D image is a sequence of 6/18/26-connected voxels. A 6/18/26-connected component in a binary image is a subset in which for every two voxels there is a 6/18/26-connected path between them. The partitioning is represented by an 3D image in which all voxels that lie in the same connected component have the same voxel value. Distinct voxel values are assigned to distinctly connected component. It is clear that only the target voxels are affected by this labelling i.e. the background voxels remain unchanged.

Hierarchy Frame for a Connected Component

For a connected component C, a hierarchy frame H C (r) rooted from voxel r is defined as a partitioning of C into hierarchy f h1(r); h2(r); ¢¢¢; hn(r) g satisfying 1.h1(r)=frg; 2. All voxels adjacent to voxels in hierarchy hi (r); (i=2; ¢¢¢; nᵢ1) are in hierarchies hiᵢ 1(r), hi (r) and hi+1(r); 3. All voxels adjacent to voxels in hierarchy hn(r) are in hierar-chies hnᵢ 1(r) and hn(r). where n is the total number of hierarchies, and is simply the depth of C. maxi fj hi (r) jg is called the width of C, where j ¢ j denotes the number of the elements in a set. FIG. 5 shows a 2D 8-connected component which is labeled by the set f A; B; C; D; E; F; G; H; I; J; K; L; M; N; O; P; Q g. If the root is A, then the hierarchy frame for this connected component is h1(A)=fA g, h2(A)=fB; Eg, h3(A)=fC; F; Q; Eg, h4(A)=fD; Eg, h 5(A)=fH; Jg, h6(A)=fK; L; M g, and h7(A)=fP; O; Ng. Therefore, the depth of C is 7, and the width is 4.

GCCL

For a binary image T, when GCCL finds a unlabeled voxel, called a root r, it does not stop until all voxels in WT connected to r though a 6/18/26-connected path are labeled. The procedure of labelling a connected component C by GCCL is to find the hierarchy frame H C (r) rooted from r. In our implementation of GCCL, we regard a connected component as a dynamic list (DL), and different com-ponents are assigned to different DLs. However, the main problem with GCCL is that GCCL may repeat to label a voxel in C. In order to avoid the expensive operation of DL, such as adding a unique node to a DL, we use 4-valued flags to determine the value of a voxel in T. Let t(i; j; k) denote the value at voxel (i; j; k) 2 T, and set t(i; j; k) to be either 0 or 1 or 2 or 3. If t(i; j; k)=0, then the voxel (i; j; k) belongs to the background and is not changed. When t(i; j; k)=1, the voxel (i; j; k) belongs to the target, it is not la-beled, and can be a root to form a new component or a new node to be added to the DL. When t(i; j; k)=2, the voxel (i; j; k) can be a new node to be added to the DL, but can not be a root to form a new component. When t(i; j; k)=3, it means that the voxel (i; j; k) has been added to a DL, neither as a new root nor as a new node. The GCCL algorithm is as follows:

GCCL Algorithm:

Read T, and set t(i, j, k) = 1, if (i, j, k) ε Ω_{T},
while t(i, j, k) = = 1 loop
/* the first loop*/

Generate a DL, denoted by dl, to store the connected component whose root is (i, j, k),
and a temporary DL, denoted by tdl, to store middle results. Two counters, denoted by
num1 and num2, represent the increase of dl and tdl, respectively, and are initialized to
zero. Add voxel (i, j, k) into tdl;
while tdl ≠ Ø, and voxel (l, m, n) ε tdl loop
/* the second loop*/

if t(l, m, n) = = 1 or 2 then

while all the 6/18/26-connected voxels of (l, m, n), denoted by (l ± 1, m ±
1, n ± 1), and t(l ± 1, m ± 1, n ± 1) = 1 loop
/*the third loop*/

num1++;
Add voxel (l ± 1, m ± 1, n ± 1) into tdl;
Set t(l ± 1,m~ 1, m ± 1, n ± 1) = 2;

End loop
Set t(l, m, n) = 3;
Add (l, m, n) into dl;
num2++;

End if
Remove voxel t(l, m, n) from the tdl;
if num1 ≠ num2 then

Reset the tdl;

End loop

End loop

Here, four issues arise in the GCCL algorithm. One is that for a connected component C, its root is the voxel (i0; j0; k0), where k0=min (i; j;k) 2 C k, j0=min (i; j;kO) 2 C j, and i0=min (i; j0;k0) 2 C i. The second is that we use three primitive operations of DL:

Add(x): It creates a new node for containing a voxel. The node is then pushed on the DL of voxel x at O(1) time cost.

Remove(x): This operation first moves the pointer of DL to the root of DL, and then finds the voxel x in the DL. If x is in DL, then delete, If not, go through the DL. In general, if there are n nodes in the DL, this operation costs O(n). In this algorithm, the voxel to be removed is always the root of the DL, therefore, this operation has O(1) cost.

TABLE 4
The efficiency of the GCCL algorithm Data Data Size
Connected Component Time (s) Amount Largest GFAP & Nuclei
29.9 MB 2514 87536 4 GFAP & Implant 63.9 MB 3115 234976 8

| | | Connected Component | | |
|---|---|---|---|---|
| Data | Data Size | Amount | Largest | Time (s) |
| GFAP & Nuclei | 29.9 MB | 2514 | 87536 | 4 |
| GFAP & Implant | 63.9 MB | 3115 | 234976 | 8 |

Reset: It reinitializes the DL and returns the root of the DL in O(1) cost. The third issue is that the number of times the first loop is excuted in the GCCL algorithm is the number of the connected components in the image. The number of times in the second loop is dependent on the number of voxels in a connected component, and the third is a constant either 6, 18 or 26. Therefore, the time complexity of the GCCL algorithm is O(N) with small constant, where N is the number of the voxels in the image. The last issue is that the size of local equivalence table is O(the width of connected component), because each local equivalence table is the DL tdl in GCCL algo-rithm. In FIG. 64, the right image is the voxel labelling result by means of Weibull a-b histogram, includes 2514 26-connected components, and the left one is the results of the GCCL. Table 4 shows GCCL on different data. This was run on PIV 1.7GHz with 4GB RAM Window 2000. As shown in FIGS. 65A and 65B, the resulting surface from our segmentation can be very coarse. This is due to the noise in the images and thresholdingbased segmentation methods. We smooth connect components using convolution with Weibull kernel whose parameters are determined by the equation (3). FIG. 65 shows the smoothing results of connected components.

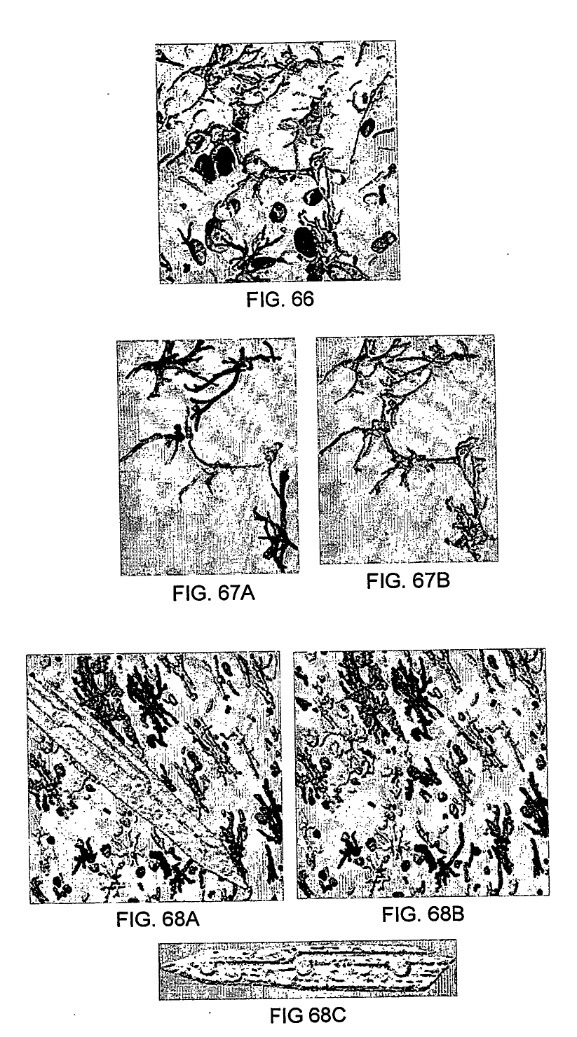

FIG. 60A shows LSCM volume data composed of 58 slices with an in-plane 512×512 pixels, and 100×100×57:8 mm field of view. After computation of the Weibull a-b histogram shown in FIG. 62, we move the top-left vertex to (24, 0) and the bottom-right to (255, 100). After the initial segmentation using voxel labelling by the Weibull a-b histogram, the corresponding result TO is given in FIG. 64A. Using GCCL for TO and setting the threshold of the number of voxels in a connected component 200, we can get the segmentation results shown in FIG. 66. FIG. 67 shows the effect of the top-left vertex on Weibull a-b his-togram on the connection for glia cells in LSCM image FIG. 60B. By adjusting the position of vertex on Weibull a-b histogram, the connections between adjacent astrocytes can be more clearly defined, allowing for the potential identification of in-dividual astrocyte. FIG. 60A is obtained, when the top-left vertex is moved to (31,0), and FIG. 60B to (24,0).

As another example, we consider a GFAP and implant LSCM volume data shown in FIG. 64B. FIG. 64B is 127 slices with an in-plane 512×512 matrix. FIG. 68 shows the segmentation results of the GFAP and implant data. We have tested our algorithm with 69 different LSCM volume data. As illustrated here, we have observed that the overall approach can be very effective at segmenting LSCM images.

In this paper, we have presented a new statistical modeling of vol-ume data to segment a target of interest, and a GCCL algorithm to refine the initial segmentation from the Weibull statistical model-ing. This method, as illustrated by pilot application in LSCM im-ages analysis, is capable of segmenting the structures within data and can be applied to real problems such as those encountered in tissue segmentation. One of the remaining limitations of the present approach is that it is still semi-automatic and consequently requires the intervention and expertise of the user. It would be desirable to move in the direction of a more fully automatic segmentation procedure.

### Conclusion

The above-described system and method of the present invention possesses numerous advantages as described herein and in the referenced appendices. Additional advantages and modifications will readily occur to those skilled in the art. Therefore, the invention in its broader aspects is not limited to the specific details, representative devices, and illustrative examples shown and described. Accordingly, departures may be made from such details without departing from the spirit or scope of the general inventive concept.

[image]

[image]

[image]

[image]

[image]

[image]

[image]

[image]

[image]

[image]

[image]

[image]

[image]

[image]

[image]

[image]

[image]

[image]

[image]

1. A computer system for storing, archiving, querying and retrieving information relating to three-dimensional objects; the system comprising:
data acquisition means for acquiring point coordinate data about the three-dimensional object;
a database component;
a processor operable to:
generate modeled data from the point coordinate data;
segment the modeled data into feature data representing a plurality of features of the object;
store the modeled data and the feature data in the database component; and
retrieve modeled data and feature data from the database using search criteria comprising representing an object feature; and
a user interface operative with the processor to:
input to the processor search criteria; and
display data retrieved by the processor as a representation of an object feature.

2. The system of claim 1 wherein the point coordinate data is surface data.

3. The system of claim 1 wherein the point coordinate data is volume data.

4. The system of claim 1 wherein the feature data represents a point.

5. The system of claim 1 wherein the feature data represents a curve.

6. The system of claim 1 wherein the feature data represents a facet on a surface.

7. The system of claim 1 wherein the processor is further operable to compress the modeled data.

8. The system of claim 7 wherein the modeled data comprises a triangle mesh and the processor is operable to compress the modeled data using B-spline curves.

9. The system of claim 7 wherein the modeled data comprises a triangle mesh and the processor is operable to segment the modeled data using subdivision surface compression.

10. The system of claim 1 wherein the point coordinate data comprises a triangle mesh and the processor is operable to segment the modeled data using watershed segmentation method including improved curvature estimation.

11. The system of claim 1 wherein the point coordinate data comprises a triangle mesh and the processor is operable to segment the modeled data using a hybrid segmentation method.

12. The system of claim 1 wherein the point coordinate data comprises a triangle mesh and the processor is operable to segment the modeled data using watershed segmentation.

13. The system of claim 1 wherein the point coordinate data comprises volume data the processor is operable to segment the modeled data using Weibull E-SD fields.

14. The system of claim 1 wherein the point coordinate data comprises volume data and the processor is operable to segment the modeled data using Greedy connected component labeling refinement.

15. The system of claim 1 wherein the user interface includes a graphic user interface that operates with the processor to allow a sketch-based search of the database.

16. A method for storing, archiving, querying and retrieving information relating to 3D objects; the system comprising:
acquiring point coordinate data from a physical object;
generating modeled data from the point coordinate data;
segmenting the modeled data into feature data representing a plurality of features of the physical object;
storing the modeled data and the feature data in a database; and
organizing the modeled data and the feature data so that features of the physical object can be automatically extracted for online query and retrieval of the plurality of features of the physical object.

17. The method of claim 16 wherein the point coordinate data is surface data.

18. The method of claim 16 wherein the point coordinate data is volume data.

19. The method of claim 16 further comprising compressing the modeled data.

20. The method of claim 19 wherein the modeled data comprises a triangle mesh and compressing the modeled data is performed using B-spline curves.

21. The method of claim 19 wherein the modeled data comprises a triangle mesh and compressing the modeled data is performed using a subdivision surface compression method.

22. The method of claim 16 wherein the point coordinate data comprises a triangle mesh and segmenting the modeled data is performed using watershed segmentation.

23. The method of claim 16 wherein the point coordinate data comprises a triangle mesh and segmenting the modeled data is performed using a hybrid segmentation method.

24. The method of claim 16 wherein the point coordinate data comprises volume data and segmenting the modeled data is performed using Weibull E-SD fields.

25. The method of claim 16 wherein the point coordinate data comprises volume data and segmenting the modeled data is performed using Greedy connected component labeling refinement.
